(19) United States
(12) Patent Application Publication
(10) Pub. No.: US 2024/0127002 A1
(43) Pub. Date: Apr. 18, 2024

(54) CONTEXT-BASED NATURAL LANGUAGE PROCESSING

(71) Applicant: Satisfi Labs Inc., Tampa, FL (US)

(72) Inventors: Randy Newman, Tampa, FL (US); Don White, Tampa, FL (US); Coralie Cojot, Los Angeles, CA (US)

(21) Appl. No.: 17/967,505

(22) Filed: Oct. 17, 2022

(51) Int. Cl. G06F 40/56; G06F 40/20

(52) U.S. Cl. CPC G06F 40/56; G06F 40/20

(57) ABSTRACT

A system can include memory and a computing device in communication therewith. The system can receive, via an input device, a first conversational input via an input device associated with a URL address. The system can process the first conversational input via a NLP algorithm to determine a context based on the URL address and the first conversational input and determine an intent based on the context and the first conversational input. The system can generate a response to the first conversational input based on the context and the intent. The system can receive a second conversational input. The system can process the second conversational input via the NLP algorithm to generate an updated intent based on the first conversational input, the second conversational input, and the URL address. The computing device can generate a second response to the second conversational input based on the updated intent and the context.

### TECHNICAL FIELD

The present systems and processes relate generally to natural language processing (NLP) and artificial intelligence platforms.

### BACKGROUND

Previous approaches to natural language processing and response face challenges in the areas of multi-turn context, consistency, knowledge management and response synthesis. For example, previous approaches to natural language processing may demonstrate significant limitations in precision and accuracy when handling inputs that are contextually similar but compositionally dissimilar. As another example, previous platforms for processing and responding to conversational inputs are typically not robust to variations in natural language (e.g., there may be hundreds to thousands of manners for expressing the same intent and previous approaches may only recognize a highly limited subset thereof). Past approaches to NLP-based services commonly limit natural language inputs and natural language response to a limited set of predetermined options. Such approaches may feel unnatural and robotic and may fail to accommodate the full spectrum of natural language compositions, contexts and intents. In other words, previous contextual response systems may lack flexibility and dynamic capacity that would otherwise provide for a context- and intent-accurate conversation experience.

Therefore, there is a long-felt but unresolved need for an improved system or process for context-based natural language processing.

### BRIEF SUMMARY OF THE DISCLOSURE

Briefly described, and according to one embodiment, aspects of the present disclosure generally relate to systems and processes for context-based natural language processing.

In various embodiments, provided herein are contextual response systems and processes for receiving and responding to natural language inputs. The contextual response system can determine a context, intent, and/or granularity of a natural language input and generate a response further based thereon. The contextual response system can process natural language inputs and generate responses via one or more machine learning models, thereby providing a conversational artificial intelligence platform. The contextual response system can train machine learning models for responding to requests for information or access to services. The contextual response system can obtain, maintain, and organize “knowledge volumes” that include information for determining contexts and intents of natural language inputs. The information of a knowledge volume can be associated with one or more criteria of a client. The contextual response system can receive one or more criteria of a client and identify, generate, and/or receive one or more knowledge volumes based thereon.

The contextual response system can receive or generate knowledge volumes. The knowledge volume can include context-, intent-, and/or granularity-specific information for processing and responding to natural language inputs. The contextual response system can process and analyze a knowledge volume to generate one or more metrics quantifying the context, intent, and/or granularity of information therein (e.g., or subsets of the information). The contextual response system can organize knowledge volumes into tiers of varying information scope. The contextual response system can assign an information scope to each of a plurality of knowledge bases. In some embodiments, the contextual response system receives, from an external service or system, an assignment of a knowledge base to a particular information scope. The contextual response system can organize a plurality of knowledge bases into a plurality of knowledge tiers. The contextual response system can organize the plurality of knowledge tiers by order of decreasing information scope. The contextual response system can generate a client knowledge base including the plurality of knowledge tiers.

The contextual response system can generate responses to conversational inputs based on the determined context(s) and intent(s) thereof. The contextual response system can apply one or more algorithms, models, and/or techniques to generate the response. The contextual response system can scan through branches of one or more decision trees to determine a potential response to a conversational input (e.g., based on natural language of the conversational input, context(s) of and intent(s) of the natural language and/or preceding conversational inputs, previous responses, and additional factors). The response can include one or more dynamic content variables. The contextual response system can generate or retrieve a value of the dynamic content variable and modify the response to include the value.

The contextual response system can include a plurality of instances of services and resources for responding to natural language inputs. Each of the plurality of instances of services and resources may be referred to as a “container.” The container may be associated with one or more contexts. For example, a first container may be associated with a “Ticket Sales” context and a second container may be associated with a “Parking Information” context. The container can include a portal for receiving input, such as, for example, a URL address, software application, or digital profile. The contextual response system can receive an input via the portal and associate the input with the corresponding container. The contextual response system can relay a user session from a first container to a second container. The contextual response system can relay the user session from a first portal to a second portal and may indicate the transition by adjusting one or more visual elements of the user session (e.g., a banner, name, and/or logo displayed on a user interface associated with the user session). The contextual response system can traverse multiple communication channels to support contextual response conversations across or between a plurality of communication mediums (e.g., SMS text, instant messaging, social media, web, voice, etc.).

The contextual response system can transition between containers based on input. For example, the contextual response system can receive, by a first container and from a computing device, a first conversational input. The contextual response system can identify a user account associated with the computing device. The contextual response system can determine a first context of the first container based on the first conversational input. The contextual response system generate a first response by processing the first conversational input via one or more natural language processing (NLP) algorithms and based on the first context in the first container. The contextual response system can transmit the response to a computing device from which the first input was transmitted. The contextual response system can receive, by the first container, a second conversational input. The contextual response system can determine whether to change to a second container based one or more of the second conversational input, a profile associated with the user account, the first context, or a context of the second conversational context (e.g., which may be the first context or a second context distinct from the first context). In response to determining a change to the second container is proper, the contextual response system can relay the second input to the second container (e.g., thereby causing the contextual response system to process and respond to the second input via the second container and based on resources associated therewith, such as particular knowledge volumes). The contextual system can update an appearance of a user interface associated with the first and/or second conversational inputs to indicate the container change.

The contextual response system can process conversational inputs via one or more natural language processing (NLP) algorithms. The contextual response system can decompose can decompose natural language into constituent terms. The contextual response system can analyze the constituent terms to perform context association and entity and intent detection. The input decomposition processes performed by the contextual response system may take into account pre-existing information to derive the most probable context and/or intent of the conversational input. The contextual response system can generate and update natural language understanding volumes, thereby learning from the network of clients using the contextual response system. The contextual response system can iteratively generate, train, and retrain models based on the volumes and other historical data, such as historical responses and user interaction data associated therewith.

The contextual response system can generates responses to conversational inputs based on factors including, but not limited to, context associations, entity detections, and class detections. After determining the intent of the end-user based on context, user input, profile information, and/or additional factors, the contextual response system can interrogate stored knowledge resources to determine a most appropriate response to send back to the end-user. The contextual response system can execute one or more response tree algorithms, models, or other techniques to scans decision trees or other tiered knowledge structures for a most specific response. From the most specific response, the contextual response system can recurse through a collection of increasingly generic responses to identify a returning the most appropriate version of the response for transmission to the end-user.

The contextual response system can generate and update training datasets for training models to process conversational inputs and generate responses thereto. The contextual response system can share the training datasets across teams, clients, industries, and other segments to leverage and improve tiered knowledge structures and contextual response models. The contextual response system can evaluate potential responses in a plurality of response tracks. The contextual response system may evaluate potential responses in a primary response track and refer to potential responses in one or more secondary or default tracks in response to failing to identify a response in the primary response track.

The contextual response system can provide substantially real-time contextual analysis and awareness. For example, the contextual response can associate conversations with a context based on the web page from which the conversation experiences are initiated. The contextual response system can transition to processing inputs in a first context to processing inputs in a second context based on factors such as new and preceding inputs and responses and user account information. For example, the contextual response system can initiate a conversation in a ticketing context on a ticketing interface and transition seamlessly to a parking context on a parking interface when the end-user begins asking questions about where to park.

The contextual response system can escalate conversations specific agent pools based on context (e.g., the specific agent pools being referred to herein as “containers” of resources for responding to inputs of particular context(s) and/or intent(s)). The contextual response system can relay conversations to containers within or outside an organization based on context, inputs, and profile information collected in the current and previous sessions. For example, the contextual response system can initiate conversations in a league-level container and, based on conversational inputs, relay the conversations to team-level containers associated with individual teams in the league. The contextual response system can update an appearance of a user interface associated with the container to assume a theme related to the container, a context, and/or a client associated with the container. The contextual response system can escalate conversations to live human agents within or independent from a client with which the current container of the conversation is associated.

According to a first aspect, a system, comprising: A) a memory; and B) at least one computing device in communication with the memory, wherein the at least one computing device is configured to: 1) receive a first conversational input of a plurality of sequential conversational inputs via at least one user input device, wherein the first conversational input is associated with a particular uniform resource locator (URL) address; 2) process the first conversational input via at least one natural language processing (NLP) algorithm to: i) determine a context based on the particular URL address and the first conversational input; and ii) determine at least one intent based on the context and the first conversational input; 3) generate a response to the first conversational input based on the context and the at least one intent; 4) subsequent to receiving the first conversational input, receive a second conversational input of the plurality of sequential conversational inputs; 5) process the second conversational input via the NLP algorithm to generate at least one updated intent based on the first conversational input, the second conversational input, and the URL address; and 6) generate a second response to the second conversational input based on the at least one updated intent and the context.

According to a further aspect, the system of the first aspect or any other aspect, wherein the context is a first context and the at least one computing is further configured to: A) identify a contextual change in a subset of the plurality of sequential conversational inputs; and B) initiate a change from the first context to a second context based on the contextual change.

According to a further aspect, the system of the first aspect or any other aspect, wherein the at least one computing is further configured to iteratively process a plurality of second sequential conversational inputs, via natural language processing (NLP) algorithm and based on the second context, to generate a plurality of second responses individually corresponding to a respective one of the plurality of second sequential conversational inputs.

According to a further aspect, the system of the first aspect or any other aspect, wherein the at least one computing is further configured to iteratively process the plurality of sequential conversational inputs based on the second context prior to generating the plurality of second responses.

According to a further aspect, the system of the first aspect or any other aspect, wherein: A) the at least one computing is configured to receive the first conversational input via the at least one computing device by a first container; B) the context is a first context of the first container; C) the at least one computing device is further configured to: 1) prior to generating the at least one updated intent, determine to change to a second container based on at least one of: the second conversational input, a profile associated with a particular user account, and the first context of the first container; and 2) relay the second conversational input to a second container.

According to a further aspect, the system of the first aspect or any other aspect, wherein the system comprises: A) a first application that, when executed by the at least one computing device, causes the first application to: 1) receive the first conversational input the at least one user input device; 2) process the first conversational input via the at least one natural language processing (NLP) algorithm to: i) determine the first context of the first container based on the particular URL address and the first conversational input; and ii) determine the at least one intent based on the first context of the first container and the first conversational input; and 3) generate the response to the first conversational input based on the context and the at least one intent; 4) receive, by the first container, the second conversational input; 5) prior to generating the at least one updated intent, determine whether to change to the second container based on at least one of: the second conversational input, the profile associated with the particular user account, and the first context of the first container; and 6) relay the second conversational input to the second container; and B) a second application that, when executed by the at least one computing device, causes the second application to: 1) receive, by the second container, the second conversational input relayed from the first container; 2) determine a second context of the second container based on the second conversational input; 3) process the second conversational input via the NLP algorithm to generate at least one updated intent based on the first conversational input, the second conversational input, and the particular URL address; and 4) process at least one second conversational input, based on the at least one updated intent and the second context in the second container, to generate at least one second response.

According to a further aspect, the system of the first aspect or any other aspect, wherein the first application is executed by a first computing device of the at least one computing device and the second application is executed by a second computing device of the at least one computing device.

According to a second aspect, a system, comprising: A) a memory; and B) at least one computing device in communication with the memory, wherein the at least one computing device is configured to: 1) receive a plurality of first conversational inputs via at least one user input device; 2) determine a first context based on at least one of the plurality of first conversational inputs; 3) iteratively process the plurality of first conversational inputs, via at least one natural language processing (NLP) algorithm and based on the first context, to generate a plurality of first responses individually corresponding to a respective one of the plurality of first conversational inputs; 4) identify a contextual change in a subset of the plurality of first conversational inputs; 5) initiate a change from the first context to a second context based on the contextual change; and 6) iteratively process a plurality of second conversational inputs, via natural language processing (NLP) algorithm and based on the second context, to generate a plurality of second responses individually corresponding to a respective one of the plurality of second conversational inputs.

According to a further aspect, the system of the second aspect or any other aspect, wherein the at least one computing is further configured to iteratively process the plurality of first conversational inputs based on the second context prior to generating the plurality of second responses.

According to a third aspect, a system, comprising: A) at least one computing device; and B) a first application that, when executed by the at least one computing device, causes the first application to: 1) receive, by a first container, at least one first conversational input via at least one user input device associated with a particular user account; 2) determine a first context of the first container based on at least one first conversational input; 3) process at least one first conversational input, via one or more natural language processing (NLP) algorithms and based on the first context in the first container, to generate at least one first response; 4) receive, by the first container, at least one second conversational input via the at least one user input device; 5) determine whether to change to a second container based on at least one of: the at least one second conversational input, a profile associated with the particular user account, and the first context; and 6) relay the at least one second conversational input to a second container.

According to a further aspect, the system of the third aspect or any other aspect, further comprising a second application that, when executed by the at least one computing device, causes the first application to: A) receive, by the second container, the at least one second conversational input relayed from the first container; B) determine a second context of the second container based on at least one second conversational inputs; and C) process at least one second conversational input, based on the second context in the second container, to generate at least one second response.

According to a further aspect, the system of the third aspect or any other aspect, wherein the first application is executed by a first computing device of the at least one computing device and the second application is executed by a second computing device of the at least one computing device.

According to a fourth aspect, a system, comprising: A) a memory; and B) at least one computing device in communication with the memory, wherein the at least one computing device is configured to: 1) receive a first conversational input via at least one user input device; 2) process the first conversational input via at least one natural language processing (NLP) algorithm by scanning through a plurality of tiers of knowledge bases to determine: i) a context based on the first conversational input; and ii) at least one intent based on the context and the first conversational input; and 3) generate a response to the first conversational input via a response tree algorithm based on the context and the at least one intent by: i) determining a dynamic content variable associated with the response; and ii) formatting the response based on a channel type corresponding to a current user session and the dynamic content variable.

According to a further aspect, the system of the fourth aspect or any other aspect, wherein the at least one computing device is further configured to determine at least one intent further based on a plurality of past conversational inputs corresponding to the current user session.

According to a further aspect, the system of the fourth aspect or any other aspect, wherein the plurality of tiers of knowledge bases are assigned to a hierarchy based on an assigned information scope.

According to a further aspect, the system of the fourth aspect or any other aspect, wherein the at least one computing device is further configured to: A) determine that a top-ranked entry of a main response track is unavailable; and B) identify a top-ranked entry of a fallback response track in response to determining that the top-ranked entry of the fallback response track satisfies the at least one intent.

According to a fifth aspect, a system, comprising: A) a memory; and B) at least one computing device in communication with the memory, wherein the at least one computing device is configured to: 1) receive first criteria associated with a client; 2) obtain a plurality of knowledge volumes based on the first criteria, wherein each of the plurality of knowledge volumes comprises a respective plurality of contexts and a respective plurality of intents; 3) generate a plurality of knowledge tiers based on the plurality of knowledge volumes, wherein: i) each of the plurality of knowledge tiers is assigned a different information scope; and ii) the plurality of knowledge tiers comprises, respectively, a global knowledge tier, a vertical knowledge tier, a sub-vertical knowledge tier, and a local knowledge tier; 4) generate at least one client knowledge base comprising the plurality of knowledge tiers; 5) determine at least one metric of the at least one client knowledge base, wherein the at least one metric is one of: a granularity metric, a context metric, or an intent metric; and 6) train at least one machine learning model by processing the at least one client knowledge base and the at least one metric.

According to a further aspect, the system of the fifth aspect or any other aspect, wherein the at least one computing device is configured to generate the plurality of knowledge tiers by identifying a plurality of segments in the plurality of knowledge volumes, wherein the plurality of segments comprises a global segment, a vertical knowledge segment, a sub-vertical knowledge segment, and a local knowledge segment.

According to a further aspect, the system of the fifth aspect or any other aspect, wherein the at least one computing device is further configured to: A) receive a request from a second computing device, the request comprising a text string; B) process the text string via the at least one client knowledge base to generate at least one second metric; C) scan through the plurality of knowledge tiers based on the at least one second metric to associate the text string with a context; D) scan through the plurality of knowledge tiers based on the context and the text string to associate the text string with an intent; E) generate a response based on the intent; and F) transmit the response to the second computing device.

According to a further aspect, the system of the fifth aspect or any other aspect, wherein the at least one computing device is further configured to: A) transmit a second request to an external service based on a dynamic content variable of the response; B) receive a reply from the external service; and C) prior to transmitting the response, populate the dynamic content variable based on the reply.

According to a further aspect, the system of the fifth aspect or any other aspect, wherein the at least one computing device is further configured to: A) obtain second criteria associated with a second client; B) generate a second client knowledge base by modifying the at least one client knowledge base based on the second criteria; and C) train a second machine learning model based on the second client knowledge base.

According to a further aspect, the system of the fifth aspect or any other aspect, wherein the at least one computing device is further configured to generating the second client knowledge base by removing at least one of the plurality of knowledge volumes from at least one of the plurality of knowledge tiers based on the second criteria.

According to a further aspect, the system of the fifth aspect or any other aspect, wherein the at least one computing device is further configured to: A) generate a metric of the second client knowledge base based on the at least one metric; and B) train the second machine learning model by processing the second client knowledge base and the score.

According to a further aspect, the system of the fifth aspect or any other aspect, wherein the plurality of knowledge tiers are ordered according to a decreasing value of the assigned information scope.

According to a further aspect, the system of the fifth aspect or any other aspect, wherein the at least one computing device is further configured to: A) obtain historical performance data associated with use of the at least one client knowledge base to determine the context and the intent for the at least one natural language input associated with the client; B) generate at least one historical error metric based on an analysis of the historical performance data; and C) modify the at least one client knowledge base to reduce the at least one historical error metric.

According to a further aspect, the system of the fifth aspect or any other aspect, wherein the at least one computing device is configured to modify the at least one client knowledge base by adjusting the at least one metric to reduce the at least one historical error metric.

According to a further aspect, the system of the fifth aspect or any other aspect, wherein the at least one computing device is configured to modify the at least one client knowledge base by: A) identifying an information deficiency in one of the plurality of knowledge tiers based on the at least one historical error metric; B) retrieving at least one additional knowledge volume based on the information deficiency; and C) updating the one of the plurality of knowledge tiers based on the additional knowledge volume.

According to a sixth aspect, a method, comprising: A) receiving a first conversational input of a plurality of sequential conversational inputs via at least one user input device, wherein the first conversational input is associated with a particular uniform resource locator (URL) address; B) processing the first conversational input via at least one natural language processing (NLP) algorithm to: 1) determine a context based on the particular URL address and the first conversational input; and 2) determine at least one intent based on the context and the first conversational input; C) generating a response to the first conversational input based on the context and the at least one intent; D) subsequent to receiving the first conversational input, receiving a second conversational input of the plurality of sequential conversational inputs; E) processing the second conversational input via the at least one NLP algorithm to generate at least one updated intent based on the first conversational input, the second conversational input, and the URL address; and F) generating a second response to the second conversational input based on the at least one updated intent and the context.

According to a further aspect, the method of the sixth aspect or any other aspect, wherein processing the first conversational input via the at least one NLP algorithm comprises scanning through a plurality of tiers of knowledge bases to determine the context and the at least one intent.

According to a further aspect, the method of the sixth aspect or any other aspect, wherein processing the second conversational input via the at least one NLP algorithm comprises scanning through the plurality of tiers of knowledge bases to determine the at least one updated intent.

According to a further aspect, the method of the sixth aspect or any other aspect, wherein the plurality of tiers of knowledge bases are assigned to a hierarchy based on an as-signed information scope.

According to a further aspect, the method of the sixth aspect or any other aspect, wherein generating the response to the first conversational input comprises processing a response tree algorithm based on the context and the at least one intent.

According to a further aspect, the method of the sixth aspect or any other aspect, wherein generating the second response comprises processing the response tree algorithm based on the context and the at least one updated intent.

According to a further aspect, the method of the sixth aspect or any other aspect, wherein generating the response to the first conversational input comprises: A) determining a dynamic content variable associated with the response; and B) formatting the response based on a channel type corresponding to a current user session and the dynamic content variable.

According to a further aspect, the method of the sixth aspect or any other aspect, wherein the step of processing the first conversational input via the at least one natural language processing (NLP) algorithm to determine the at least one intent is further based on a plurality of past conversational inputs corresponding to the current user session.

According to a further aspect, the method of the sixth aspect or any other aspect, wherein the response is a top-ranked entry of a main response track and the method further comprises: A) determining that the top-ranked entry of the main response track is unavailable; B) determining that a top-ranked entry of a fallback response track satisfies the at least one intent; and C) identifying the top-ranked entry of the fallback response track as the response.

According to a seventh aspect, a non-transitory, computer-readable medium embodying a program that, when executed by at least one computing device, causes the at least one computing device to: A) receive a first conversational input of a plurality of sequential conversational inputs via at least one user input device, wherein the first conversational input is associated with a particular uniform resource locator (URL) address; B) process the first conversational input via at least one natural language processing (NLP) algorithm to: 1) determine a context based on the particular URL address and the first conversational input; and 2) determine at least one intent based on the context and the first conversational input; C) generate a response to the first conversational input based on the context and the at least one intent; D) subsequent to receiving the first conversational input, receive a second conversational input of the plurality of sequential conversational inputs; E) process the second conversational input via the NLP algorithm to generate at least one updated intent based on the first conversational input, the second conversational input, and the URL address; and F) generate a second response to the second conversational input based on the at least one updated intent and the context.

According to a further aspect, the non-transitory, computer-readable medium of the seventh aspect or any other aspect, wherein the program, when executed by the at least one computing device, further causes the at least one computing device to process the first conversational input via the at least one NLP algorithm by scanning through a plurality of tiers of knowledge bases to determine the context and the at least one intent.

According to a further aspect, the non-transitory, computer-readable medium of the seventh aspect or any other aspect, wherein the program, when executed by the at least one computing device, further causes the at least one computing device to: A) receive first criteria associated with a client; B) obtain a plurality of knowledge volumes based on the first criteria, wherein each of the plurality of knowledge volumes comprises a respective plurality of contexts and a respective plurality of intents; and C) generate a plurality of knowledge tiers based on the plurality of knowledge volumes.

According to a further aspect, the non-transitory, computer-readable medium of the seventh aspect or any other aspect, wherein: A) each of the plurality of knowledge tiers is assigned a different information scope; B) the plurality of knowledge tiers comprises, respectively, a global knowledge tier, a vertical knowledge tier, a sub-vertical knowledge tier, and a local knowledge tier; and C) the program, when executed by the at least one computing device, further causes the at least one computing device to generate at least one client knowledge base comprising the plurality of knowledge tiers.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A shows an exemplary contextual response workflow that may be performed by a contextual response system, according to one embodiment of the present disclosure;

FIG. 1B shows an exemplary contextual response workflow that may be performed by a contextual response system, according to one embodiment of the present disclosure;

FIG. 2 shows an exemplary network environment in which a contextual response system may operate, according to one embodiment of the present disclosure;

FIG. 3 shows an exemplary communication service and workflow, according to one embodiment of the present disclosure;

FIG. 4 shows exemplary contexts, according to one embodiment of the present disclosure;

FIG. 5 shows an exemplary natural language processing (NLP) service and workflow, according to one embodiment of the present disclosure;

FIG. 6 shows exemplary knowledge bases and context rankings, according to one embodiment of the present disclosure;

FIG. 7 shows an exemplary knowledge base, according to one embodiment of the present disclosure;

FIG. 8 shows an exemplary response resolution schema, according to one embodiment of the present disclosure;

FIG. 9 shows an exemplary response generation process, according to one embodiment of the present disclosure;

FIG. 10 shows an exemplary response generation process, according to one embodiment of the present disclosure;

FIG. 11 shows an exemplary response generation process, according to one embodiment of the present disclosure;

FIG. 12 shows an exemplary response generation process, according to one embodiment of the present disclosure;

FIG. 13 shows an exemplary knowledge base generation process, according to one embodiment of the present disclosure;

FIG. 14 shows exemplary user interfaces, according to one embodiment of the present disclosure;

FIG. 15 shows an exemplary response generation workflow, according to one embodiment of the present disclosure;

FIG. 16A shows a partial view of an exemplary decision tree, according to one embodiment of the present disclosure; and

FIG. 16B shows a partial view of an exemplary decision tree, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to generating context- and intent-specific responses to natural language inputs.

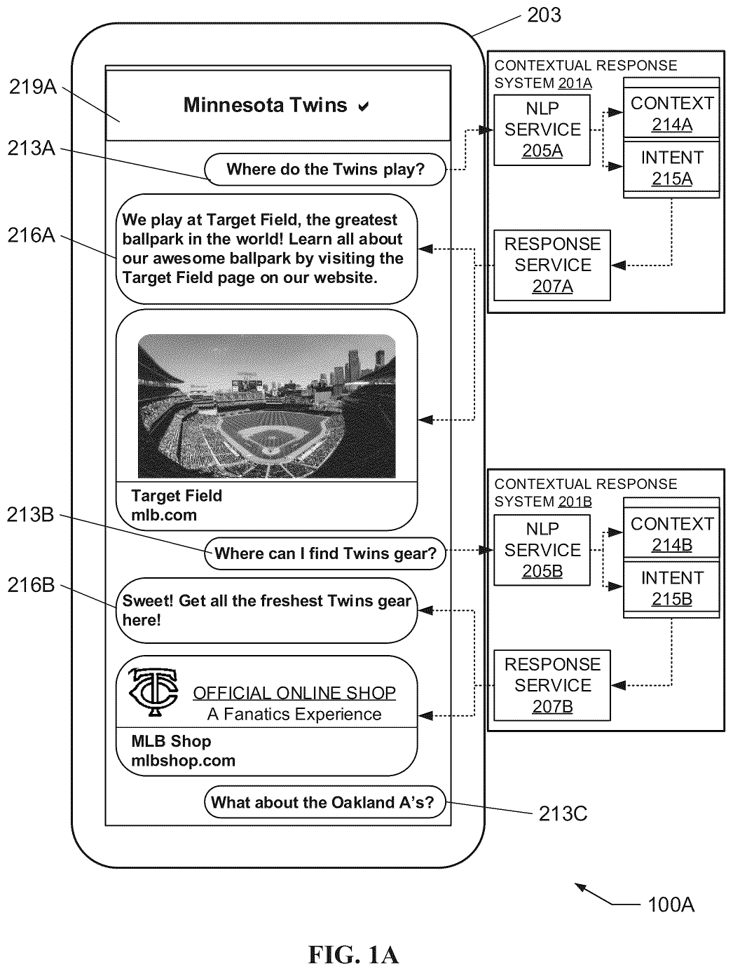

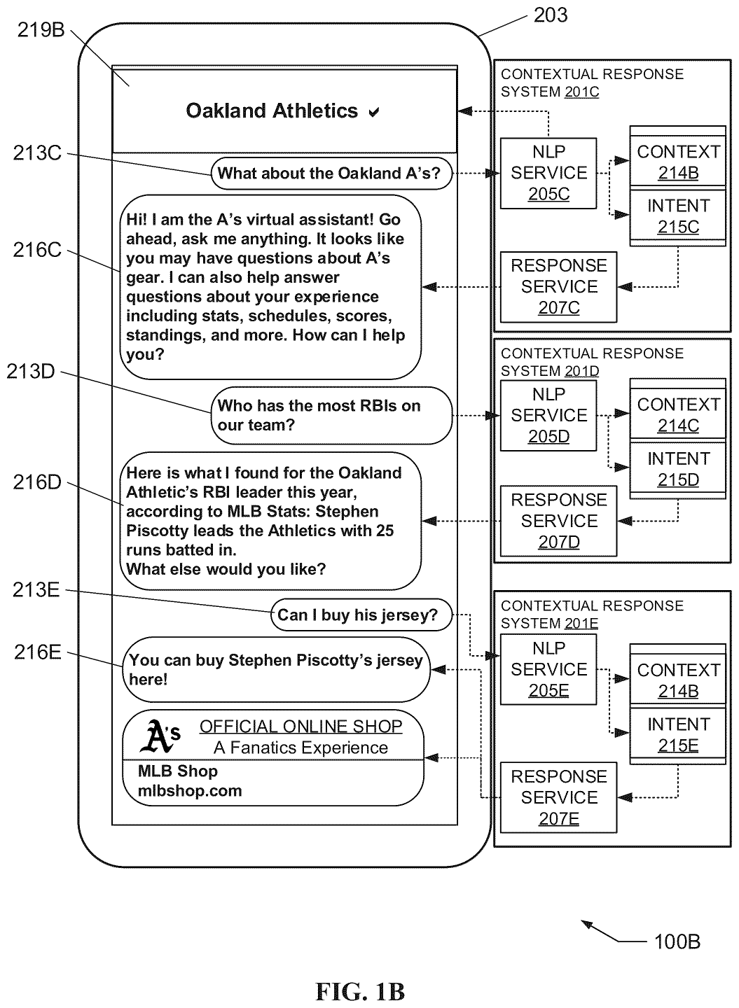

As demonstrated in the scenario shown in workflows 100A-B (e.g., see FIGS. 1A-B and accompanying description), the present contextual response system can receive a conversational input from a computing device. The contextual response system can receive the conversational input via a URL address associated with a first container. The contextual response system can determine a context based on the URL address and by processing the conversational input via one or more natural language processing (NLP) algorithms and/or or techniques. The contextual response system can determine an intent based on the context and the conversational input. The contextual response system can generate a response to the conversational input based on the context and the intent. For example, the contextual response system scans through a decision tree to identify a response based on the intent and the context. The response can include a dynamic content variable. The contextual response system can generate a value of the dynamic content variable based on information from a data store or by requesting the value of the dynamic content variable from an external service. The contextual response system can apply one or more rules to format the response such that the response is suitable for transmission via a particular channel (e.g., SMS text, instant message on a particular online communication platform, transmission to an application running on the user's computing device, etc.).

The contextual response system can transmit the response to the computing device. Subsequently, the contextual response system can receive a second conversational input and determine an updated intent thereof based the second conversational input and one or more of a context of the second conversational input, the initial conversational input, the context of the initial conversational input, the intent of the initial conversational input, the response to the initial conversational input, and the first container. The contextual response system can generate a second response to the second conversational input based on the updated intent and the context of the second conversational input (e.g., which may be the same or different from the context of the initial conversational input).

As further shown in the workflows 100A-D, the contextual response system can receive a plurality of conversational inputs. The contextual response system can determine a first context based on one or more of the plurality of conversational inputs. The contextual response system can iteratively process the plurality of conversational inputs based on the first context to generate a plurality of responses individually corresponding to a respective one of the plurality of responses. The contextual response system can determine that a subset of the plurality of responses is associated with a second context (e.g., different from the first context). The contextual response system can initiate a change from the first context to the second context. The contextual response system can generate one or more updated responses by iteratively re-processing the subset of the plurality of conversational inputs. The contextual response system can receive a second plurality of conversational inputs and process the second plurality of inputs based on the second context (e.g., and, in some embodiments, the plurality of responses and/or the one or more updated responses) to generate a plurality of second responses individually corresponding to one of the second plurality of conversational inputs.

### Exemplary Embodiments

Referring now to the figures, for the purposes of example and explanation of the fundamental processes and components of the disclosed systems and processes, reference is made to FIG. 1A that shows an exemplary contextual response workflow 100A that may be performed by an embodiment of the contextual response system shown and described herein. The workflow 100A and workflow 100B (e.g., shown in FIG. 1B and described herein) may correspond to different workflows or a shared workflow.

For purposes of illustrating and describing exemplary aspects of the present technology, FIGS. 1A-B include contextual response systems 201A, 201B and contextual response systems 201C, 201D and 201E. As will be understood and appreciated, the contextual response systems 201A-E may represent a single contextual response system or multiple contextual response systems in communication over one or more networks. As will be understood and appreciated, the exemplary contextual response systems shown in FIG. 1A, FIG. 1B, and other accompanying figures may each represent merely one approach or embodiment of the present contextual response system, and other aspects are used according to various embodiments shown and described herein. According to one embodiment, the lettering convention of elements shown in FIGS. 1A-B may indicate a temporal sequence of actions performed by the corresponding element. For example, in FIG. 1A, the NLP service 205A and NLP service 205B may refer to the same NLP service (e.g., the NLP service 205B representing an iteration of the NLP service subsequent to the NLP service 205A).

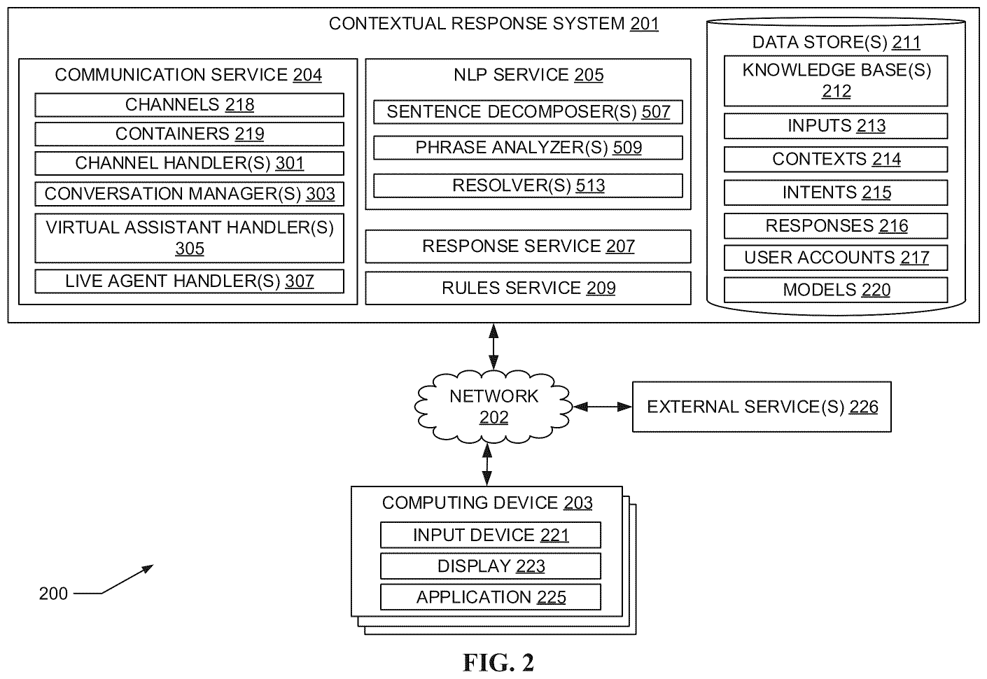

The workflow 100A may be performed by contextual response systems 201A, 201B. As further shown in FIG. 2 and described herein, the contextual responses systems 201A, 201B may communicate with one or more computing devices 203. The contextual responses systems 201A, 201B can receive inputs from the computing device 203, such as text strings including natural language. The contextual response systems 201A, 201B can process the inputs to generate responses thereto. The contextual responses systems 201A, 201B can transmit the responses to the computing device 203 from which input was received, or to one or more additional computing devices.

The contextual response systems 201A, 201B may correspond to the contextual response system 201 shown in FIG. 2 and described herein. In addition to other elements shown in FIG. 2 and described herein, the contextual response system 201A, 201B may include, but is not limited to, an NLP service 205A, 205B and a response service 207A, 207B. The NLP service 205A, 205B can receive inputs associated with a computing device 203. The input can be any electronic communication and may include natural language, such as text strings or audio recordings. The NLP service 205A, 205B can process the inputs to determine one or more of a context of the input, an intent of the input, and a level of granularity of the input. The context of the input can refer to a set of standalone resources for generating responses to context-associated inputs. As one example, a “Venue” context may include a set of resources for responding to inputs associated with one or more venues, and a “Merchandise” context may include a set of resources for responding to inputs associated with one or more goods for sale. The intent of the input can refer to a desired action and object of the action. The intent can be associated with a context. For example, an “access venue location” intent can refer to a desire to access a location of a venue (e.g., the venue being associated with the “Venue” context). As another example, a “buy player jersey” intent can refer to a desire to purchase merchandise (e.g., the merchandise being associated with the “Merchandise” context). The level of granularity of the input can refer to an arbitrary level of specificity as compared to other inputs associated with the same context and/or intent. For example, a first input of “Can I buy a Mets jersey?” may be associated with a first level of granularity, and a second input of “Can I buy a Jacob deGrom jersey” may be associated a second level of granularity that is greater than the first level of granularity (e.g., Jacob deGrom being a pitcher on the roster of the Mets baseball team).

The response service 207A, 207B can generate a response to an input based on one or more of the context of the input, the intent of the input, and the level of granularity of the input. The response service 207A, 207B may generate a response at a highest level of granularity available (e.g., providing a response that is most specific to the corresponding input).

The contextual response systems 201A, 201B can include a first container 219A. The first container 219A can correspond to the container 219 shown in FIG. 2 and described herein. The first container 219A includes a standalone deployment of resources for receiving inputs into the contextual response systems 201A, 201B, and for transmitting output therefrom to one or more computing devices. The first container 219A may include a deployment of resources associated with the contextual response system 201A, including one or more portals, mediums, or other means by which input is received into the contextual response system 201A. Multiple containers may be associated with different entities. For example, the first container 219A is associated with a first Major League Baseball (MLB) team, the Minnesota Twins, and a second container 219B (see FIG. 1B) is associated with a second MLB team, the Oakland Athletics. As described herein, the present contextual response systems may receive, process, and respond to inputs by a first container. As shown in the FIGS. 1A-B and accompanying description, the present contextual response systems may receive and process input by a first container and further process and respond to the input by a second container.

The proceeding paragraphs describe the workflows 100A-B in reference to an exemplary scenario of receiving and responding to natural language inputs. It will be understood and appreciated that the described functions and processes may represent one of a plurality of embodiments of the present technology and are not intended to restrict the systems and processes shown and described herein.

In an exemplary scenario, the contextual response systems 201A, 201B, and the contextual response systems 201C, 201D, 201E (see FIG. 1), are deployed as an artificial intelligence (AI) customer assistant for MLB teams, including the Minnesota Twins and the Oakland Athletics.

A user of the computing device 203 accesses a particular uniform resource locator (URL) address associated with the first container 219A. The computing device 203 transmits an input 213A to the contextual response system 201A via the first container 219A. The contextual response system 201A receives the input 213A via the first container 219A. The input 213A includes natural language from the user, such as “Where do the Twins play?” The NLP service 205A processes the input 213A via one or more NLP algorithms, techniques, or modules and determines a context 214A. In this scenario, the context 214A is “Venue Information.” The NLP service 205A may determine the context 214A based one or more factors including, but not limited to, the first container 219A by which the input 213A was received (e.g., including the URL address associated therewith), detections of the terms “where,” “Twins,” and/or “play, a detection of the phrase “where do the Twins play,” a detection of the question mark character “?,” and a context of one or more preceding inputs (not shown).

The NLP service 205A further processes the input 213A based on the context 214A to determine an intent 215A. The intent 215A includes a desired action and one or more objects, elements, or subjects associated with desired action. In this scenario, the intent 215A includes a desire to learn, obtain, and/or access venue information, in particular, a location of the venue. As shown in Table 1 and described herein, an intent may include a concatenation of various classes and/or detections generated by the contextual response system. A naming convention of the intent 215A may include “venue_information:venue_location-learn.”

The response service 207A processes the context 214A and the intent 215A to generate a response 216A. The response 216A includes natural language, such as “We play at Target Field!” As further shown and described herein, the response service 207A may scan through one or more decision trees to identify a context- and intent-matching response (e.g., and including an emphasis on identifying a response associated with a highest possible level of granularity relative to the corresponding input). The response 216A may include one or more multimedia elements, such as a photo, video, or audio file. The response 216A may include one or more selectable links for accessing additional information or services, such as a URL address for accessing additional venue information.

The computing device 203 receives the response 216A and renders the response 216A on a display. The user provides an input 213B to the computing device 203. The computing device 203 transmits the input 213B to the contextual response system 201B via the URL associated with the first container 219A. The input 213B includes “Where can I find Twins gear?” The NLP service 205B processes the input 213B and associates the input 213B with a “Merchandise” context 214B. The NLP service 205B processes the input 213B based on the context 214B to generate an intent 215B. The intent 215B may include a desire to access information for one or more physical or digital merchandise vendors. The intent 215B may include a naming convention “merchandise:vendor_locations-learn.” The naming convention may include a modifier based on a determination that the computing device 203 is, or will be, physically present at the venue. The modifier may cause the contextual response system to filter the subsequent response to include only physical locations, only digital locations, or to include both physical and digital locations.

The response service 207B processes the context 214B and the intent 215B to generate a response 216B. The response 216B includes natural language, such as “Sweet! Get all the freshest Twins gear!” The response 216B may include a selectable link for an online merchandise sales platform. The contextual response system 201B transmits the response 216B to the computing device 203. The computing device 203 renders the response 216B on the display. The user of the computing device 203 enters an input 213C, as further shown in FIG. 1B and discussed herein.

FIG. 1B shows an exemplary contextual response workflow 100B that may be performed by a contextual response system. The workflow 100B may be performed by contextual response systems 201C, 201D, 201E. The contextual response systems 201C-E include corresponding NLP services 205C-E and response services 207C-E.

Continuing the above scenario, the contextual response system 201C receives the input 213C from the computing device 203. The NLP service 205C processes the input 213C and determines that the input 213C is associated with the “Merchandise” context 214B. In response to detecting one or more of “Oakland,” “A's,” and “Oakland A's,” the NLP service 205C determines that the input 213C is associated with an entity or topic corresponding to a second container 219B. Based on the determination of context and the detection of keywords and/or phrases, the contextual response system 201C relays the conversation from the first container 219A to the second container 219B. The first container 219 is associated with the Minnesota Twins and the second container 219 is associated with the Oakland Athletics. The contextual response system 201C causes the computing device 203 to update the display to indicate the relay, including changing a title of the conversation from “Minnesota Twins” to “Oakland Athletics.”

The NLP service 205C receives and processes, by the second container 219B, the input 213C. The NLP service 205C generates an intent 215C by processing the input 213C, the response 216n, the input 213C, and/or the context 214B via resources associated with the second container 219B. The intent 215C includes a desire to access information related to the Oakland Athletics. The intent 215C may include a naming convention, such as “merchandise general_information-learn.”

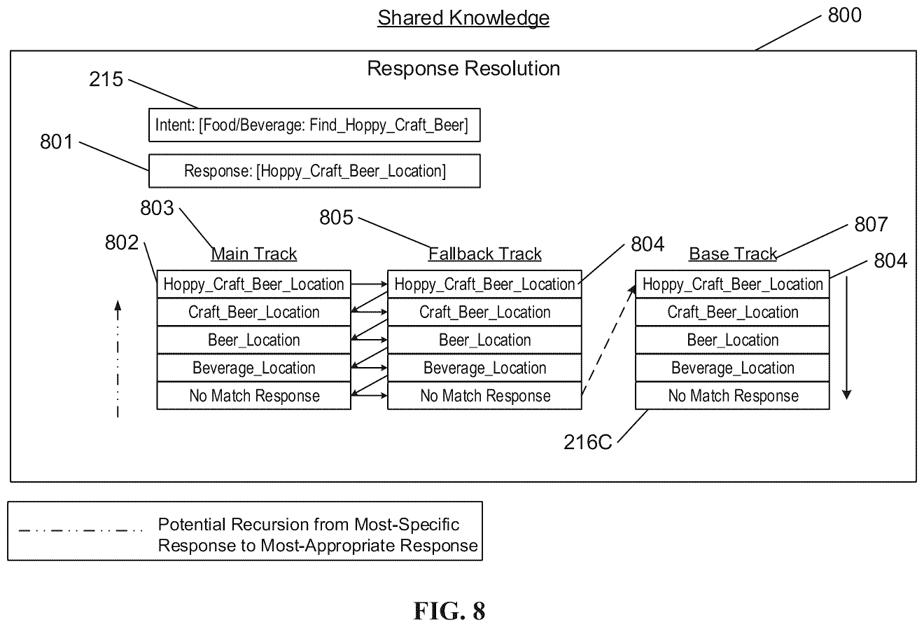

The response service 207C generates a response 216C by processing the intent 215C based on the context 214B. The response service 207C determines that the input 213C is associated with a low level of granularity (e.g., low specificity or high generality) and generates the response 216C based thereon. As further shown in FIG. 8 and described herein, the response service 207C may generate responses by scanning through mappings of responses (e.g., response decision trees) in one or more response tracks including, but not limited to, a main response track, a fallback response track, and a base response track. In this scenario, the response service 207C may retrieve the response 216C from a base response track (e.g., a response track including default and/or low granularity responses).

The response 216C includes context-specific information (e.g., merchandise-related language) and more general instructive information that informs a user of various functions of the contextual response system 201 (e.g., embodied as a virtual assistant of the Oakland Athletics). The response 216C includes natural language, such as “Hi! I am the A's virtual assistant! Go ahead, ask me anything. It looks like you may have questions about A's gear. I can also help answer questions about your experience including stats, schedules, scores, standings, and more. How can I help you?” The contextual response system 201C transmits the response 216C to the computing device 203 for rendering and presentation to the user.

The contextual response system 201D receives an input 213D from the computing device 203 via the second container 219B. The input 213D includes natural language, such as “Who has the most RBIs on our team?” The NLP service 205D processes the input 213D and associates the input 213D with a “Statistics” context 214C. The NLP service 205D processes the input 213D based on the context 214C to determine an intent 215D. The intent 215D includes a desire to access statistical information including the player with the most runs batted in (RBIs) on the Oakland Athletics. The intent 215D includes a naming convention, such as “statistics:current_roster-rbi-rank_first-learn.”

The response service 207D generates a response 216D by processing the intent 215D based on the context 214C. The response 216D includes natural language, such as “Here is what I found for the Oakland Athletics' RBI leader this year, according to MLB Stats: Stephen Piscotty leads the Athletics with 25 runs batted in. What else would you like?” The contextual response system 201D transmits the response 216D to the computing device 203 for rendering and presentation to the user.

The contextual response system 201D receives an input 213E from the computing device 203 via the second container 219B. The input 213E includes natural language, such as “Can I buy his jersey?” The NLP service 205E processes the input 213D and associates the input 213E with the “Merchandise” context 214B. The NLP service 205E determines an intent 215E by processing the input 213E based on the context 214B and the input 213D. The intent 215E includes a desire to purchase a Stephen Piscotty Oakland Athletics jersey. The intent 215E includes a naming convention, such as “merchandise:jersey-stephenpiscotty-buy.” The response service 201E generates a response 216E by processing the intent 215E based on the context 214B. The response 216E includes natural language, such as “You can buy Stephen Piscotty's jersey here!” The response 216E includes a selectable link for an online merchandise sales platform at which the user may purchase the desired jersey.

### Exemplary System Architecture

FIG. 2 shows a network environment 200 in which an embodiment of the contextual response system 201 may operate. The computing environment 200 can include the contextual response system 201 and one or more computing devices 203. In some embodiments, the computing environment 200 includes one or more external services 226. The contextual response system 201 can communicate with the computing device 203 and the external service 226 via one or more networks 202. The network 202 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks. The contextual response system 201 can communicate with a first computing device 203 over a first network 202 and communicate with a second computing device 203, or external service 226, over a second network 202.

As shown and described herein, the contextual response system 201 can process a natural language input from the computing device 203 and generate a natural language output for responding to the natural language input. The contextual response system 201 can include, but is not limited to, a communication service 204, a natural language processing (NLP) service 205, a response service 207, a rules service 209, and one or more data stores 211. The contextual response system 201 includes, for example, a Software as a Service (SaaS) system, a server computer, or any other system providing computing capability. Alternatively, the contextual response system 201 may employ computing devices that may be arranged, for example, in one or more server banks or computer banks or other arrangements. Such computing devices can be located in a single installation or may be distributed among many different geographical locations. For example, the contextual response system 201 can include computing devices that together may include a hosted computing resource, a grid computing resource, and/or any other distributed computing arrangement. In some cases, the contextual response system 201 can correspond to an elastic computing resource where the allotted capacity of processing, network, storage, or other computing-related resources may vary over time. In various embodiments, the contextual response system 201 (e.g., or one or more elements thereof) may be embodied as a browser feature, a browser plug-in, a browser web extension, an application, or a live chat bot launched on a particular website or network platform.

As further shown and described herein, the NLP service 205 can process an input 213 and associate the input 213 with one or more contexts 214, intents 215, and metrics for categorizing, rating, or classifying the input 213, such as a level of granularity. The response service 207 can generate a response 216 to the input 213 based on the one or more contexts 214, intents 215, and/or other metrics. The rules service 209 can format the response 216 (e.g., or a communication including the response 216) based on an intended recipient thereof and/or a means or mode of communication by which the response 216 will be transmitted (e.g., SMS text, instant message on a particular platform, electronic mail, etc.). Various applications and/or other functionality may be executed in the contextual response system 201 according to various embodiments. In various alternate embodiments, one or more elements of the contextual response system 201 are external services 226.

Various data is stored in the data store 211 that is accessible to the contextual response system 201. In some embodiments, the data store 211, or a subset of data stored thereat, is accessible to the computing device 203. In various embodiments, subsets of data stored at the data store 211 is accessible via containers 219 (e.g., as shown in described herein). The container 219 may embody a standalone instance of a contextual response system (e.g., an entity and/or context-specific instance of the contextual response system 201). The data store 211 can be representative of a plurality of data stores 211 as can be appreciated. The data stored in the data store 211, for example, is associated with the operation of the various applications and/or functional entities described herein. The data store 211 can include, but is not limited to, knowledge bases 212, inputs 213, contexts 214, intents 215, responses 216, user accounts 217, and models 220.

The knowledge base 212 can include data for processing, analyzing, and responding to inputs 213 (e.g., a conversational input received from a computing device 203). The knowledge base 212 can include information for identifying verbs, nouns, and other parts of speech, and relationships therebetween. The knowledge base 212 can include one or more corpuses of information for determining one or more contexts 214 and/or intents 215 of an input 213. The knowledge base 212 can include associations with one or more contexts 214, intents 215, and/or additional metrics. The knowledge base 212 can include, for example, one or more corpuses of keywords, key phrases, and associations the keywords and key phrases with one or more contexts 214, one or more intents 215, and/or levels of granularity. In one example, a knowledge base 212 is associated with a “ticketing” context 214 and includes keywords including, but not limited to, “ticket,” “pass,” “tix,” “permit,” “stub,” “ticket price,” “reservation,” and “. The knowledge base 212 can include any suitable number of keywords, key phrases, language structures, and/or language patterns with which an input 213 may be associated. In one example, a knowledge base 212 can be associated with a “food and beverage” context 214 and can include hundreds or millions of keywords and key phrases associated with drinking-related activities, eating-related activities, food names, beverage names, names of food and beverage providers, food quantities, beverage quantities, and combinations thereof.

In one example, each of a plurality of contexts 214 is associated with a different knowledge base 212, and each knowledge base 212 includes a different set of keywords. Continuing this example, the NLP service 205 may process an input 213 and identify a top-ranked knowledge base 212 based on a greatest number of keyword matches. In the same example, the NLP service 205 may associate the input 213 with one of the plurality of contexts 214 with which the matched knowledge base 212 is associated.

In another example, a knowledge base 212 includes a plurality of keyword sets, and each of the plurality of keywords is associated with a different intent 215. Continuing this example, the NLP service 205 may process an input 213 and identify a top-ranked keyword set based on a greatest number of keyword matches. In the same example, the NLP service 205 may associate the input 213 with the intent 215 corresponding to the top-ranked keyword set.

The knowledge base 212 can include grammatically and/or typographically flawed permutations of natural language (e.g., inclusive of colloquial terms, slang terms, and abbreviations of terms). For example, a knowledge base 212 includes “tickets” and abbreviations and misspellings thereof including, but not limited to, “tix,” “tickats,” “tocket,” “ticks,” “tcks,” “tkts,” and “tlcket.” The NLP service 205 can update the knowledge base 212 include additional permutations of natural language (e.g., based on historical inputs 213, information from one or more external services 226, or information from other knowledge bases 212).

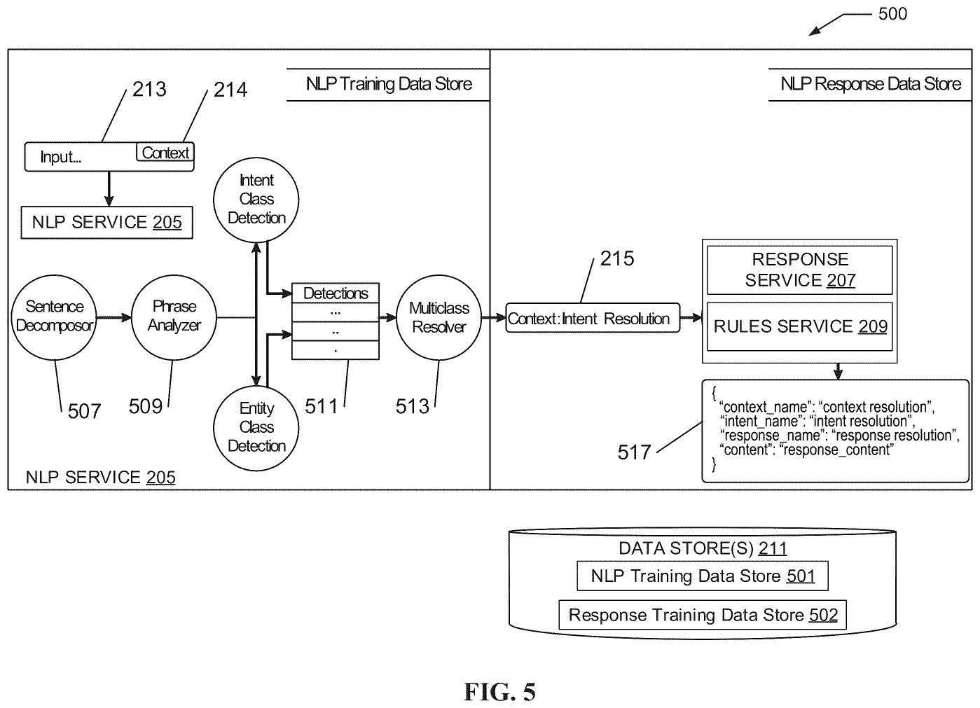

The knowledge base 212 can include one or more knowledge volumes. The knowledge volume can include data for processing, analyzing, and responding to inputs 213. The knowledge volume can include data associated with a particular context 214 and/or intent 215. For example, a first knowledge volume and a second knowledge volume may each be associated with a “ticketing” context 214. The first knowledge volume may include a first corpus of keywords associated with a “buy ticket” intent 215 and the second knowledge volume may include a second corpus of keywords associated with an “access ticket information” intent 215. The knowledge base 212 shown in FIG. 5 and described herein shows additional examples of various intents 215 with which a knowledge base 212, and/or knowledge volumes thereof, may be associated.

The knowledge base 212 can be generated based on a particular entity for which an instance of the contextual response system 201 is implemented. In one example, the entity is a zoo operator and a corresponding knowledge base 212 includes keywords associated with a corresponding zoo, such as zoo name, nickname, seasonal events, ticket types, special events, accommodations, vendor names, animal and other creature names, parking terms, local or regional directional information, and terms associated with points of interest within and around the zoo. In another example, the entity is a sports franchise and a corresponding knowledge base 212 includes keywords and phrases related to game schedules, ticket pricing and availability, adverse weather conditions, and season ticket holder support. The contextual response system 201 can receive one or more criteria associated with the particular entity and generate the knowledge base 212 based thereon (e.g., by obtaining one or more knowledge volumes corresponding to the one or more criteria).

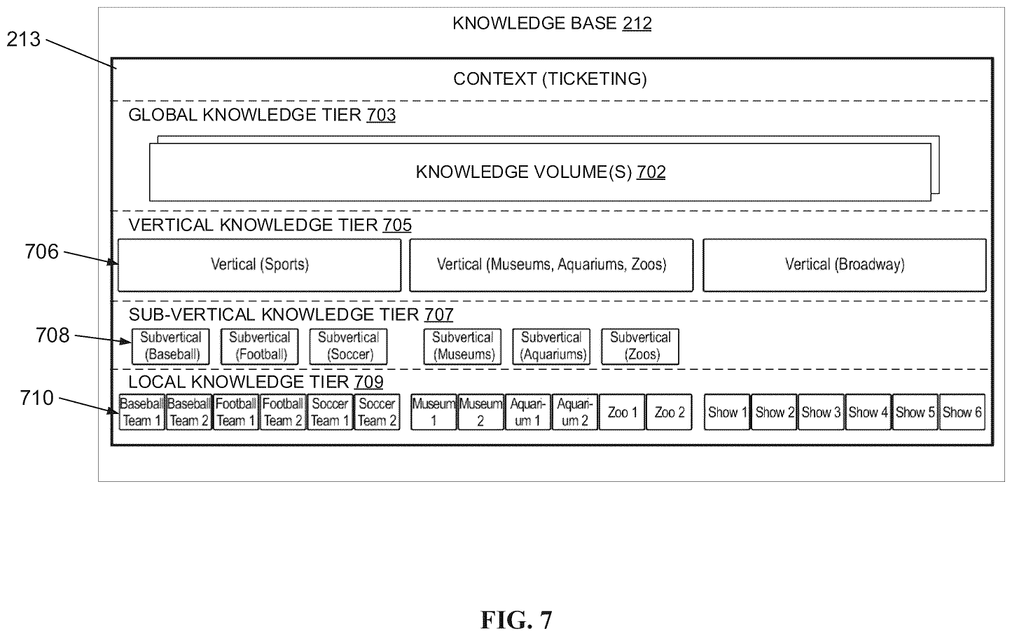

A plurality of knowledge volumes can be assigned a respective level of information scope. The knowledge volumes can be ordered into a plurality of knowledge tiers based on corresponding assignments of information scope. For example, a knowledge tier can include a plurality of knowledge volumes arranged by decreasing level of information scope assignment. Further aspects of exemplary knowledge bases 212 are shown in FIG. 7 and corresponding description herein. For example, as shown in FIG. 7 and described herein, a knowledge base 212 may include a tiered or hierarchical structure including, by decreasing level of information scope assignment, a global knowledge tier, a vertical knowledge tier, a sub-vertical knowledge tier, and a local knowledge tier.

The knowledge base 212 can be associated with one or more contexts 214. For example, a first knowledge base 212 may be associated with a first context 214 “Ticketing at Madison Square Garden,” a second knowledge base 212 may be associated with a second context 214 “Food and Beverage Services at Madison Square Garden,” and a third knowledge base 212 may be associated with a third context 214 “Health and Safety Services at Madison Square Garden.” In this example, “Madison Square Garden” may be a fourth context 214 with which the first, second, and third knowledge bases 212 are associated (e.g., the fourth context 214 being associated with a broader scope of information versus the more specific scope of the first, second, and third contexts 214).

The knowledge base 212 can be associated with one or more contexts 214. For example, the knowledge base 212 can be associated with a first context 214, “Ticket Sales,” a second context 214, “Parking,” a third context 214, “Ticket Services,” a fourth context 214, “Season Tickets,” a fifth context 214, “Food and Beverage Services,” a sixth context 214, “Venue Services,” a seventh context 214, “Event Services,” an eighth context 214, “Media Services,” and a ninth context 214 “Personnel Services.”

The knowledge base 212 can include a plurality of knowledge tiers including, but not limited to, a global knowledge tier, a vertical knowledge tier, a sub-vertical knowledge tier, and a local knowledge tier. The plurality of knowledge tiers can each be assigned a level of information scope. The plurality of knowledge tiers can be ordered by decreasing level of assigned information scope. The global knowledge tier can be assigned to a first level of information scope, the vertical knowledge tier can be assigned to a second level of information scope that is less than the first level. The sub-vertical knowledge tier can be assigned to a third level of information scope that is less than the second level. The local knowledge tier can be assigned to a fourth level of information scope that is less than the third level. In some embodiments, the assigned level of information scope corresponds to a level of granularity of the information included in the one or more knowledge volumes from which the plurality of tiers may be derived. A greater level of assigned information scope can correspond to a lower level of granularity.

In an exemplary scenario, a knowledge volume includes a first list including member states of the United Nations, a second list including states and provinces of each of the member states, a third list including cities of the states and provinces of each of the member states, and a fourth list including public transportation keywords (e.g., destinations, pass names, etc.) for each of the cities of the third list. The first list may be associated with a lowest level of granularity and may be assigned to a first level of information scope. The second list may be associated with a low level of granularity and may be assigned to a second level of information scope (e.g., less than the first level). The third list may be associated with a medium level of granularity and may be assigned to a third level of information scope (e.g., less than the second level). The fourth list may be associated with a high level of granularity and may be assigned to a fourth level of information scope (e.g., less than the third level). The lists may be incorporated into a plurality of knowledge tiers based on their assigned level of information scope. A global knowledge tier may include the first list, a vertical knowledge tier may include the second list, a sub-vertical knowledge tier may include the third list, and a local knowledge tier may include the fourth list.

Two or more knowledge volumes may be incorporated into the same or different knowledge tiers. As an example of the former, a knowledge base 212 may be associated with a “Parking” context 214 and include a plurality of knowledge tiers. A first knowledge volume may include keywords and phrases related to parking activities at a baseball stadium and a second knowledge volume may include keywords and phrases related to parking activities at an art museum. The plurality of knowledge tiers may include a vertical knowledge tier that includes both the first and second knowledge volumes.

As an example of the latter, a knowledge base 212 may be associated with a “Parking” context 214 and include a plurality of knowledge tiers. The first knowledge volume may include keywords and phrases associated with parking locations of a baseball stadium and a second knowledge volume may include keywords and phrases associated with parking fares and operating hours of the parking locations. The plurality of knowledge tiers may include a vertical knowledge tier that includes the first knowledge volume and a sub-vertical knowledge tier that includes the second knowledge volume.

As another example, a knowledge volume may be associated with a “Food and Beverage” context 214 and include a first subset, a second subset, a third subset, and a fourth subset (e.g., the subsets being mutually exclusive in some embodiments and, in other embodiments, not). The first subset may include keywords and phrases for all foods and beverages offered at a particular venue. The second subset may include keywords and phrases for prices of the foods and beverages at the particular venue. The third subset may include keywords and phrases related to a mapping of the foods and beverages to individual merchants at the particular venue. The fourth subset may include keywords and phrases related to availability of each of the foods and beverages at the corresponding merchant (e.g., capacity, operating hours, wait time, etc.). The knowledge volume may be segmented out into a plurality of knowledge tiers including a global knowledge tier, a vertical knowledge tier, a sub-vertical knowledge tier, and a local knowledge tier. The global knowledge tier may include the first subset, the vertical knowledge tier may include the second subset, the sub-vertical knowledge tier may include the third subset, and the local knowledge tier may include the fourth subset.

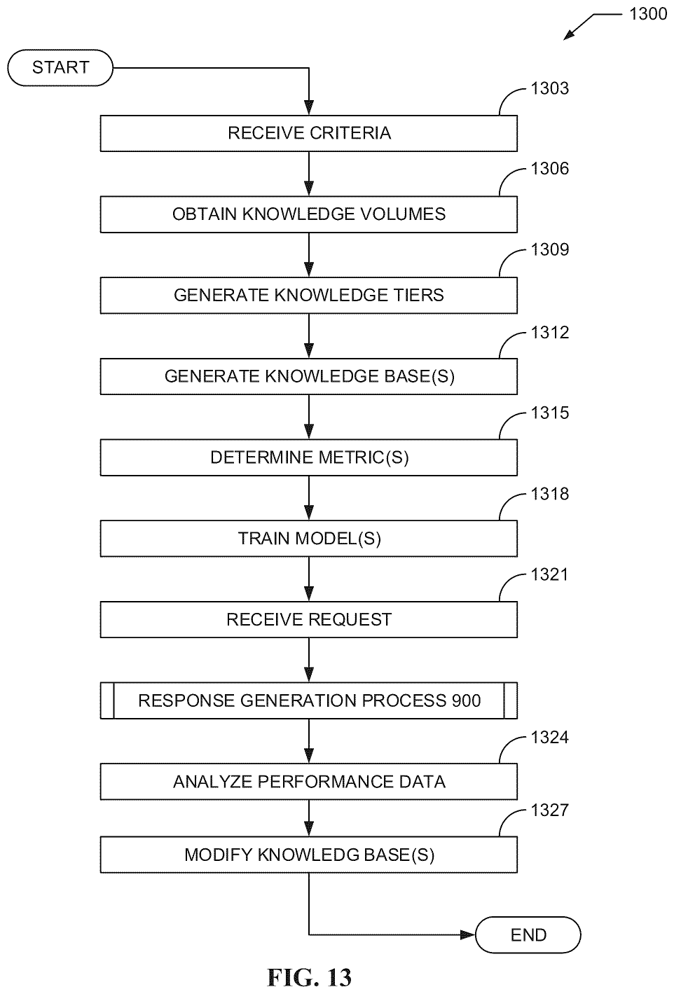

The contextual response system 201 can obtain the knowledge volume(s), generate knowledge tiers, and generate knowledge bases 212 according to processes described herein, such as the process 1300 shown in FIG. 13 and described herein.

The inputs 213 can include natural language, such as text strings. The inputs 213 may include conversational inputs as shown and described herein. The inputs 213 can include transmissions from the computing device 203, such as, for example, requests for services, information, or other functions. The inputs 213 can include time-series sequences of conversational inputs (e.g., representing a conversation between a user and the contextual response system 201). The stored inputs 213 can include indications of associated context(s) 214, intent(s) 215, response(s) 216, user account 217, container(s) 219, and/or model(s) 220. For example, a particular input 213 includes a natural language text string and an indication of a container 219 by which the contextual response system 201 received the particular input 213. The input 213 can include metadata including, but not limited to, timestamp receipt, device identifying information (e.g., IP address, MAC address, device identifiers, etc.), user identifying information (e.g., username and other credentials, mobile service provider, etc.), geolocation information (e.g., GPS data, cell tower data, etc.), and media files (e.g., audio recordings, images, videos, etc.). In one example, the input 213 includes an audio file and a natural text string extracted from the audio file (e.g., via processing the NLP service 205 processing the input 213 via one or more NLP algorithms). In some embodiments, the contextual response system 201 omits or deletes personal identifiable information (PII) from a conversational input (or sequence thereof) prior to storing the conversational input as the input 213. In one example, the contextual response system 201 processes a conversational input to remove personal names, addresses, and transactional information therefrom before storing the conversational input at the data store 211.

The context 214 can be a set of computing resources for responding to input 213 of a particular type or subject. The context 214 can include associations between the context 214 and one or more knowledge bases 212, intents 215, responses 216, models 220, and external services 226. For example, a first context 214 may be “Food and Beverages at Yankee Stadium” and may be associated with a first set of resources including a first knowledge base 212, a first set of intents 215, a first set of responses 216, and a first model 220. In the same example, a second context 214 may be “Parking and Transportation at Yankee Stadium” and may be associated with a second set of resources including a second knowledge base 212, a second set of intents 215, a second set of responses 216, and a second model 220.

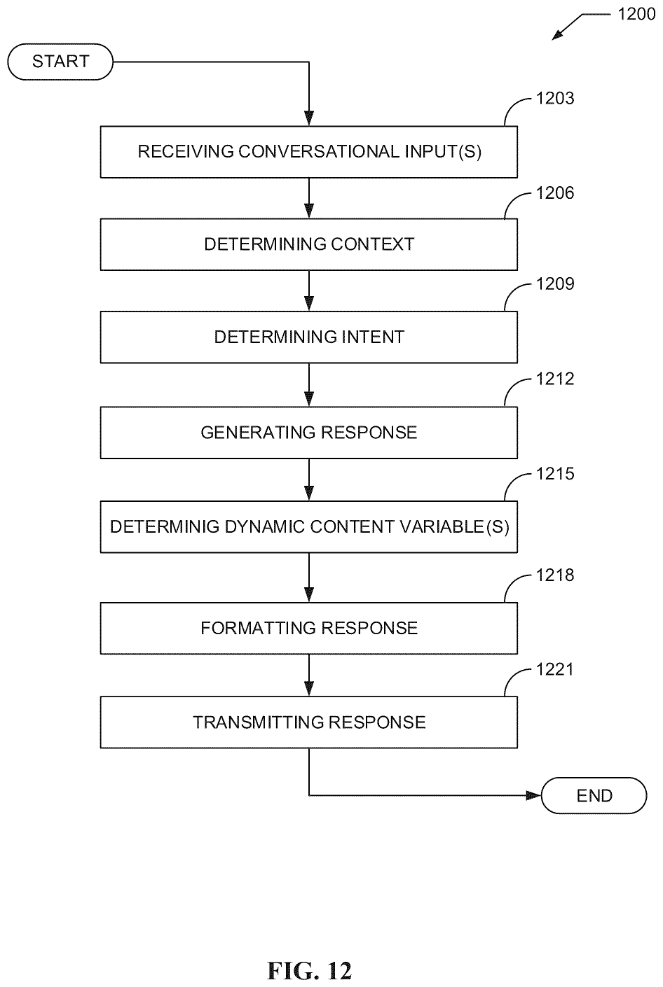

The NLP service 205 can determine an association between the input 213 and one or more contexts 214 based on one or more factors including, but not limited to, a container 219 by which an input 213 is received and natural language of the input 213. The context 214 may include labels of particular topics, subjects, tasks, and services with which the input 213 may be associated. For example, a first context 214 may be “Parking,” a second context 214 may be “Ticketing,” and a third context 214 may be “VIP Services.” FIG. 12 and accompanying description herein provide further exemplary contexts. The context 214 can be associated with a particular entity, such as a particular venue, franchise, or location. For example, a first context 214 may be “Parking at Venue X,” a second context 214 may be “Ticketing at Venue X,” and a third context 214 may be “VIP Services at Location Y.” In this example, the first and second context may be associated with a first entity, Venue X, and the third context 214 may be associated with a second entity, location X. In some embodiments, the context 214 is associated with multiple entities, such as multiple locations or instances of a franchise. For example, the context 214 may be a “Food and Beverage” context and may be associated with multiple locations of Six Flags Theme Parks.

In some embodiments, the context 214 includes one or more corpuses of natural language linked to the context 214. In at least one embodiment, the NLP service 205 compares the input 213 to the one or more corpuses to generate a similarity score (e.g., via any suitable method, such as vectorization and distance metrics). The NLP service 205 may determine that the similarity score satisfies a predetermined threshold (e.g., and/or that the input 213 matches a threshold-satisfying number of terms in the one or more corpuses). The NLP service 205 can assign the input 213 to the context 214 in response to determining the similarity score satisfies a predetermined threshold. In some embodiments, the NLP service 205 assigns the input 213 to one or more top-ranked contexts 214 from a plurality of contexts 214. The NLP service 205 can perform context association processes in a rank-ordered manner such that the NLP service 205 first determines if an input 213 is associated with a top-ranked context 214 and, if not, proceeds to sequentially determine whether the input 213 is associated with a second-ranked context 214 or other, lower-ranked contexts 214. The NLP service 205 can generate, retrieve, and update rankings of contexts 214 (e.g., based on a particular entity associated therewith, previous context associations, and other historical data).

The intent 215 can be a desired action and/or desired information. The intent 215 can be associated with a context 214. For example, an intent 215 may be a desire to access operating hours of “Zoo Y.” In this example, the associated context 214 may be “Ticketing at Zoo Y.” In various embodiments, multiple intents 215 may be associated with the same context 214 and differing actions or desired information. For example, a first intent 215 and second intent 215 may be associated with a “Food and Beverage” context 214. In this example, the first intent 215 may be associated with “Price of a Hotdog,” and the second intent 215 may be associated with “Price of a Beer.” In the same example, a third intent 215 may be associated with “Price of Combo #1, Beer and Hotdog.” In one or more embodiments, multiple intents 215 may be associated with the same context 214 and with similar actions or desired information.

In at least one embodiments, intents 215 may demonstrate varying levels of granularity. For example, a first intent 215 and a second intent 215 may be associated with a “Beverages at Busch Stadium” context 214. In the same example, the first intent 215 may be associated with accessing beverage information at a first level of granularity to identify any location inside the stadium at which beverages may be purchased. Continuing the example, the second intent 215 may be associated with accessing beverage information at a second level of granularity to identify locations inside the stadium at which liquor beverages may be purchased. The data store 211 can include associations between intents 215 and responses 216. For example, the data store 211 can include decision-tree data structures for indicating associations between intents 215 and responses 216 (e.g., the intents 215 and responses 216 also sharing a contextual association). In other words, the intent 215 of the input 213 and an intent-associated response 216 may embody a question-answer relation (e.g., which may be further influenced by determined the granularity of the input 213 for which the intent 215 is determined).

The intent 215 can include a naming convention. The name of the intent 215 can be a concatenation of data classes associated with which the intent 215 is associated. The data classes may include, but are not limited to, context 214, topics, subtopics, modifiers, and actions. In some embodiments, granularity levels described herein include topics, subtopics, modifiers, and/or actions. For example, the contextual response system 201 may determine an association between an input 213 and intent 215 based at least in part on a determination that the input 213 is associated with one or more topics, subtopics, modifiers, and/or actions. In this example, the contextual response system 201 may determine a level of granularity based at least in part on the associations of the input 213 with the one or more topics, subtopics, modifiers and/or actions.

As shown in Table 1, the intent name may include a concatenation of the form “Context: Topic-Subtopic-Modifier-Action.” Table 1 presents an exemplary naming convention in the context of ticketing services for a ski lodge. The naming convention can identify one or more contexts 214 with which an intent 215 is associated. The naming convention can include one or more topics within the context. The naming convention can include a modifier for indicating a class or subject with which an instance of a topic is associated. For example, in Table 1, the modifier “ikon” may refer to an annual ski pass and the modifier “kids” may refer to tickets for a child subject.

The naming convention can include an action that indicates desired object or action of the intent 215. The “learn” action can indicate a desire for information regarding a topic and/or subtopic. For example, the action “learn” in row 2 of Table 1 may indicate a desire obtain information regarding when an annual pass at Ikon ski resorts are available for purchase. As another example, the action “buy” in row 5 of Table 1 may indicate a desire to purchase a kid's ski resort ticket at a discounted price. Additional examples of actions include, but are not limited to, cancel, stop, reschedule, repeat, combine, reduce, increase, access, and block.

TABLE 1
Exemplary Intent Naming Conventions

| | | | | | | Human |
|---|---|---|---|---|---|---|
| Context | Topic | Sub-topic | Modifier | Action | Intent Name | Readable Name |
| tickets | annual_pass | on_sale_date | ikon | learn | tickets:annual_pass- | Learn About Ikon |
| | | | | | on_sale_date-ikon- | Annual Pass On |
| | | | | | learn | Sale Date |
| tickets | annual_pass | policy | ikon | learn | tickets:annual_pass- | Learn About Ikon |
| | | | | | policy-ikon-learn | Annual Pass Policy |
| tickets | annual_pass | price | ikon | learn | tickets:annual_pass- | Learn About Ikon |
| | | | | | price-ikon-learn | Annual Pass Price |
| tickets | tickets | discount | kids | buy | tickets:tickets- | Buy Kids Tickets |
| | | | | | discount-kids-buy | Discount |
| tickets | tickets | discount | kids | learn | tickets:tickets- | Learn About Kids |
| | | | | | discount-kids-learn | Tickets Discount |

The responses 216 can include data for replying to the inputs 213. The responses 216 can include natural language entries, such as text strings. For example, an input 213 may include “where is the parking lot” and the NLP service 205 may associate the input 213 with a container 219 “Yankees,” a context 214 “parking” and an intent 215 “access parking lot address.” In this example, a response 216 may include “1187 River Ave, The Bronx, NY 10452.” The responses 216 may include media files, such as images, videos, or audio recordings. For example, the response 216 may include an image of a map for navigating to or within a particular location. In another example, the response 216 may include an image of a person-of-interest, such as an athlete, musical artist, or public speaker. In another example, the response 216 may include images, recordings, and/or videos of an animal.

The response 216 may include selectable links that, upon selection at the computing device 203, cause the computing device 203 to access a particular networking address and display content hosted thereat. The response 216 may include tables, such as, for example, a table of ticket types and prices, a table of potential dates for scheduling an activity, or a roster of a sports team. The response 216 may include a selectable link that, upon selection, causes the computing device 203 to load a particular application, such as a navigation application, media streaming application, or social media application. The response 216 can include requests for collecting data from the computing device 203. For example, the response 216 can include a request for collecting geolocation data of the computing device 203. In another example, the response 216 can include a request for capturing an image, video, or audio recording via the computing device 203. In another example, the response 216 can include a request for transaction processing information (e.g., or a link to an online transaction processing environment).

The response 216 can include a call to one or more external services 226 such that, when the response 216 is identified for replying to the input 213, the contextual response system 201 performs one or more calls to request and obtain data from an external service 226. In one example, an input 213 may include “how much is gas in Brookhaven” and may be associated with a context 214 “Costco.” In this example, a response 216 may include a call to an external service 226 for accessing current Costco gas prices. Continuing the example, the contextual response system 201 may call the external service 226 (e.g., the call including an indication of the location, Brookhaven) and, in response, receive a current gas price for a Brookhaven Costco location. In another example, the response 216 includes a call to a weather forecasting service. In another example, the response 216 includes a call to a social media platform, or a particular account thereof.

The response 216 can include an association between the response 216 and one or more models 220, such as, for example, decision trees. The response 216 can include conditional variables that may be used based on the computing device 203 from which an input 213 was received. The response 216 can include conditional variables that may be used based on a user account 217 with which the input 213 or computing device 203 is associated. For example, the response 216 may include conditional variables for gender pronouns such that the contextual response system 201 formats the response 216 based on a gender assignment of the user account 217. In another example, the response 216 may include conditional variables for an operating system of the computing device 203 such that the contextual response system 201 formats the response 216 based thereon. In another example, the response 216 may include conditional variables for an age of the user such that the contextual response system 201 restricts the response 216 based thereon (e.g., preventing an underage user from accessing controlled substance information, adult-only sections of a venue, etc.).

The response 216 can include one or more dynamic content variables. The dynamic content variable can be a variable with one or more configurable elements. The response service 207 can determine the value of the dynamic content variable based on a container 219 by which the response 216 is to be transmitted. The response service 207 value of the dynamic content variable based on a context 214 or intent 215 with which the response 216 is associated. The response service 207 may determine the value of the dynamic content variable by requesting data from one or more external services 226. The response service 207 and/or the rules service 209 may update the response 216 based on the dynamic content variable. Updating the response 216 can include, but is not limited to, adjusting the composition of the response 216 (e.g., inserting one or more text strings into the response 216, populating dynamic content variables with text string-formatted data, etc.), modifying one or more visual elements of the response 216, or modifying one or more visual elements of a container 219 or (e.g., including a visual appearance of a user session with which the container 219 is associated).

In one example, a response 216 can include ticket information and a dynamic content variable of the response 216 can include a current price of the ticket. The response service 207 can generate the current price of the ticket by processing the dynamic content variable based on a container 219 and/or context 214 with which the response 216 is associated. The response service 207 can retrieve the current price of the ticket from the data store 211 or request and receive the current price of the ticket from an external service 226 (e.g., via an application programming interface (API) interaction, such as a remote procedure call).

In another example, a dynamic content variable includes a current beer price. The response service 207 can generate the current beer price by processing the dynamic content variable based on an associated container 219, context 214, intent 215, and/or level of granularity. In a particular container 219, the NLP service 205 can determine that a first input 213 “how much for a beer?” is associated with a “Beverages” context 214, a first “learn beer price” intent 215 (e.g., “beverages:beer-currenprice-learn”), and a first level of granularity. The response service 207 can generate a response 216 that includes a dynamic content variable, or plurality thereof, for the current price of beers associated with the particular container 219. The response service 207 can generate, or receive from an external service 226, a current price of each of a plurality of beers associated with the container 219. The response service 207 can update the value of the dynamic content variable(s) based on the current price of each of the plurality of beers. In the particular container 219, the NLP service 205 can determine that a second input 213 “how much for an IPA?” is associated with the “Beverages” context 214, a second “learn beer price” intent 215 (e.g., “beverages:beer-IPA-currentprice-learn”), and a second level of granularity, greater than the first level of granularity. The response service 207 can generate a response 216 that includes a dynamic content variable for the current price of an IPA beer associated with the particular container 219. The response service 207 can generate, or receive from an external service 226, a current price of the IPA beer and modify a response 216 to include the current price.

As shown in FIG. 8 and described herein, the responses 216 can be associated with one of a plurality of response tracks including, but not limited to, a main response track, a fallback response track, and a base response track. The main response track can include responses 216 that are entity-specific, location-specific, or specific to a subset of an entity. The fallback response track can be specific to a category of entities, or, if an entity includes various subsets, an overall entity. The base response track can include one or more default responses 216 for replying to inputs 213 for which a response 216 cannot be identified within the main response track or the fallback response track.

In one example, the entity is a particular food vendor. For a “Health and Nutrition” context 214, a main response track may include, but is not limited to, allergen data and nutritional data of each food product offered by the particular food vendor. A fallback response track may include, but is not limited to, allergen data and nutritional data from other food vendors or from one or more external services 226 (e.g., U.S. Department of Agriculture, Nutritionix, etc.). A default response track may include generic responses, such as “I am not sure,” “I cannot find an answer at this time, but I will notify you when I do,” or “I cannot verify that [input-requested food product] does not include [x], [y], and/or [z] allergen(s).”

In another example, the entity is a particular Major League Baseball (MLB) team. For a “Scheduling” context 214, a main response track may include a regular season schedule of the particular MLB team as sourced from a front office of the particular MLB team. A fallback response track may include a league-wide regular season schedule as provided by the overall MLB organization and/or regular season schedules from other MLB teams. A base response track may include one or more generic responses, such as “Sorry, I am unable to answer that” or “I do not have an answer at this time, would you like to be notified when I find an answer?”

The responses 216 of each response track may be arranged by order of decreasing granularity. For example, a “Food Services” context 214 may be associated with one of a plurality of main response tracks (e.g., each main response track being associated with a different intent 215, or set thereof). The main response track may be associated with an intent 215 of “access spicy food location.” The main response track may include a first response 216 associated with a highest level of granularity and including a name and location of a particular food vendor considered to offer the spiciest food at a given venue. The main response track may include a second response 216 associated with a medium level of granularity and including names and locations of a plurality of food vendors considered to offer at least one spicy food item at the given venue. The main response track may include a third response 216 associated with a low level of granularity and including names and locations of all food vendors at the given menu.

As shown in FIG. 8 and described herein, the response service 207 can scan through the main response track and the fallback response track to identify a response 216 for responding to an input 213 (e.g., based on the context 214, intent(s) 215, and/or other metrics associated therewith). The response service 207 may attempt to identify the response 216 by scanning through the main response track and the fallback response track in a serpentine manner. For example, when iterating through response tracks to identify a suitable response 216, the response service 207 may first consider a highest granularity response in the main response track. In response to determining that the highest granularity response in the main response track is unavailable or unsuitable, the response service 207 may then consider a highest granularity response in the fallback response track. In response to determining that the highest granularity response in the fallback response track is unavailable or unsuitable, the response service 207 may return to the main response track and consider a second-highest granularity response therein. In response to determining that the second-highest granularity response of the main response track is unavailable or unsuitable, the response service 207 may return to the fallback response track and consider a second-highest granularity response therein (e.g., and so on and so forth until a suitable response is identified). In response to failing to identify a suitable response in both the main response track and the fallback response track, the response service 207 may access a generic response in an associated base response track, such as “I cannot find an answer at this time,” “I am not sure about that one, would you like to be notified when I have an answer?,” or “I am having trouble finding an answer, can I connect you to a live agent?”

The user account 217 can include user credentials (e.g., name, username, password, biometric data, etc.), a user identifier, a device identifier, contact information, user preferences, or other identifying information. The user identifier can correspond to an identifier stored in one or more external services 226, such as, for example, a user identifier in a ticketing system, a user identifier in a social media platform, or a user identifier in a transaction system. In some embodiments, in response to receiving a transmission from the computing device 203, the communication service 204 identifies a corresponding user account 217 based on the transmission. In at least one embodiment, the communication service 204 enforces a login or authentication operation to initiate functions described herein. The communication service 204 can prompt the computing device 203 (e.g., or user thereof) to provide credential data, such as a username, password, and/or dual-authentication input (e.g., one-time code, biometric data, etc.). The communication service 204 can authenticate the credential data to allow access to functions described herein (e.g., contextual response generation processes described herein). The communication service 204 can store user sessions at the data store 211. The stored user session can include, but is not limited to, inputs 213, responses 216, and any metrics with which the user session is associated. The user account 217 can include one or more subscriber lists and/or an association of the user account with one or more subscriber lists. The subscriber list can correspond to a list of recipients for communications related to a particular context 214, intent 215, or combination thereof. For example, in response to providing a default response 216 to an input 213 (e.g., a response that fails to address, or only partially addresses, the input 213), the response service 207 adds an input-associated user account 217 to a subscriber list with which the context 214 and the intent 215 of the input 213 is associated. Continuing this example, upon identifying an adequate (e.g., non-default) response 216 to the input 213, the response service 207 transmits the response 216 to each computing device 203 associated with each user profile 217 of the subscriber list.

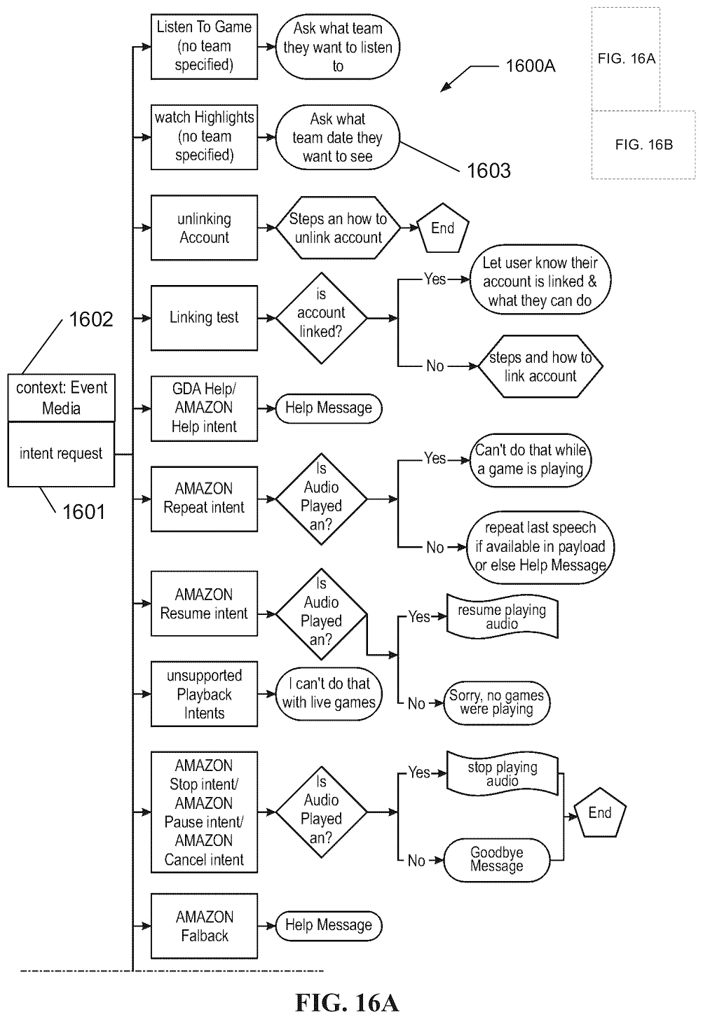

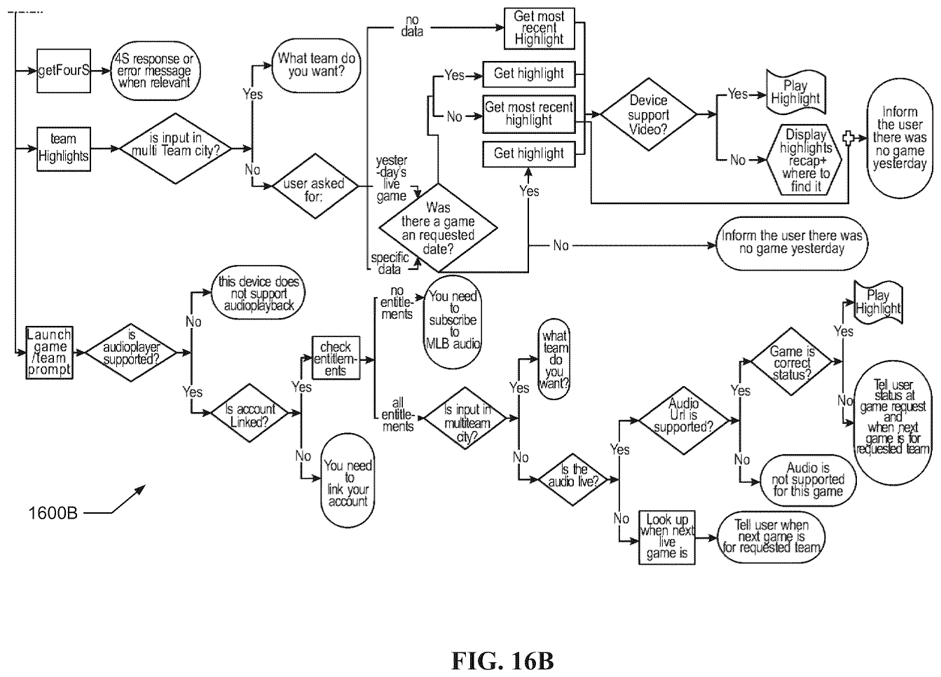

The models 220 can include models for identifying and/or generating the responses 216. The model 220 can identify or generate the response by processing one or more of the input 213, the context(s) 214 of the input 213, the intent(s) 215 of the input 213, a level of granularity of the input 213, metadata of the input 213, a computing device 203 associated with the input 213, a user profile 217 associated with the input 213, a channel 218 by which the input 213 was received, and historical data including, but not limited, to historical inputs 213 and data associated therewith (e.g., historical contexts, intents, granularity levels, etc.), historical responses 216, and user interactions. The model 220 can include decision trees by which the response service 207 generates a response to an input 213. FIGS. 16A, 16B illustrate an exemplary model 220 in the form of decision trees 1600A, 1600B. In various embodiments, a decision tree may include a type of supervised machine learning used to categorize or make predictions based on various conditions, including, but not limited to, context(s) 214, intent(s) 215, a level of granularity associated with an intent 215, one or more previous responses 216, and/or one or more previous inputs 213. The decision tree may be a form of supervised learning, meaning that the response service 207 may test and train the decision tree on a set of data that contains a pattern of sample natural language inputs and desired (and/or undesired) responses thereto. The model 220 can be associated with a particular response track, such as, for example, a main response track, a fallback response track, or a base response track (e.g., see also FIG. 8 and accompanying description herein).

The model 220 can include models for identifying a most appropriate response 216 to an input 213 based on or more of scoring, voting, and clustering. Non-limiting examples of such models include random forest classification, topic modelers, neural networks, linear regression, logistic regression, ordinary least squares regression, stepwise regression, multivariate adaptive regression splines, ridge regression, least-angle regression, locally estimated scatterplot smoothing, support vector machines, Bayesian algorithms, hierarchical clustering, k-nearest neighbors, K-means, expectation maximization, association rule learning algorithms, learning vector quantization, self-organizing map, locally weighted learning, least absolute shrinkage and selection operator, elastic net, feature selection, computer vision, dimensionality reduction algorithms, gradient boosting algorithms, and combinations thereof. Neural networks can include, but are not limited to, uni- or multilayer perceptron, convolutional neural networks, recurrent neural networks, long short-term memory networks, auto-encoders, deep Boltzman machines, deep belief networks, back-propagations, stochastic gradient descents, Hopfield networks, and radial basis function networks. A model 220 can be representative of a plurality of models of varying or differing composition and/or function.

The communication service 204 can receive and transmit data to and from the computing device 203 and the external service 226. The communication service 204 can receive requests from the computing device 203. The communication service 204 can process the request to generate or extract natural language inputs therein. In some embodiments, the communication service 204 processes the request to generate or retrieve metadata, as described herein. The communication service 204 can identify a source from which a request was transmitted, such as a particular computing device 203 or application 225 (e.g., or a particular channel 218, as shown and described herein). The communication service 204 can determine a user account 217 associated with the request (e.g., based on the source). In some embodiments, the communication service 204 causes the computing device 203, or a browser thereof, to access a particular URL and/or store cookie information for subsequent inclusion in a request, thereby providing a beaconing service for identifying the computing device 203.

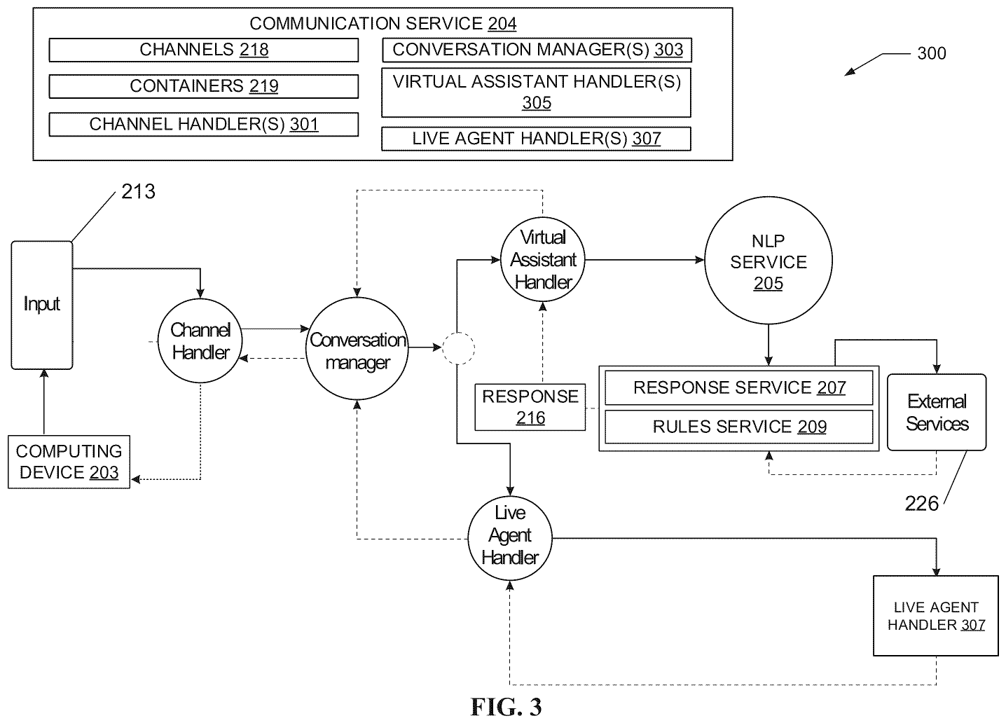

The communication service 204 can include, but is not limited to, channels 218, containers 219, channel handlers 301, conversation managers 303, virtual assistant handlers 305, and live agent handlers 307. FIG. 3 and accompanying description herein provide additional details and aspects of the communication service 204 and exemplary workflow thereof.

The channel 218 can be a medium or means by which the contextual response system 201 receives an input 213. Non-limiting examples of the channel 218 include web or browser-based messaging (e.g., respective channels 218 for entity-hosted websites, such as LinkedIn®, Shopify®, etc.), application-based messaging (e.g., respective channels 218 for WhatsApp®, Apple Business Chat®, Google® Business Messages, Microsoft Teams®, etc.), SMS or other cellular text-based messaging, voice messaging (e.g., respective channels 218 for telephone, voice over internet, Amazon Alexa®, Google Assistant®, Siri®, Bixby®, etc.), and social media-based messaging (e.g., respective channels 218 for Twitter®, Facebook Messenger®, Instagram Messenger®, etc.). The communication service 204 can include one or more channel handlers 301 for each channel 218. The channel handler 301 can receive inputs 213 and transmit responses 216 via the associated channel 218. In one example, a first channel 218 is associated with an online instant messaging service and a second channel 218 is associated with SMS text messaging. The communication service 204 can include a first channel handler 301 that receives inputs 213 and transmits responses 216 via the first channel 218 (e.g., in the form of instant messages) and a second channel handler 301 that receives inputs 213 and transmits responses 216 via the second channel 218 (e.g., in the form of SMS text messages).

The channel handler 301 can process an input 213 and identify a channel 218 associated therewith (e.g., an SMS channel, social media messaging channel, web-based channel, etc.). For example, the channel handler 301 can determine that an input 213 was received in the form of an SMS text message and, in response, associate the input 213 with an SMS text-based channel 218. The channel handler 301 can associate the input 309 with the particular channel 218, which may configure the communication service 204 to transmit responses 216 via the same channel 218 and cause the rules service 209 to format the response 216 to conform to the channel 218. As shown and described herein, the communication service 204 can relay a conversation from a first a channel 218 to a second a channel 218. In such instances, the channel handler 301 may dissociate corresponding input 309 from a first channel 218 and associate the input 309 with a second a channel 218. For example, the communication service 204 may relay a conversation from a social media-based messaging channel to an SMS-based messaging channel.

The channel handler 301 can relay a conversation from a first channel 218 to a second channel 218. The channel handler 301 can relay the conversation based on one or more of an input 213, a change in container 219, a change in context 214, or a change in intent 215. In one example, via an instant messaging-based channel 218, the communication service 204 receives an input 213 that includes natural language of “please text me at 555-123-5689.” The NLP service 205 processes the natural language and associates the input 213 with an intent 215 of relaying a conversation from the instant messaging-based channel 218 to an SMS text-based channel 218. In response to the determination, the channel handler 301 causes the communication service 204 to transmit subsequent responses 216 via the SMS text-based channel 218 (e.g., and may cause the rules service 209 to format the subsequent responses 216 as SMS text messages).

The container 219 can include a set of resources for processing and responding to conversational inputs. The resources can include, but are not limited to, instances of the NLP service 205, the response service 207, and the data store 211 (e.g., or contents thereof, such as knowledge bases 212, contexts 214, intents 215, user accounts 217, channels 218, and/or models 220). The container 219 can be a standalone deployment of a contextual response system with access to one or more processing resources, modules, or shared data structures of the contextual response system 201 (e.g., including the NLP service 205, response service 207, rules service 209, and/or data store 211). The container 219 can include an instance of contextual response software programs embodying functionality shown and described herein. For purposes of description and illustration, operations of the container 219 are described in the context of the contextual response system 201. It may be understood and appreciated that the described functions of the contextual response system 201 may be individually embodied, on a context-specific basis, by one or more containers 219. Each container 219 can be associated with a different entity (e.g., where entities may or may not share traits). In some embodiments, the entity may be referred to as a client and customers or guests associated with the entity may be referred to as users. The entity can include, for example, an event or entertainment venue, a sports league, or franchise thereof, an amusement park, a zoo operator, an airport customer service, an airline customer service, or a tourism board. The container 219 can include indicia for visually identifying the container 219 and/or indicating affiliation of the container 219 with a particular entity, context 214, knowledge base 212, user account 217, or type of user account 217 (e.g., basic user, VIP user, etc.).

The communication service 204 can receive transmissions via each container 219. The container 219 can include an association with one or more contexts 214, knowledge bases 212, or user accounts 217. For example, a first container 219 may be associated with a first entity, Major League Baseball™, and a second container 219 may be associated with a second entity, the New York Yankees™. In another example, a first container 219 may be associated with a first context 214, “parking services,” and a second container 219 may be associated with a second context 214, “ticketing services.” In another example, a container 219 may be associated with a first context 214, “ticketing services,” and a second context 214, “food and beverages.” In one exemplary scenario, a container 219 is associated with a theme park and a plurality of contexts 214 including ticketing services, food and beverages, health and safety, navigation, and loyalty programs.

The container 219 can be associated with one or more channels 218, such as, for example, a universal resource locator (URL) address, an inline frame (iframe), a particular server or port thereof, or a particular network 202. The container 219 can include a level of access or privilege with which a request (e.g., or a computing device 203 or user account 217) is associated. For example, a first container 219 may be associated with user accounts 217 having a basic privilege level and a second container 219 may be associated with user accounts having an administrator or VIP privilege level.

The conversation manager 303 can process an input 213 and identify a container 219 associated therewith. In some embodiments, the conversation manager 303 may be referred to as a “conductor.” The communication service 204 can receive an input 309 from a computing device 203, such as a request including one or more natural language strings. The conversation manager 303 can process the input 309 and determine that it was received via a particular URL address. The conversation manager 303 can associate the input 309 with a container 219 based on the particular URL address. As shown and described herein, the communication service 204 can relay a conversation from a first container 219 to a second container 219. In such instances, the conversation manager 303 may dissociate corresponding input 309 from a first container 219 and associate the input 309 with a second container 219. The conversation manager 303 can associate the input 213 with a container 219 based on the channel 218 by which the input 213 was received (e.g., which may be determined by the channel handler 301).

The conversation manager 303 can cause a change from a first container 219 to a second container 219. By changing containers, the communication service 204 may improve the quality of responses from the contextual response system 201 by utilizing a container 219 including one or knowledge bases 212 that are most closely associated with a context 214, intent 215, or granularity level of an input 213. The conversation manager 303 can cause a container change by relaying conversational input(s) from a first container 219 to a second container 219 (e.g., from a first instance of the contextual response system 201 to a second instance of the contextual response system 201, each instance being associated with different entities, knowledge bases 212, and/or contexts 214). To relay conversational input, the conversation manager 303 may provide one or more historical conversational inputs from the first container 219 to the second container 219. For example, the conversation manager 303 may transmit or forward conversational input(s) from processing resources of a first container 219 to processing resources of a second container 219. To relay conversational input from a first container 219 to a second container 219, a transition from a first instance of the contextual response system 201 to a second instance of the contextual response system 201 may occur (e.g., each instance being associated with a particular entity and/or context 214). The channel handler 301 may relay a conversation from a first channel 218 to a second channel 218 in response to, or as a part of, a relay of conversational input from a first container 219 to a second container 219.

In one example, a first container 219 is associated with an airline and a second container 219 is associated with a particular airport at which the airline operates flights. In this example, the conversation manager 303 may relay a sequence of conversational inputs from the first container 219 to the second container 219 in response to one of the sequence of conversational inputs, when processed, being associated with a context 214 for the particular airport and/or an intent 215 corresponding to the particular airport (e.g., a request for security wait times, a request for food and beverage information, a request for disability accommodations, etc.).

To relay a conversation between containers, the conversation manager 303 may command the computing device 203 or application 225 to switch from a first URL address for submitting conversational inputs to a second IRL address for submitting conversational inputs. The conversation manager 303 may initiate an update to a user interface for receiving a conversational input. The conversation manager 303 may command the application 225 to update a user interface to replace a first set of indicia with a second set of indicia. The first set of indicia may be associated with a first context 214 and/or first entity, and the second set of indicia may be associated with a second context 214 and/or second entity.

In an exemplary scenario, the communication service 204 receives a plurality of conversational inputs from a computing device 203 via a first container 219 associated with “National Football League.” The NLP service 205 processes the plurality of conversational inputs and determines a contextual change from a first context 214 “National Football League” associated with the first container 219 to a second context 214 “New England Patriots.” In response to the contextual change, the conversation manager 303 relays the plurality of conversational inputs, or a subsequent conversational input, to a second container 219 associated with the second context 214. In the above example, the first container 219 is associated with a first URL address and a first user interface, and the second container 219 is associated with a second URL address and a second user interface. The appearance of the first user interface may be based on branding of the “National Football League,” and the appearance of the second user interface may be based on branding of the “New England Patriots.” The relay of conversational input from a first container 219 to a second container 219 may the conversation manager 303 causing the computing device 203 to switch from a first instance of the application 225 to a second instance of the application 225 (e.g., each instance being associated with a particular entity and/or context 214).

The virtual assistant handler 305 can receive conversational inputs from the conversation manager 303 and provide the conversational inputs to the NLP service 205 for analysis. For example, the channel handler 301 receives an input 213 via a channel 218. The channel handler 301 provides the input 213 and an indication of the channel 218 to the conversation manager 303. Based on the input 213 and the indication of the channel 218, the conversation manager 303 associates the input 213 with a container 219. Based on the container 219, the conversation manager 303 transmits the input 213 to a virtual assistant handler 305 with which the container 219 is associated. Based on the container 219, the virtual assistant handler 305 provides the input 213 to an instance of the NLP service 205 with which the container 219 is associated.

The virtual assistant handler 305 can receive responses 216 from the response service 207 or the rules service 209. The virtual assistant handler 305 can provide the response 216 to the conversation manager 303 (e.g., which may provide the response 216 to a channel handler 301 for transmission to a computing device 203 via a channel 218). The virtual assistant handler 305 can receive user interaction data from the computing device 203 (e.g., via the channel handler 301 and the conversation manager 303). The user interaction data can include, but is not limited to, historical inputs 213, historical responses 216, actions initiated by the computing device 203 (e.g., selection of a link included in a response 216, completion of a transaction, etc.), navigation of the computing device 203 from a first location to one or more second locations, and user feedback (e.g., ratings, reviews, complaints, etc.). The virtual assistant handler 305 can store the user interaction data at the data store 211. The virtual assistant handler 305 can associate user interaction data with one or more user accounts 217 (e.g., the user interaction data being a potential input to future models 220 for identifying and/or formatting responses 216, or a potential to the NLP service 205 for improving context or intent determination).

The live agent handler 307 can transmit inputs 213 to and receive responses 216 from one or more live agents. A live agent can include a human operator. The live agent handler 307 can generate, maintain, and resolve support tickets. The support ticket may include an input 213 for which a response 216 could not be determined. The support ticket may identify one or more of a computing device 203 from which the input 213 was received, a channel 218 by which the input 213 was received, and a user account 217, container 219, context 214, and/or intent 215 with which the input 213 was associated. The support ticket may include an identifier generated by the communication service 204, which can be transmitted to the input-associated computing device 203 as a means of authentication or proof of authorization.

The NLP service 205 can process conversational inputs via one or more NLP algorithms and/or subservices to generate various outputs including, but not limited to, one or more contexts 214 of the conversational input, one or more intents 215 of the conversational inputs, and a level of granularity of the conversational input. The NLP service 205 can execute different NLP algorithms and subservices for generating each output, as can be appreciated. The NLP service 205 may generate an output based at least in part on previously generated outputs. The NLP service 205 may determine a context 214 of a conversational input and determine an intent 215 of the conversational input based in part on the context 214. The NLP service 205 may determine a context 214 and an intent 215 of a first conversational input and determine an intent 215 of a second conversational input based on the context and intent of the first conversational input. The NLP service 205 can include one more machine learning models for processing the input 213 and associating the input 213 with one or more contexts 214, one or more intents 215, and/or a level of granularity. For example, the NLP service 205 can process the input 213 via a local topic modeler to predict an association of the input 213 with one of a plurality of contexts 214. In another example, the NLP service 205 can process the input 213 via a random forest classification model to generate a prediction for the most likely intent 215 with which the input 213 may be associated.

The NLP service 205 can process a first conversational input via a natural language processing (NLP) algorithm to determine a context 214 based on the first conversational input and a channel 218 and/or container 219 associated with receipt of the first conversational input. The channel 218 can include, for example, a particular universal resource locator (URL) address. The container 219 can include, for example, a The NLP service 205 can further process the first conversational input via the NLP algorithm (e.g., or other NLP algorithm(s)) to determine a first intent based on the first conversational input and the context. The NLP service 205 can process a second conversational input via the NLP algorithm to determine an updated intent based on the first conversational input, the second conversational input, the first intent, the context, and/or the URL address.

The NLP service 205 can identify a contextual change between two or more conversational inputs. A contextual change can include a change from a first context to a second context (e.g., or any number of other contexts). A contextual change can include the inclusion of a second context in addition to the first context. The NLP service 205 can process a plurality of conversational inputs to determine if a context change occurs between a first subset of the conversational inputs and a second subset of the conversational inputs. The NLP service 205 can determine additional changes in context, as can be appreciated.

In an exemplary scenario described in the following paragraph, the NLP service 205 determines a first context based on at least one of a plurality of first conversational inputs. The NLP service 205 and/or response service 207 iteratively processes the plurality of first conversational inputs, based on the first context, to generate a plurality of first responses individually corresponding to a respective one of the plurality of first conversational inputs. The NLP service 205 processes the plurality of first conversational inputs via one or more NLP algorithms and/or subservices and identifies a contextual change in a subset of the plurality of first conversational inputs. The NLP service 205 initiates a change from the first context to a second context based on the context change. The NLP service 205 and/or response service 207 iteratively processes a plurality of second conversational inputs, based on the second context, to generate a plurality of second responses individually corresponding to a respective one of the plurality of second conversational inputs.

In various embodiments, the NLP service 205 includes one or more subservices for analyzing conversational inputs. As further shown in FIG. 5 and described herein, the NLP service 205 can include, but is not limited to, one or more sentence decomposers 507, one or more phrase analyzers 509, and one or more resolvers 513.

The sentence decomposer 507 can process natural language of an input 213 via one or more decomposition algorithms, techniques, or models. The sentence decomposer 507 can decompose a sentence, or sentence fragment, into constituent terms (e.g., words, punctuation, etc.). The sentence decomposer 507 can associate the constituent terms with one or more classes including, but not limited to, nouns, pronouns, verbs, adjectives, adverbs, prepositions, conjunctions, and interjections. The sentence decomposer 507 can associate the constituent terms with one or more subcategories including, but not limited to, common noun, proper noun, singular noun, plural noun, concrete noun, abstract noun, compound noun, collective noun, possessive noun, personal pronoun, reflexive pronoun, intensive pronoun, demonstrative pronoun, interrogative pronoun, indefinite pronoun, relative pronoun, action verb, linking verb, auxiliary verb, transitive verb, intransitive verb, coordinating conjunction, correlative conjunction, and subordinating conjunction. The sentence decomposer 507 can generate and tag the constituent terms with labels corresponding to the categories and subcategories. For example, an input 213 includes natural language “how many guests can I have in my suite?” The sentence decomposer 507 can decompose the input 213 into constituent terms “how,” “many,” “guests,” “can,” “I,” “have,” “in,” “my,” “suite,” and “?.” The sentence decomposer 507 can process each the constituent terms to associate the constituent term with one or more categories or subcategories. The sentence decomposer 507 can label “guests,” “I,” and “suite” as nouns, “can” and “have” as verbs, “in” as a preposition, “how many” as an adverb, “my” as an adjective, and “?” as an interrogation point or query.

The phrase analyzer 509 can determine one or more of a context 214, intent 215, and a level of granularity of the input 213. The phrase analyzer 509 can process the input 213, and/or or the constituent terms and labels thereof, to associate the input 213 with one or more contexts 214, one or more intents 215, and/or a level of granularity. The phrase analyzer 509 can compare the input 213 to one or more knowledge bases 212. The phrase analyzer 509 can compare the input 213 to a plurality of knowledge bases 212 212, each knowledge base being associated with a different context 214. The phrase analyzer 509 can determine a match between the input 213 and an entry of the knowledge base 212. The phrase analyzer 509 can perform comparison and matching via any suitable similarity algorithm, technique, model, or combinations thereof. Non-limiting examples of similarity algorithms, techniques, and models include exact string matching, approximate string matching, fuzzy comparison, string-to-vector encoding and comparison, cluster comparison, mutual information classification, naïve string search, Naïve Bayes classification, support vector machines, neural networks (e.g., convolutional neural networks (CNN), recurrent neural networks (RNN), etc.), and keyword extractors (e.g., YAKE!, BERT, etc.).

The phrase analyzer 509 can perform intent class detection and entity class detection to process and tag natural language for purposes of associating the input 213 with context(s) 214, intent(s) 215, and/or a level of granularity. When referring to intent class detection and entity class detection, “intent” may refer to a desired action and “entity” may refer to a subject or object of the desired action. For example, an input 213 includes natural language of “how many guests can I have in my suite?” The phrase analyzer 509 can process the natural language and determine that phrases “how many” and “have in” are intents and terms “guest” and “suite” are entities.

The resolver 513 can associate the input 213 with context(s) 214, intent(s) 215, and/or a level of granularity based on outputs from the sentence decomposer 507 and phrase analyzer 509. The resolver 513 can compare the natural language of the input 213 (e.g., including any classifications, determinations, or tags applied to the natural language elements) to one or more knowledge base 212. The resolver 513 can identify a context 214 of the input 213 by determining a context 214 whose associated knowledge base(s) 212 demonstrate the greatest measure of similarity to the natural language of the input 213. The resolver 513 can identify an intent 215 of the input 213 by determining an intent 215 whose associated knowledge base(s) 212 demonstrate the greatest measure of similarity to the natural language of the input 213. The resolver 513 can apply one or more predetermined thresholds to positively associate an input 213 with a context 214 or intent 215. For example, the resolver 513 can associate an input 213 with a particular context 214 in response to determining that the input 213 matches a predetermined percentage of terms in a knowledge base 212 with which the particular context 214 is associated. The resolver 513 can apply heuristics or other rules for associating an input 213 with a context 214. For example, the resolver 513 can apply fuzzy matching rules such that potentially misspelled or incorrectly phrased natural language may still be associated with a proper context 214 and intent 215.

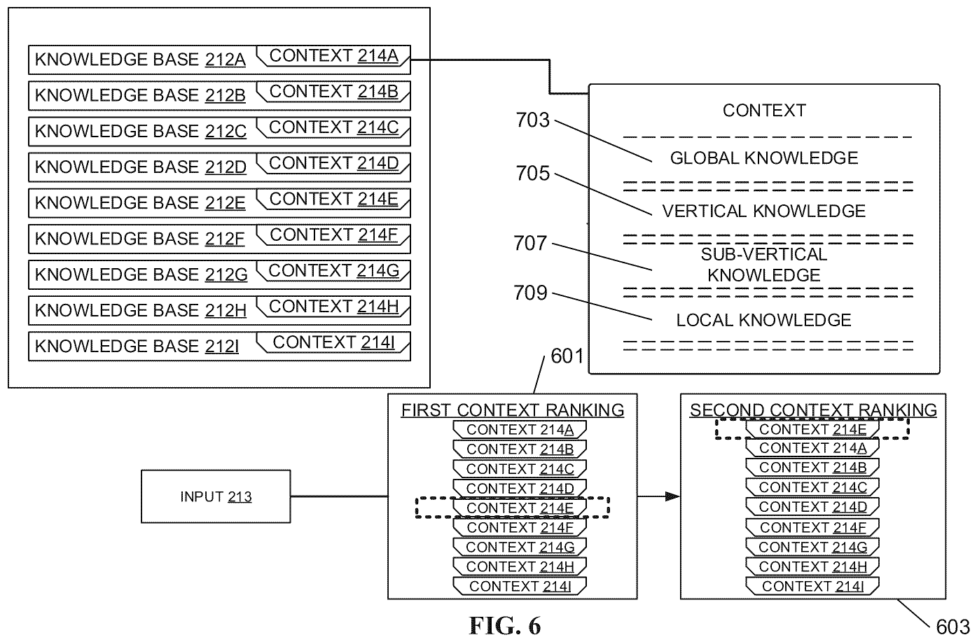

As further shown in FIG. 6 and described herein, the NLP service 205 can perform context association in a rank-wise manner. For example, a plurality of knowledge bases 212 are each associated with a different context 214. The phrase analyzer 509 can generate or retrieve a first ranking of the multiple knowledge bases 212 (e.g., a default ranking or a ranking based on previous conversational inputs and a context 214 associated therewith). In the order of the ranking, the NLP service 205 can compare a first input 213 (e.g., or constituent terms and labels thereof) to each of the plurality of knowledge bases 212 (e.g., which may include comparing the first input 213 to a plurality of knowledge tiers of each of the plurality of knowledge bases 212). In response to determining a threshold-satisfying level of similarity to a particular knowledge base of the plurality of knowledge bases 212, the NLP service 205 may associate the first input 213 with the particular context 214 corresponding to the particular knowledge base 212 (e.g., and may suspend performing further comparisons to other knowledge bases 212 that are lower in the first ranking). In response to associating the first input 213 with the particular context 214, the NLP service 205 can generate a second ranking of the plurality of knowledge bases 212 in which the particular knowledge base 212 is a top-ranked entry. The NLP service 205 can compare a subsequent input 213 to the plurality of knowledge bases 212 by order of the second ranking. The NLP service 205 can match the subsequent input 213 to one of the plurality of knowledge bases 212 and an associated context 214 thereof. The NLP service 205 can generate a third ranking of the plurality of knowledge bases 212 based on the analysis of the subsequent input 213. As shown in FIG. 6 and described herein, instead of or in addition to ranking knowledge bases, the NLP service 205 can generate and update a ranking of a plurality of contexts 214 (e.g., each of which may be associated with one or more knowledge bases 212).

The response service 207 can generate responses 216 for responding to inputs 213. The response service 207 can generate responses 216 based one or more factors including, but not limited to, natural language of the input 213, the context(s) 214 of the input 213, the intent(s) 215 of the input 213, a level of granularity of the input 213, metadata of the input 213, a computing device 203 associated with the input 213, a user profile 217 associated with the input 213, a channel 218 by which the input 213 was received, and historical data including, but not limited, to historical inputs 213 and data associated therewith (e.g., historical contexts, intents, granularity levels, etc.), historical responses 216, and user interactions. For example, the NLP service 205 can process an input 213 to associate the input 213 with a context 214 and an intent 215. The response service 207 can scan through a decision tree based on the associated context 214 and intent 215 to identify a response to the input 213.

The response service 207 can generate, train, and execute models 220 to identify or generate the response 216. For example, the response service 207 can train a random forest classification model to process an input 213, a context 214, and an intent 215, and generate a plurality of votes toward potential responses 216 for responding to the input 213. The response service 207 can train the random forest classification model to output a ranking of the potential responses 216 based on the votes. The response service 207 can determine a top-ranked entry of the ranking as the most suitable response 216 for responding to the input 213. In another example, the response service 207 can train a model 220 to determine a matching metric between an input 213 and each of a plurality of potential responses 216. Each of the plurality of potential responses 216 may be associated with one or more contexts 214, intents 215, and levels of granularity. The matching metric can represent a comparison between the context(s) 214, intent(s) 215, and level of granularity of the input 213 and those of each potential response 216. The response service 207 can train the model 220 to identify a response 216 based on determining that a top-ranked potential response 216 satisfies a predetermined matching metric threshold.

The response service 207 can inject dynamic content variables into a response 216 or modify one or more dynamic content variables of a response 216. The response service 207 can populate a dynamic content variable based on various factors and objects including, but not limited to, previous responses 216, previous inputs 213, user profiles 217, properties of a computing device 203 from which an input 213 was received (e.g., location, device type, etc.), user interaction data, and data from external services 226. User interaction data can include, but is not limited to, click rate, dwell time, referring domain, impressions, user ratings, and user feedback.

The response service 207 can analyze historical responses 216 and historical inputs 213 to generate various insights, such as, for example, popular inputs 213, common inputs 213 answered with a default response (e.g., a non-specific response from a base response track), and unique user encounters. The response service 207 can support trend identification by identify commonly requested goods and services. The response service 207 can identify health, safety, or security threats, for example, by determining that a plurality of historical inputs 213 are associated with a similar concern.

For example, an input 213 includes “how much is a beer at the ballpark?” The response service 207 can generate a response 216 that includes a dynamic content variable for the price of a beer at a particular venue (e.g., the ballpark). The response service 207 can retrieve, from the data store 211, a current price of a beer at the particular venue. Alternatively, the response service 207 can request and receive the current price of the beer from an external service 226, such as an inventory management system of the particular venue. The response service 207 can update the dynamic content variable to include the current price. In another example, the response service 207 generates a response 216 that includes a dynamic content variable for a user's name. To populate the dynamic content variable, the response service 207 can retrieve and process a user profile 217 to obtain the user's name and populate the dynamic content variable based thereon.

The rules service 209 can apply one or more rules to format a response 216 for transmission to a computing device 203 or presentation to a user thereof. The rules may include various factors, such as, for example, type of computing device 203 (e.g., tablet, smartphone, kiosk, etc.), channel 218, container 219, and properties of a user profile 217 (e.g., language, age, location, etc.). The rules service 209 can structure the response 216 into a particular communication format that may be based on the channel 218 by which the response will be transmitted and/or the computing device 203 intended to receive the response 216. Non-limiting examples of communication formats include text messages, instant messages (e.g., on any digital platform or service, such as a social media platform or business messaging service), push notifications, computer voice, and e-mail. The rules service 209 can modify a response 216 based on regulations or restrictions. For example, the rules service 209 can modify response 216 based on age-based restrictions, location-based restrictions, or time-based restrictions.

For example, a venue may suspend beverage services at a particular time. If the response service 207 generates a response 216 for providing information on accessing beverage services, the rules service 209 may process the response 216 and determine that the request for beverage services is beyond the particular time. In response to the determination, the rules service 209 may modify the response 216 (e.g., including retrieving a replacement response 216 from a fallback or base response track) to indicate that beverage services are not accessible at this time. In another example, a venue may restrict ticket sales to peoples 21 years of age and over. The response service 207 may generate a response 216 for facilitating purchase of tickets at the particular venue. The rules service 209 may process the response 216 and a user account 217 associated with an input 213 for which the response 216 was generated. The rules service 209 may determine that the user account 217 is associated with an individual under 21 years of age. In response to the determination, the rules service 209 may modify the response to indicate that the requested tickets are only purchasable to peoples 21 years of age and over.

The rules service 209 can apply one or more language-based policies to translate a response 216 from a first language to a second language. The rules service 209 can apply one or more content-based policies to censor or omit content containing restricted language (e.g., curse words, potentially offensive imagery, etc.). The rules service 209 can apply gender or sex-based rules to modify pronouns or other response language so as to conform to an intended recipient of the response 216. The rules service 209 can apply accessibility- or disability-based rules to format a response 216 for presentation to differently abled persons. For example, the rules service 209 can generate text descriptions of visual elements, thereby allowing communication of the visual elements to a visually impaired reader. As another example, where a response 216 includes multimedia or audio content, the rules service 209 can modify the response 216 to include a transcription of the content, thereby allowing communication of the content to an audio-impaired reader. As another example, an input 213 includes natural language requesting directions to a location. The rules service 209 can determine that the input 213 is associated with a person having mobility needs (e.g., based on one or more of a user profile 217, context 214, or intent 215). In response to the determination, the rules service 209 can instruct the response service 207 to identify or generate a response 216 that accommodates users with mobility impairments (e.g., utilizing disability-accessible routes to the location, connecting a user to an employee at the location, etc.).

The computing device 203 can include any network-capable electronic device, such as, for example, personal computers, smartphones, and tablets. The computing device 203 can transmit inputs 213 to the communication service 204 (e.g., via one or more channels 218), such as a requests or conversational inputs. The computing device 203 can include, but is not limited to, one or more inputs devices 221, one or more displays 223, and an application 225. The input device 221 can include one or more buttons, touch screens including three-dimensional or pressure-based touch screens, camera, finger print scanners, accelerometer, retinal scanner, gyroscope, magnetometer, or other input devices. The display 223 can include, for example, one or more devices such as liquid crystal display (LCD) displays, gas plasma-based flat panel displays, organic light-emitting diode (OLED) displays, electrophoretic ink (E ink) displays, LCD projectors, or other types of display devices, etc.

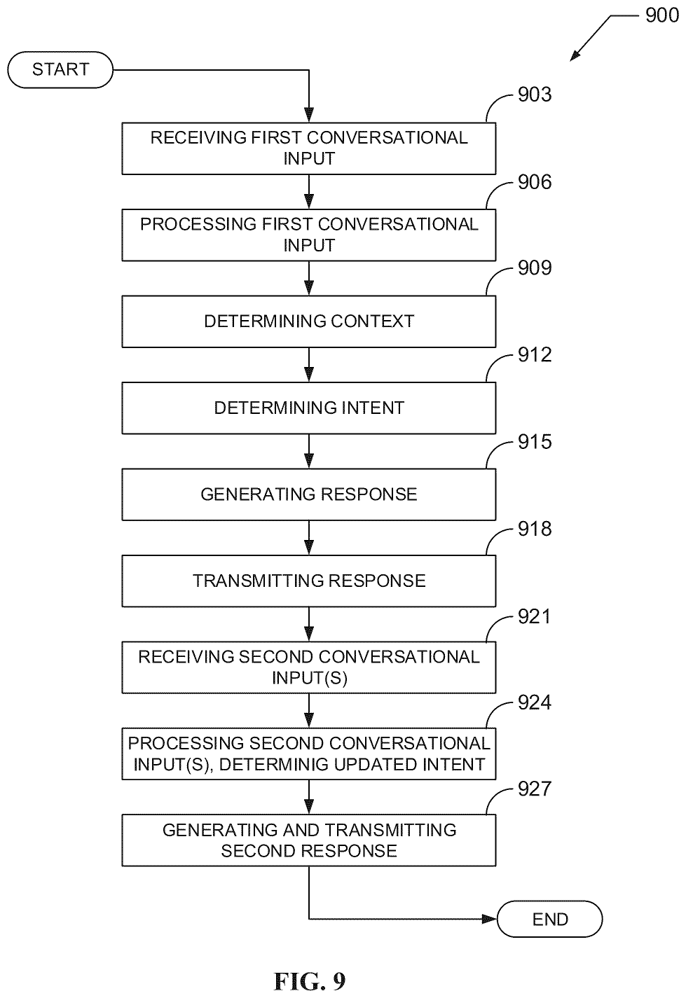

The application 225 can support and/or execute processes described herein, such as, for example, the response generation processes 900, 1000, 1100, 1200 shown in FIGS. 9, 10, 11, 12, respectively, and described herein. The application 225 can correspond to a web browser and/or a web page, a mobile app, a native application, a service, or other software that can be executed on the computing device 203. Where functions and actions of the computing device 203 are described herein, any of the functions and actions may be performed by the application 225. In some embodiments, the application 225 may be a standalone deployment of the contextual response system 201. The application 225 can generate user interfaces and cause the computing device 203 to render user interfaces on the display 223. For example, the application 225 generates a user interface including a user session comprising conversational inputs and responses to the conversational inputs.

The application 225 can generate inputs 213 and transmit the inputs 213 to the contextual response system 201. The application 225 can transmit additional factors including, but not limited to, device data, user profile data, and metadata. The application 225 can receive, from the contextual response system 201, responses 216. The application 225 can store inputs 213 and responses 216 in memory of the computing device 203 and/or at a remote computing environment configured to communicate with the computing device 203.

The external service 226 can include any public or private, network-capable computing environment (e.g., including virtual, cloud-based systems and physical computing systems). Non-limiting examples of the external service 226 include a language translation service, a location, mapping, and/or navigation service, a reservation management service, a point of sale service or other pricing service (e.g., such as a website or database of a food vendor or merchandise vendor), an inventory management service, a social media platform, a media platform (e.g., news outlet, news website, etc.), a multimedia platform (e.g., a streaming service, video on demand service, radio broadcast service, etc.), a health information service, or a public or private service associated with accessing event information (e.g., ticket prices, ticket availabilities, reservation confirmations, scheduling information, etc.). The external service 226 can transmit various information to the contextual response system 201, including, for example, translations of conversational inputs, values of dynamic content variables (e.g., or information by which the same may be determined), and variables for generating a response 216 (e.g., such as a location of a computing device 203, weather condition, product availability, etc.). The contextual response system 201 can transmit requests to the external service 226 and receive responses therefrom. For example, the NLP service 205 can transmit an input 213 of a first language to a translation service. The NLP service can receive, from the translation service, a translation of the input 213 in a second language (e.g., and the response service 207 may perform similar processes for a response 216). As another example, the response service 207 can request a location of the computing device 203 from a location service. The response service 207 can receive, from the location service, a current location of the computing device 203. As another example, the response service 207 can request a current price of a particular beer from a point of sale system. The response service 207 can receive, from the external service 226, the current price of the particular beers. As another example, the response service 207 transmits transaction data to a transaction processing service. The transaction processing service can authenticate the transaction data to process a corresponding transaction. The response service 207 can receive, from the transaction service, a confirmation that the transaction was successfully processed. The contextual response system 201 can communicate via any suitable network mechanism, such as an application programming interface (API).

### Exemplary System Features and Functions

FIG. 3 shows an exemplary communication service 204 and communication workflow 300. The communication service 204 can include, but is not limited to, containers 219, one or more container handlers 301, one or more conversation managers 303, one or more virtual assistant handlers 305, and one or more agent handlers 307. While not shown in FIG. 3, the channel handler 301 can include, but is not limited to, a channel input manager, a conductor, a data collector, and a channel output manger. In some embodiments, the conversion manager 303 is an element or subservice of the channel handler 301. The channel input manager can associate the input 213 with a channel 218. The channel input manger can receive a request that includes the input 213. The channel input manager can process the request to extract the input 213 and/or generate additional metadata (e.g., timestamp, user identifier, device identifier, location, associations with previous inputs 213, contexts 214, intents 215, or responses 216, etc.). The conductor can relay the input 213 to the conversation manager 303. The data collector can generate metadata associated with user sessions (e.g., also referred to herein as conversations). Non-limiting examples of the metadata include time stamps, user session identifiers, input identifiers, response identifiers, computing device identifiers, user account identifiers, and a time series record of a user session. The channel output manager can transmit responses 216 to computing devices 203 (e.g., via the same or a different channel 218 by which a corresponding input 213 was received).

The conversation manager 303 can associate a user session with a container 219 and can retrieve and deploy instances of the contextual response system 201 (e.g., or one or more elements thereof) based on the container 219. The conversation manager 303 can associate a user session with a container 219 by processing the input 213 and a channel 218 by which the input 213 was received (e.g., such as a particular URL address). The conversation manager 303 can retrieve or call instances of the NLP service 205, response service 207, and/or rules service 209 that are associated with the container 219. The conversation manager 303 can provide the input 213 to the one or more initiated services for processing. The conversation manager 303 may also provide additional data for processing, such as metadata or previous inputs 213, contexts 214, intents 215, or responses 216.

The conversation manager 303 can configure one or more settings of the NLP service 205, response service 207, and/or rule service 209 based on the container 219. Non-limiting examples of settings include input and output language, input and output vernacular, time zone, output character limits, and censorship of personal identifiable information or other protected data. The conversation manager 303 can retrieve one or more knowledge bases 212 associated with the container 219 and/or a context 214 with which the input 213 is determined to be associated. The conversation manager 303 can provide the one or more knowledge bases 212 to the NLP service 205 for processing. The conversation manager 303 can manage a time-series sequence of conversational inputs and outputs, including determining whether a virtual assistant handler 305 or a live agent handler 307 may respond to an input 309. In one example, the input 213 includes a request to speak to a live agent, human, or non-bot. Based on the input 213, the conversation manager 303 can relay the user session and the input 213 to a live agent handler 307. In some embodiments, the response service 207 performs the action(s) of determining whether a live or virtual agent may respond to an input 213. The conversation manager 303 may initially relay the input 309 to a virtual assistant handler 305. The conversation manager 303 may redirect the input 309 to a live agent handler 307 in response to receiving an indication from the virtual assistant handler 305 of a failure to respond to the input 309.

In the communication workflow 300, the solid line may indicate a pathway of an input 213 as received from the computing device 203 at the communication service 204 and processed via the NLP service 205 or a live agent handler 307. The dashed line may indicate a pathway of a response 216 as generated by the response service 207, formatted by the rules service 209, and transmitted to the computing device 203.

The computing device 203 can transmit the input 213 to the communication service 204 via a channel (not shown). The channel handler 301 can receive the input 213 and determine the channel by which the input 213 was received. The channel handler 301 can relay the input 213 and an indication of the channel to the conversation manager 303. The conversation manager can process the input 213 and the indication of the channel and, based thereon, associate the input 213 with a container 219. The conversation manager 303 can determine whether the input 213 may be responded to via a virtual agent (e.g., the NLP service 205 and response service 207) or a live agent. The conversation manager 303 can relay the input 213 to either of the virtual assistant handler 305 or the live agent handler 307 based on the determination. The virtual assistant handler 305 and the live agent handler 307 may be instances of said elements associated with the container 219.

The virtual assistant handler 305 can receive the input 213 from the conversation manager 303. The NLP service 205 can process the input 213 and one or more knowledge bases of the container 219 to determine a context of the input 213 and an intent of the input 213. The NLP service 205 may determine the context based at least in part on the input 213 and the container 219 (e.g., or the channel 218 with which the container is associated). The NLP service 205 may determine the intent based at least in part on the input 213 and the context. The response service 207 can receive the input 213, context(s), and intent(s) from the NLP service 205. The response service 207 can generate a response 216 based on the input 213, the context(s), and the intent(s). The response 216 can include a dynamic content variable. The response service 207 can request and receive a value of the dynamic content variable from an external service 226. The response service 207 can update the dynamic content variable based on the value. The rules service 209 can receive the response 216 from the response service 207. The rules service 209 can format the response 216 for various purposes including, but not limited to, suitability for transmission via the channel by which the input 213 was received and personalization. The virtual assistant handler 305 can relay the formatted response 216 from the rules service 209 to the conversation manager 303. Alternatively, the assistant handler 305 receives a response from the live agent handler 307 and relays the live agent response to the conversation manager 303. The conversation manager 303 can relay the formatted response 216, or live agent response, to the channel handler 301. The channel handler 301 can transmit the formatted response to the computing device 203 via the same or a different channel by which the input 213 was received.

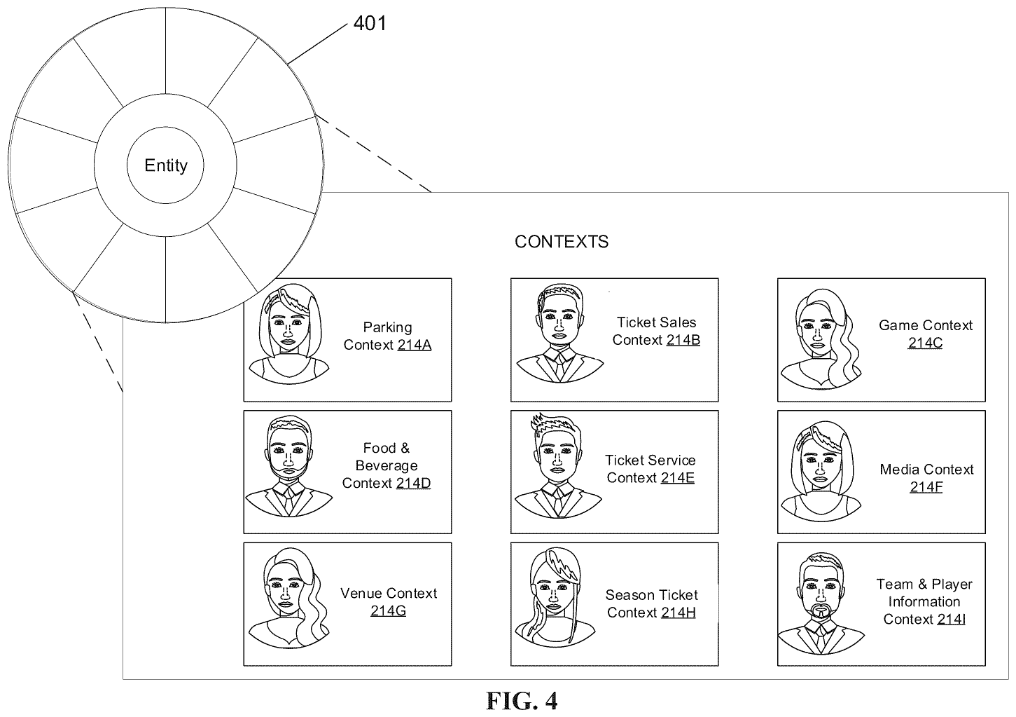

FIG. 4 shows exemplary contexts 214A-I. The contexts 214A-I may be associated with an entity 401. The entity 401 may be a sports franchise, such as, for example, a baseball team (e.g., including a venue at which games are hosted). The entity 401 may be a sports franchise, such as, for example, a baseball team (e.g., including a venue at which games are hosted). The contexts 214A-I may correspond to a set of computing resources for receiving and processing inputs 213 associated with a particular entity 401. The contexts 214A-I may relate to various aspects of managing operations and activities of the entity 1401, including the activities of entity customers and affiliates (e.g., fans, season ticket holders, vendors, emergency services, general staff, media outlets, statisticians, etc.). The contexts 214A-I include, for example, a parking context 214A, a ticket sales context 214B, a game context 214C, a food and beverage context 214D, a ticket service context 214E, a media context 214F, a venue context 214G, a season ticket context 214H, and a team and player information context 214I.

In one example, the parking context 214A may support rapid and automated navigation of customers to desired parking information. The parking context 214A may be associated with identifying and processing inputs 213 that relate to parking information, disability accommodations, VIP amenities, and other transportation questions. In another example, the food and beverage context 214D may be associated with identifying and processing inputs 213 for that relate to food and beverages (e.g., such as requests for food and beverage availability, location, pricing, and ordering). The NLP service 205 may associate an input 213 with the food and beverage context 214D in response to detecting, in the input 213, keywords and phrases for food items, beverage items, bars, eateries, dietary restrictions, and/or nutritional information. In another example, the venue context 214G may provide for rapid identification and processing of questions regarding health and safety, entry protocols, prohibited items, and other on-site venue queries.

Each context 214A-I may be associated with a knowledge base 212 (e.g., as shown in FIG. 2 and described herein). In some embodiments, two or more contexts 214A-I may share a knowledge base 212 (e.g., in addition to other, non-shared knowledge bases 212). For example, the ticket sales context 214B, ticket service context 214E, venue context 214G, and season ticket context 214H may each include an association with a shared knowledge base 212 while being simultaneously and individually associated with a different one of a plurality of other knowledge bases 212.

FIG. 5 shows an exemplary NLP service 205 and an exemplary NLP workflow 500. The NLP service 205 can process an input 213 to associate the input 213 with a context 214 and an intent 215. The below described operations may be performed to determine the context 214 or the intent 215 (e.g., with some variation, such as initially determining the context 214 and determining the intent 215 based at least in part on the context 214).

The NLP service 205 can process the input 213 via the sentence decomposer 507 (see, e.g., FIG. 2 and accompanying description herein). The sentence decomposer 507 can process the input 213 via one or more decomposition algorithms, techniques, or models. The sentence decomposer 507 can decompose the input 213, into constituent terms (e.g., words, punctuation, etc.). The phrase analyzer 509 can process the decomposed input 213. The phrase analyzer 509 can compare the input 213, or one or more constituent terms thereof, to one or more knowledge bases 212. The phrase analyzer 509 can perform intent class detection and entity class detection to generate a plurality of detections 511 including one or more entity detections and one or more intent detections. The resolver 513 can associate the input 213 with context(s) 214, intent(s) 215, and/or a level of granularity based on the detections 511 (e.g., and additional factors, such as metadata, previous inputs 213, previous contexts 214, previous intents 215, previous responses 216, or combinations thereof). The resolver 513 can generate a label based on the intent 215, the context 214, and/or the detections 511. The response service 207 can generate a response based on one or more of the input 213, the context 214, the intent 215, the detections 511, and the label. The rules service 209 can format the response as described herein. The response service 207 and/or the rules service 209 can generate a label 517 for representing and recording the response. The label 517 can include a concatenation of one or more outputs of processing the input 213. For example, the label 517 includes a concatenation of the context name, the context resolution, the intent name, the intent resolution, the response name, the response resolution, and/or name(s) of the response content.

In various embodiments, the data store 211 includes an NLP training data store 501 and a response training data store 502. The NLP training data store 501 can include data for training the response service 207 (e.g., one or more models or other elements thereof) to determine a context and an intent of an input 213. The NLP training data store 501 can include, for example, one or more training datasets comprising labeled or unlabeled historical inputs 213. The labeled historical inputs 213 can include labels for indicating an associated context 214 and an associated intent 215. The unlabeled historical inputs 213 may include only the natural language of the historical inputs 213. The labeled or unlabeled training data sets can include or exclude additional factors including, but not limited to, preceding inputs, preceding contexts, preceding intents, preceding responses, device data, user account data, and metadata.

The NLP service 205 can train a model 220 (not shown, see, e.g., FIG. 2 and accompanying description herein). The NLP service 205 can process a plurality of inputs 213 via a first iteration of the model 220 to generate a plurality of experimental contexts 214 and/or intents 215. The NLP service 205 can compare the plurality of experimental contexts 214 and intents 215 to known contexts 214 and intents 215 of the plurality of inputs 213. The NLP service 205 can determine one or more errors of the model 220 based on the comparison. The NLP service 205 can adjust one or more settings of the model 220 and generate a second iteration thereof (e.g., or resources used thereby in processing, such as a knowledge base 212) to reduce or eliminate the one or more errors. The NLP service 205 can iteratively train the model 220 and generate subsequent versions thereof until a particular iteration of the model 220 is generated that satisfies one or more predetermined performance thresholds (e.g., context accuracy, intent accuracy, precision, etc.). The NLP service 205 can store the particular iteration of the model 220 for use in live context and intent detection processes. The NLP service 205 may continue to train the model 220 on unlabeled training datasets and/or additional labeled training datasets over time (e.g., to ensure continuing model performance and stability).

The response service 207 can train a model 220 (not shown, see, e.g., FIG. 2 and accompanying description herein). The response service 207 can process a plurality of inputs 213, contexts 214, and/or intents 215 via a first iteration of the model 220 to generate a plurality of experimental responses 216. The response service 207 can compare the plurality of experimental responses 216 to known responses 216 to the plurality of inputs 213. The response service 207 can determine one or more errors of the model 220 based on the comparison. The response service 207 can adjust one or more settings of the model 220 and generate a second iteration thereof (e.g., or resources used thereby in processing, such as an intent 215 or context 214) to reduce or eliminate the one or more errors. The response service 207 can iteratively train the model 220 and generate subsequent versions thereof until a particular iteration of the model 220 is generated that satisfies one or more predetermined performance thresholds (e.g., response accuracy, response precision, response generation time, etc.). The response service 207 can store the particular iteration of the model 220 for use in response generation processes. The response service 207 may continue to train the model 220 on unlabeled training datasets and/or additional labeled training datasets over time.

FIG. 6 shows exemplary knowledge bases 212A-I and context rankings 601, 602. A container 219 (not shown, see FIG. 2 and accompanying description herein) may be associated with a plurality of knowledge bases 212A-I. Each of the plurality of knowledge bases 212A-I may be associated with a different context 214A-I. In some embodiments, not shown in FIG. 6, two or more knowledge bases may be associated with the same context. Each knowledge base 212A-I may include a plurality of knowledge tiers. As further shown in FIG. 7 and described herein, the plurality of knowledge tiers may include a global knowledge tier 703, vertical knowledge tier 705, a sub-vertical knowledge tier 707, and a local knowledge tier 709. The NLP service of the contextual response system can assign a level of information scope to each of the plurality of knowledge tiers. The plurality of knowledge tiers can be arranged in order of decreasing assigned information scope. For example, the plurality of knowledge tiers is arranged in order of global knowledge tier 703, vertical knowledge tier 705, sub-vertical knowledge tier 707, and local knowledge tier 709.

The contexts 214A-I (e.g., and/or knowledge bases 212A-I associated therewith) may be associated with a first context ranking 601. The NLP service may initially perform context detection based on the first context ranking 601. For example, the NLP service first determines if an input 213 may be associated with a top-ranked entry of the context ranking 601 (e.g., context 214A) by comparing the input 213 to the knowledge base 212A. In response to determining the input 213 is not associated with the top-ranked entry, the NLP service may determine whether the input 213 may be associated with a second-ranked entry of the context ranking 601 (e.g., context 214B). The NLP service may proceed through the entries of the context ranking 601 until determining that the input 213 is associated with a context 214E. The NLP service can generate a second context ranking based on the association of the input 213 with the context 214E. For example, the NLP service generates the second context ranking by re-ordering entries of the first context ranking 601 such that the context 214E is top-ranked. The NLP service may process a subsequent input based on the second context ranking 602 such that the NLP service first determines whether the subsequent input may be associated with the context 214E. In some embodiments, the NLP service 205 may generate, train, and execute one or more models 220 (e.g., shown in FIG. 2 and described herein) to generate a context ranking prediction. For example, the model 220 receives, as input, one or more previous inputs 213 and data associated therewith (e.g., contexts, intents, responses, etc.). The model 220 processes the input and generates a predicted ranking of contexts by which one or more subsequent inputs may be processed.

FIG. 7 shows an exemplary knowledge base 212. For the purposes of showing and describing aspects of the present systems and processes, the knowledge base 212 depicted in FIG. 7 and described herein is associated with a “Ticketing” context 214. The knowledge bases and/or knowledge volumes described herein may be associated with multiple contexts 214. For example, a knowledge base 212 can be associated with a “Ticketing” context 214 and a “Venue Information” context 214. As another example, a first knowledge volume can be associated with a “Ticket Sales” context 214 and a second knowledge volume can be associated with the “Ticket Sales” context 214 and a “Ticket Services” context 214.

The knowledge base 212 can include a global knowledge tier 703, a vertical knowledge tier 705, a sub-vertical knowledge tier 707, and a local knowledge tier 709. Each knowledge tier can include one or more knowledge volumes. Each knowledge volume can include keywords, key phrases, language patterns, and language conventions that are associated with one or more contexts 214 or intents 215 (e.g., for supporting intent-detection processes via matching of natural language from an input 213 to the contents of a knowledge volume, or subset thereof).

The global knowledge tier 703 can include one or more knowledge volumes 702. The knowledge volume 702 may include, but is not limited to, ticketing-related keywords, key phrases, and language patterns. The global knowledge tier 703 may be associated with a first level of information scope and a first level of granularity. In one example, the one knowledge volume 702 may include keywords “ticket,” “reservation,” “pass,” and various permutations thereof. The vertical knowledge tier 705 can include a plurality of knowledge volumes 706 that are each associated with a different category of the ticketing context 214. The vertical knowledge tier 705 may be associated with a second level of information scope that is less than the first level of information scope and a second level of granularity that is greater than the first level of granularity. The vertical knowledge tier 705 can include a first knowledge volume 706 associated with a “Sports” category, a second knowledge volume 706 associated with a “Museums, Aquariums, and Zoos” category, and a third knowledge volume 706 associated with a “Broadway” category. The first, second, and third knowledge volumes 706 can include information related to the corresponding category. For example, in the vertical knowledge tier 705, the first knowledge volume 706 may include sports- and athletics-related keywords, the second knowledge volume 706 may include museum-, aquarium-, and zoo-related keywords, and the third knowledge volume 706 may include Broadway-, theater-, and other stage production-related keywords.

The sub-vertical knowledge tier 707 can include a plurality of knowledge volumes 708 that are each associated with a different subcategory of one of the categories associated with the knowledge volumes of the vertical knowledge tier 705. The sub-vertical knowledge tier 707 can be associated with a third level of information scope that is less than the second level of information scope and a third level of granularity that is greater than the second level of granularity. The sub-vertical knowledge tier 707 can include a first set of knowledge volumes 708 that are associated with subcategories of the “Sports” category, a second set of knowledge volumes 708 that are associated with subcategories of the “Museums, Aquariums, and Zoos” category, and, while not shown in FIG. 7, a third set of knowledge volumes that are associated with subcategories of the “Broadway” category. The first set of knowledge volumes 708 can include a first knowledge volume associated with a “Baseball” subcategory, a second knowledge volume associated with a “Football” subcategory, and a third knowledge volume associated with a “Soccer” subcategory. The second set of knowledge volumes 708 can include a first knowledge volume associated with a “Museum” subcategory, a second knowledge volume associated with an “Aquariums” subcategory, and a third knowledge volume associated with a “Zoos” subcategory. The various sets of knowledge volumes 708 may include corpuses of information associated with the corresponding subcategory (e.g., subcategory-specific key terms, key phrases, language patterns, etc.). It will be understood and appreciated that the subcategories are provided by way of example and additional subcategories may be included (e.g., a “Softball” subcategory within the “Sports” category, a “Botanical Garden” subcategory within the “Museums, Aquariums, and Zoos” category, etc.).

The local knowledge tier 709 can include a plurality of knowledge volumes 710 that are each associated with one of the subcategories of the sub-vertical knowledge tier 709. The local knowledge tier 709 can be associated with a fourth level of information scope that is less than the third level of information scope and a fourth level of granularity that is greater than the third level of granularity. The local knowledge tier 709 can include a first set of knowledge volumes 710 that are each associated with one of the plurality of subcategories of the “Sports” category, a second set of knowledge volumes 710 that are each associated with one of the plurality of subcategories of the “Museums, Aquariums, and Zoos” category, and a third set of knowledge volumes 710 that are each associated with the “Broadway” category (e.g., or subcategories thereof, not shown in FIG. 7).

Referring to the local knowledge tier 709, a first subset of the first set of knowledge volumes 710 can include a “Baseball Team 1” knowledge volume and a “Baseball Team 2” knowledge volume that are each associated with the “Baseball” subcategory. The “Baseball Team 1” knowledge volume may include a corpus of keywords, key phrases, and language patterns associated with a first baseball team. For example, the “Baseball Team 1” knowledge volume includes a full name of the baseball team, terms for team play schedules (e.g., seeding, bye, home, away, etc.), terms for ticket types and titles (e.g., “adult,” “child,” “senior”, “fast pass”, “Red Deck Pass,” etc.), team nickname, team mascot, home city, training schedule, current team roster, and one or more historical team rosters. The “Baseball Team 2” knowledge volume may include similar types information associated with a second baseball team. A second subset of the first set of knowledge volumes 710 can include a “Football Team 1” knowledge volume and a “Football Team 2” knowledge volume that are each associated with the “Football” subcategory (e.g., with divisions of information therein similar to the “Baseball Team 1” and “Baseball Team 2” knowledge volumes, but as related to a first and a second football team). A third subset of the first set of knowledge volumes 710 can include a “Soccer Team 1” knowledge volume and a “Soccer Team 2” knowledge volume that are each associated with the “Soccer” subcategory and a respective soccer team.

Still referring to the local knowledge tier 709, a first subset of the second set of knowledge volumes 710 can include a “Museum 1” knowledge volume and a “Museum 2” knowledge volume that are each associated with the “Museum” subcategory. The “Museum 1” knowledge volume may include a corpus of keywords, key phrases, and language patterns associated with a first museum. For example, the “Museum 1” knowledge volume includes a name of the first museum, ticket types, ticket prices, ticket availabilities, ticket restrictions, ticketing schedules, operating hours, and museum location. The “Museum Team 2” knowledge volume may include similar types information associated with a second museum. A second subset of the second set of knowledge volumes 710 can include an “Aquarium 1” knowledge volume and an “Aquarium 2” knowledge volume that are each associated with the “Aquarium” subcategory (e.g., with divisions of information therein similar to the “Museum 1” and “Museum 2” knowledge volumes, but as related to a first and a second aquarium). A third subset of the second set of knowledge volumes 710 can include a “Zoo 1” knowledge volume and a “Zoo 2” knowledge volume that area each associated with the “Zoo” subcategory and a respective zoo.

The third set of knowledge volumes 710 of the local knowledge tier 709 may be associated with the “Broadway” category. The third set of knowledge volumes 710 may include a plurality of subsets that each correspond to a respective Broadway show. The plurality of subsets may include, for example, a first subset of knowledge volumes associated with a “Show 1,” a second subset of knowledge volumes associated with a “Show 2,” a third subset of knowledge volumes associated with a “Show 3,” a fourth subset of knowledge volumes associated with a “Show 4,” a fifth subset of knowledge volumes associated with a “Show 5,” and a sixth subset of knowledge volumes associated with a “Show 6.” Each of the subsets of knowledge volumes may include, for example, show ticket types, ticket restrictions, show title (e.g., “Macbeth,” “Phantom of the Opera,” etc.), show nickname (e.g., “The Scottish Play,” “Phantom,” etc.), show director, show cast, and show venue. It will be understood and appreciated that any of the above-described individual knowledge volumes may instead refer to or be comprised of a plurality of knowledge volumes.

FIG. 8 shows an exemplary response resolution schema 800. The response service 207 (shown in FIG. 2 and described herein) can generate a response via the response resolution schema 800 shown in FIG. 8 and/or the response generation processes 900, 1000, 1100, 1200 shown in respective FIGS. 9, 10, 11, 12 and described herein.

The response resolution schema 800 can include, as input, an intent 215. The response service 207 can generate a response variable 801 based on the intent 215. The response service 207 can identify or generate a response to a conversational input (e.g., response 216 and input 213 shown in FIG. 2 and described herein) based on the response variable 801. In some embodiments, the intent 215 is a concatenation of context(s) and intent(s) with which an input 213 was associated (e.g., by the NLP service 205 shown in FIG. 2 and described herein). For example, an input 213 includes natural language “Where can I get a hoppy craft beer?” The NLP service 205 can process the natural language and associate the input 213 with a food and beverages context (e.g., [Context:Food/Beverage]) and an intent variable of finding a hoppy craft beer (e.g., [Intent:Find_Hoppy_Craft_Beer]. The NLP service 205 can generate an intent 215 by concatenating the detected context and intent variable (e.g., [Food/Beverage:Find_Hoppy_Craft_Beer]). The response service 207 can generate a response variable 801 based on the intent 215. For example, based on an intent 215 of “[Food/Beverage:Find_Hoppy_Craft_Beer],” the response service 207 can generate a response variable 801 of “Response:[Hoppy_Craft_Beer_Location].”

The response resolution schema 800 can include a main response track 803, a fallback response track 805, and a base response track 807. The main response track 803, fallback response track 805, and base response track 807 can each be associated with a different level of information scope. The main response track 803, fallback response track 805, and base response track 807 can each include a plurality of potential responses.

The responses of the main response track 803 may be associated with a higher level of granularity (e.g., greater specificity) as compared to the potential responses associated with the fallback response track 805 and the base response track 807. For example, in a food and beverages context associated with a particular baseball stadium, the potential responses associated with main response track 803 may be derived from an inventory management system of the particular baseball stadium and/or a mapping of vendor offerings at the particular baseball stadium. The responses of the fallback response track 805 may be associated a greater granularity as compared to potential responses associated with the base response track 807. Continuing the preceding example, the potential responses associated with the fallback response track 805 may be derived from historical inventory data from a plurality of baseball stadiums (e.g., including or excluding the particular baseball stadium). The responses of the base response track 807 may be associated with a lower level of granularity as compared to the main response track 803 and fallback response track 805. In the preceding example, potential responses associated with the base response track 805 may include default responses, such as “we are unable to answer that question at this time” or “please wait, we are connecting you to a live agent.”

The response service 207 can order the respective responses of the main response track 803, fallback response track 805, and base response track 807 based on a level of granularity associated with each response. In each of the main response track 803, fallback response track 805, and base response track 807, the responses may be ranked in order of decreasing granularity (e.g., most specific to least specific). In some embodiments, a second-ranked response of the main response track 803 may be associated with a lower level of granularity as compared to a first-ranked response of the fallback response track 805.

The response service 207 can generate the response 216 by scanning through the main response track 803, fallback response track 805, and base response track 807 based on the response variable 801. The response service 207 can scan through the top-ranked entry of each of the main response track 803 and fallback response track 805 to determine if the top-ranked entry is available and whether the top-ranked entry satisfies the response variable 801. For example, the response service 207 evaluates a first response 802 of the main response track 803 based on the response variable 801. In this example, in response to determining the first response 802 does not satisfy the response variable 801 (e.g., or that the first response 802 is not available), the response service 207 evaluates a first response 804 of the fallback response track 805. In response to failing to identify an appropriate response 216 from the top-ranked entry of the main response track 803 and the fallback response track 805, the response service 207 proceeds to evaluate a second-ranked entry of the main response track 803 and the fallback response track 807. The response service 207 may proceed with evaluating entries of the main response track 803 and the fallback response track 805 (e.g., alternating between the response tracks 803, 805) until identify an entry that satisfies the response variable 801 (e.g., said entry being selected by the response service 207 as the response 216 for responding to the input 213 with which the response variable 801 is associated).

In some embodiments, at each ranking level, the response service 207 also evaluates an entry of the base response track 807 (e.g., in response to a determination that the response of the fallback response track 805 fails to satisfy the response variable 801). For example, in response to determining that the first response 802 of the main response track 803 and the first response 804 of the fallback response track 805 fail to satisfy the response variable 801 (e.g., or if the responses are not available), the response service 207 may evaluate a first response 806 from the base response track 807. In other embodiments, the response service 207 evaluates responses of the base response track 807 (e.g., beginning with a top-ranked entry thereof) after determining that an appropriate response cannot be identified in either of the main response track 803 and the fallback response track 805. For example, in response to determining that no variable-matching or variable-satisfying response exists in either of the main response track 803 and the fallback response track 805, the response service 207 evaluates the first response 806 of the base response track 807 (e.g., and subsequent ranked responses, until a response match is identified).

In some embodiments, the response service 207 identifies a most-specific response to the conversational input. The response service 207 may determine that the most-specific response to the conversational input is beyond a scope of the conversational input (e.g., based on intent of the input, granularity of the input, deficiency of information in the input, etc.). The response service 207 can recurse back from the most-specific response to a most appropriate response of the same or a different response track. The response service 207 may determine a most appropriate response based on one or more factors including, but not limited to, intent of the input, intent of one or more previous inputs, one or more previous responses, deficiency of information in the input or one or more previous inputs, device data, user profile data, and metadata.

The fallback response track 805 shown in FIG. 8 may be one of a plurality of fallback response tracks 805. The response service 207 may evaluate entries of multiple fallback response tracks 805 while attempting to determine a response 216. The multiple fallback response tracks 805 may include fallback response tracks associated with the same context 214 with which an input 213 is associated or a different context 214. For example, a base response track 803 and a first fallback response track 805 may be associated with a food and beverages context 214, and a second fallback response track 805 may be associated with a nutrition context 214. When attempting to identify a response 216 to an input 213 associated with the food and beverages context 214, the response service 207 may evaluate entries of the main response track 803, the first fallback response track 805, and the second fallback response track 805. In this example, the second fallback response track 805 may constitute a main response track 803 when the response service 207 attempts to identify a response 216 to an input 213 associated with the nutrition context 214.

### Exemplary Processes

FIG. 9 shows an exemplary response generation process 900 that may be performed by an embodiment of the present contextual response systems, such as the contextual response system 201 shown in FIG. 2 and described herein. As will be understood by one having ordinary skill in the art, the steps and processes shown in FIG. 9 (and those of all other flowcharts and sequence diagrams shown and described herein) may operate concurrently and continuously, are generally asynchronous and independent, and are not necessarily performed in the order shown.

At step 903, the process 900 includes receiving a conversational input, referred to in the proceeding description of the process 900 as a first input 213 (see also FIG. 2 and accompanying description herein). The communication service 204 can receive the first input 213 from a computing device 203 (e.g., via an application 225, browser, SMS text message, voice message, etc.). The communication service 204 can receive the first input 213 at a particular uniform resource locator (URL) address. The communication service 204 can receive the first input 213 via a channel 218 (e.g., shown in FIG. 2 and described herein). For example, the communication service 204 receives the first input 213 via an SMS text message. In another example, the communication service 204 receives the first input 213 via an instant messaging service of a social media platform. In another example, the communication service 204 receives the first input 213 via an input to a physical kiosk or tablet (e.g., which may be placed within or adjacent to a venue or other place of business).

The first input 213 can include natural language. The first input 213 can be formatted as one or more text strings. The first input 213 can include one or more audio files (e.g., a voice recording or other sound file). The first input 213 can include one or more images, videos, or other multimedia files. The first input 213 can include, but is not limited to, device data, user account data, and metadata. The device data can include, but is not limited to, device geolocation, phone number, serial number, media access control (MAC) address, Internet protocol (IP) address, beacon identifier, and other device-identifying data. The user account data can include, but is not limited to, username, user account identifier, and user preferences (e.g., language, location, security settings, content viewing permissions, accessibility settings, etc.). The metadata can include, but is not limited to, a timestamp, a channel 218 type, or an identifier for a container 219 by which the request was received.

In some embodiments, prior to receiving the conversational input, the contextual response system 201 receives a request. For example, the communication service 204 automatically receives a request in response to a browser of the computing device 203 accessing a particular URL address associated with the contextual response system 201. In another example, the communication service 204 automatically receives a request in response to the computing device 203 initiating the application 225. The request can include, but is not limited to, device data, user account data, and metadata. The device data can include, but is not limited to, device geolocation, phone number, serial number, media access control (MAC) address, Internet protocol (IP) address, beacon identifier, and other device-identifying data. The user account data can include, but is not limited to, username, user account identifier, and user preferences (e.g., language, location, security settings, content viewing permissions, accessibility settings, etc.). The metadata can include, but is not limited to, a timestamp, a channel 218 type, or an identifier for a container 219 by which the request was received. The communication service 204 can process the request to generate, determine, or retrieve the device data, user account data, and/or metadata. The NLP service 205, response service 207, and rules service 209 may process the request, and data derived therefrom or obtained based thereon, to improve context detection, intent detection, response identification and generation, and response formatting. In response to receiving the request, the communication service 204 may cause the computing device 203 to render a user interface for displaying a conversation (e.g., including inputs from the computing device 203 and responses from the contextual response system 201). The communication service 204 can determine a container 219 with which the request is associated. The communication service 204 can retrieve or generate one or more visual elements based on the determined container 219. The communication service 204 can cause the computing device 203 to render the visual element(s) on the user interface.

At step 906, the process 900 includes processing the first conversational input of step 903 (e.g., still referred to in the description of the process 900 as the first input 213). The communication service 204 can process the first input 213 and the particular URL address to associate the first input 213 with a container 219. In other words, the communication service 204 may process the first input 213 to identify a set of resources of the contextual response system 201 most appropriate for responding to the first input 213. As shown in FIG. 3 and described herein, the communication service 204 can process the first input 213 via one or more of a channel handler 301, a conversation manager 303, and a virtual assistant handler 305 (e.g., or live agent handler 307). The communication service 204 can process the first input 213 to generate, determine, or retrieve the device data, user account data, and/or metadata. The NLP service 205 can process the first input 213 to modify the input 213, enhance the input 213, normalize the input 213, and/or to generate metadata for use in steps 909 and 912 described herein.

In some embodiments, the communication service 204 determines if the first input 213, or a user account 217 or computing device 203 associated therewith, is associated with a previous conversation. For example, the communication service 204 determines that the first input 213 is associated with a prior conversation that prematurely terminated before one or more conversational inputs thereof were resolved (e.g., via the contextual response system 201 providing a response to the conversational input(s)). In response to determining that the first input 213 was associated with a prior conversation, the communication service 204 may retrieve the prior conversation and data associated therewith and provide the prior conversation to the NLP service 205, response service 207, and rules service 209 for processing and improvement of functions and operations described herein.

At step 909, the process 900 includes determining a context of the first input 213. In the present description of the process 900, the context of the first input 213 may be referenced as the context 214 (see also context 214 shown in FIG. 2 and described herein). The NLP service 205 can process the first input 213 to associate the first input 213 with a context. The NLP service 205 can compare the first input 213 to one or more knowledge bases 212 (e.g., shown in FIG. 2 and described herein). The NLP service 205 can process the first input 213 to identify and extract keywords and phrases therein. The NLP service 205 can compare the keywords and phrases to the knowledge base(s) 212. In response to determining a match between the keywords and phrases and a particular knowledge base 212, the NLP service 205 can determine the context 214 of the first input 213 as the context with which the particular knowledge base 212 is associated. The NLP service 205 can determine the context 214 based on one or more additional factors including, but not limited to the container 219 with which the first input 213 is associated, device data, user account data, and metadata. The NLP service 205 can store the context 214 of the first input 213 at the data store 211. The NLP service 205 can generate and append to the first input 213 a tag or label for indicating the context 214.

As shown in FIG. 6 and described herein, the NLP service 205 can perform context detection in a rank-wise manner. The NLP service 205 can retrieve a context ranking associated with the container 219. The NLP service 205 can determine if the first input 213 may be matched to a first-ranked entry of the context ranking (e.g., by comparing the first input 213 to one or more knowledge bases 212 associated with the first-ranked entry). The NLP service 205 can determine that the first input 213 is not associated with the first-ranked entry and, in response, determine if the first input 213 may be matched to a second-ranked entry of the context ranking (e.g., and evaluate subsequent ranked entries in order of the context ranking until the first input 213 can be matched to at least one entry). The NLP service 205 can determine the context 214 of the first input 213 by determining that the keywords and phrases of the first input 213 demonstrate a threshold-satisfying similarity to a knowledge base 212 of a particular context. In some embodiments, the NLP service 205 does not apply a similarity threshold but determines the context 214 of the first input 213 based on the knowledge base 212 that is most similar to the keywords and phrases of the first input 213. The NLP service 205 can update the context ranking based on the context determined to be associated with the first input 213. The NLP service 205 can re-order entries of the context ranking such that a matched context is reordered to the top of the context ranking. The NLP service 205 can store the updated context ranking in the data store 211 (e.g., for retrieval in processing subsequent conversational inputs).

At step 912, the process 900 includes determining an intent of the first input 213. In the present description of the process 900, the second conversational input may be referenced as the first intent 215. The NLP service 205 can process the first input 213 and the context 214 to determine the intent 215. The NLP service 205 can determine the intent 215, at least in part, by comparing the first input 213 to one or more knowledge bases 212 associated with the context 214. The NLP service 205 can generate statistical metrics for associating the first input 213 with one or more terms of a knowledge base 212 (e.g., and the NLP service 205 may generate intent variables based on the terms). The statistical metrics can include similarity metrics for comparing terms of the first input 213 to terms of the knowledge base 212 (e.g., cosine distance, Euclidean squared distance, Manhattan distance, Hamming distance, Jaccard similarity, etc.). The statistical metrics can include measures of probability, such as a predicted probability that the first input 213 is associated with each of a plurality of intents. The NLP service 205 can apply models 220 for determining the intent, such as, for example, topic classification models, random forest classification models, or convolutional neural networks.

The NLP service 205 can perform sentence decomposition, phrase detection, and multi-class resolving to determine the intent 215 (e.g., see FIG. 5 and accompanying description). The NLP service 205 can generate intent variables (e.g., requested actions) and entity variables (e.g., objects or subjects of the requested actions) and resolve the intent variables and entity variables into the intent 215. The NLP service 205 can generate and append to the first input 213 a tag or label for indicating the intent 215. The NLP service 205 can concatenate the context 214 and the intent 215 to generate the tag.

The NLP service 205 can determine multiple intents from the first input 213. For example, the first input 213 includes “can I buy 2 adult tickets and a child ticket?” The NLP service 205 may determine that the first input 213 is associated with a ticketing context. The NLP service 205 may determine a first intent of the first input 213 as purchasing adult tickets (e.g., tickets:tickets-adults-buy) and a second intent of the first input 213 as purchasing a child ticket (e.g., “tickets:tickets-kids-buy). The NLP service 205 can generate separate tags or a shared tag for indicating the multiple intents. A multiple-intent tag may include, for example, a concatenation of the tags for each intent.

At step 915, the process 900 includes generating a response to the first input 213 based on the context 214 and the intent(s) 215. In the present description of the process 900, the response to the first input 213 may be referenced as the first response 216. The response service 207 can generate the first response 216 by processing the first input 213, the context 214, and the first intent 215. The response service 207 can execute one or more algorithms, models 220, or other techniques to scan through one or more decision trees and determine an entry thereof by which to generate the first response 216. The response service 207 can evaluate entries of a main response track and one or more fallback response tracks (e.g., see also the response resolution schema 800 shown in FIG. 8 and described herein). The response service 207 can attempt to identify a response entry of maximum specificity (e.g., highest granularity) for responding to the first input 213. In some embodiments, in response to failing to identify a response in the context 214 of the first input 213, the response service 207 attempts to generate the first response 216 based on one or more additional contexts. When attempting to generate the first response 216 in a different context, the response service 207 may retrieve the context ranking utilized and, in some embodiments, updated by the NLP service 205. In response to failing to identify a response in a main response track or a fallback response track, the response service 207 may evaluate a base response track that includes one or more default responses, such as “Sorry, we are unable to answer that at this time, would you like me to alert you when we have an answer?” or “can I refer you to a live agent?” The first response 216 can include, but is not limited to, natural language, dynamic content variables, selectable links, visual elements, audio elements, metadata, and combinations thereof. The response service 207 can determine a dynamic content variable associated with the first response 216, such as, for example, a price of a beverage, availability of a ticket, operating hours of a business, or statistical value (e.g., sports team records, traffic delay time, estimated line wait, etc.). The response service 207 can generate a value of the dynamic content variable based on information stored in the data store 211, communication with an external service 226, or other sources, such as an automated Internet search. The response service 207 can update the first response 216 to include the value of the dynamic content variable. The response service 207 can adjust the response 216 based on the value of the dynamic content variable.

The response service 207 can determine that the intent 215 may be unworkable based on the value of the dynamic content variable. For example, the intent 215 may be an intent to travel to a particular venue prior to a closing time of the venue. The response service 207 may determine that a dynamic content variable for the closing time of the venue is beyond a timestamp of the first input 213. In response, the response service 207 may update the response 216 to include an indication that the requested activity associated with the first input 213 may be unworkable. In another example, the intent 215 may be an intent to purchase a beer at a baseball stadium during a baseball game. The response service 207 may determine that alcohol sales at the baseball stadium are suspended following the eighth inning and that the baseball game is currently in its ninth inning. In response, the response service 207 may update the first response 216 to replace a dynamic variable for beer price or availability with an indication that the requested purchase cannot be made due to timing constraints.

The response service 207 can determine a most-specific response to the first input 213. The response service 207 can determine if the most-specific response is appropriate for responding to the first input 213. The response service 207 and/or the rules service 209 can determine appropriateness based on one or more factors including, but not limited to intent of the first input 213, preset heuristics and/or logical rules, intent of one or more historical inputs, one or more historical responses, deficiency of information in the first input 213, device data, user profile data, and metadata. The response service 207 can recurse from the most-specific response to one or more less-specific responses until the response service 207 identifies a response that is appropriate for a reply to the first input. In one example, the first input 213 includes “I want to buy a ball.” The response service 207 may determine that a most-specific response includes “Great! You can buy an autographed baseball at the team store for $300.” The response service 207 may determine that the most-specific response is inappropriate because the first input 213 does not indicate an intent to purchase an autographed baseball, a baseball at the team store, or a baseball itself.” The response service 207 may recurse from the most-specific response to a less-specific response that is appropriate for replying to the first input 213. The less-specific response to the first input 213 may include “Great! What kind of ball would you like purchase? Would you like to purchase online or in-person?”

At step 918, the process 900 includes transmitting the first response 216 to the computing device 203 from which the first input 213 was received. The rules service 209 can format the first response 216 for various purposes, such as modifying the first response 216 to include personal pronouns, translating the language of the first response 216, formatting the first response 216 to comply with accessibility settings, or formatting the first response 216 for transmission via the channel 218 by which the first input 213 was received. The communication service 204 can transmit the first response 216 to the computing device 203 via the channel 218.

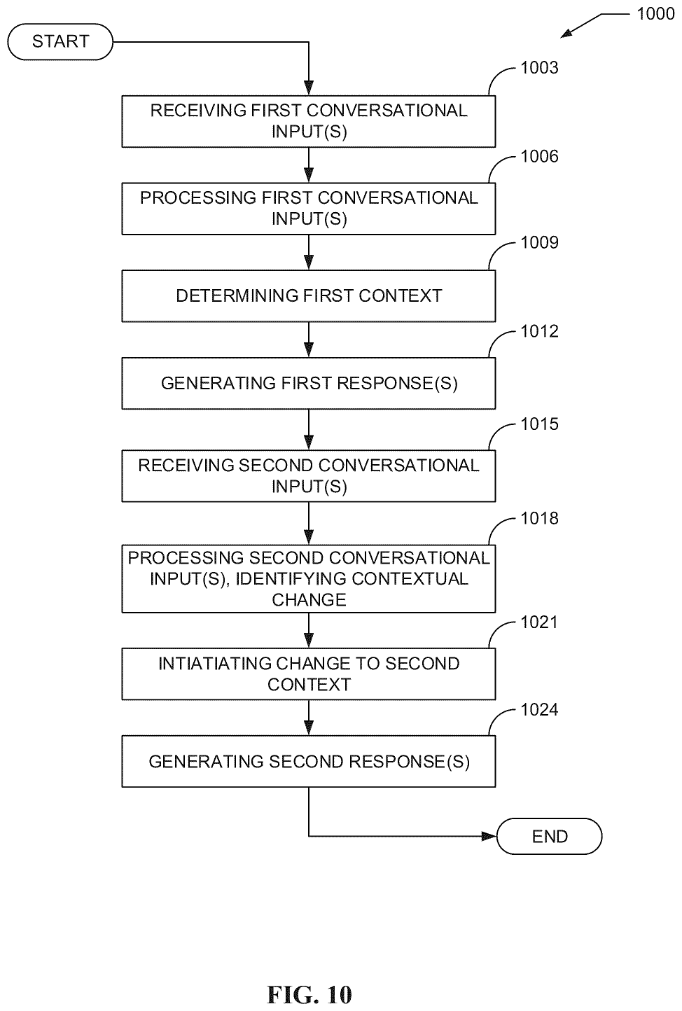

At step 921, the process 900 includes receiving a second conversational input 213. In the present description of the process 900, the second conversational input may be referenced as the second input 213. In some embodiments, step 921 may be performed similar to one or more of steps 903, 906, 909. The communication service 204 can process the second input 213 to generate device data, user account data, and/or metadata. The NLP service 205 can perform context detection to determine if the second input 213 is associated with the same context 214 as the first input 213 or a different context (e.g., see also process 1000 shown in FIG. 10 and described herein).

At step 924, the process 900 includes processing the second input 213 and determining an updated intent based thereon. In the present description of the process 900, the updated intent may be referenced as the second intent 215. The NLP service 205 can process the second input 213, the context 214 of the second input 213, and the container 219 (e.g., including a URL address associated therewith) to determine the second intent 215. The NLP service 205 may also evaluate additional factors for determining the second intent 215, such as, for example, the first input 213, the first intent 215, the first response 216, device data, user account data, and metadata.

In an exemplary scenario, the first input 213 includes natural language “I want to go the next Buccaneers game” and is received via a URL address associated with the Tampa Bay Buccaneers baseball team. The NLP service 205 processes the natural language and the URL address and determines that the first input 213 is associated with a ticketing context 214. The NLP service 205 processes the first input 213 and the ticketing context 214 and determines that the first input 213 is associated with a first intent 215 of purchasing a ticket to the next Tampa Bay Buccaneers baseball game. The response service 207 generates a first response 216 based on the first input 213, the ticketing context 214, and the first intent 215. The first response 216 includes natural language of “Terrific! You can purchase a ticket to the next Buccaneers game on September 30^{th} starting at $40” and a selectable link for purchasing an adult ticket. The second input 213 includes natural language of “Are there any deals for kids?” The NLP service 205 processes the natural language and the URL address and determines that the second input 213 is associated with the ticketing context 214. The NLP service 205 processes the natural language and the ticketing context 214 (e.g., and, in some embodiments, the first input 213 and/or the first response 216) and determines a second intent 215 of purchasing a ticket package including a child ticket.

At step 927, the process 900 includes generating and transmitting a response to the second input 213. In the present description of the process 900, the response to the second input 213 may be referenced as the second response 216. The response service 207 can generate the second response 216 based on the second intent 215 and the context 214. The response service 207 can generate the second response 216 based on additional factors, such as the first input 213, the first response 216, device data, user account data, and metadata. The second response 216 may include one or more dynamic content variables. The response service 207 can process the dynamic content variable(s) to generate or retrieve a value thereof and modify the second response 216 to include the value.

The rules service 209 can format the second response 216 as described herein. The communication service 204 can transmit the second response 216 to the computing device 203 from which the second input 213 was received. The contextual response system 201 can perform additional appropriate actions. The contextual response system 201 can store the conversation in a user profile 217 associate with the computing device 203. The contextual response system 201 can initiate transaction processing operations to complete a requested purchase associated with the conversation. The contextual response system 201 can transmit a command or request one or more external services 226, such as, for example, an external ticketing service, a live guest assistance service, or an emergency service. The contextual response system 201 can update a subscriber list to include the computing device 203 or a user account 217 (e.g., thereby facilitating transmission of future responses to the computing device 203, if, for example, the contextual response system 201 is unable to identify a suitable response to the conversational input(s)). After step 927, the process 900 can proceed to step 921 to process additional conversational inputs.

FIG. 10 shows an exemplary response generation process 1000 that may be performed by an embodiment of the present contextual response systems, such as the contextual response system 201 shown in FIG. 2 and described herein. In various embodiments, the process 1000 show in FIG. 10 and described herein demonstrates the ability of the contextual response system to identify transitions in input context and transition from responding to conversational inputs in a first context to responding to conversational inputs in a second context.

At step 1003, the process 1000 includes receiving one or more first conversational inputs (see, e.g., input 213 shown in FIG. 2 and described herein). Step 1003 may be similar to step 903 of the process 900 shown in FIG. 9 and described herein. The first conversational input can include natural language, such as “GA ticket to the Rolling Stones show.”

At step 1006, the process 1000 includes processing the first conversational input. Step 1006 may be similar to step 906 of the process 900. The communication service 204 can process the first conversational input, a channel by which the first conversational input was received, and/or a URL address associated with receipt of the first conversational input. The communication service 204 can associate the first conversational input with a container (see, e.g., container 219 shown in FIG. 2 and described herein). For example, the communication service 204 associates the first conversational input with a particular container that is associated with a venue, the House of Blues Chicago. The NLP service 205 can process the first conversational input based on the container and can generate various determinations based thereon (see, e.g., step 1009).

At step 1009, the process 1000 includes determining a context (see, e.g., context 214 shown in FIG. 2 and described herein) of the first conversational input. In the present description of the process 1000, the context of the first conversational input may be referenced as the first context. Step 1009 may be similar to step 909 of the process 900. The NLP service 205 can determine the first context based on the first conversational input and, in some embodiments, additional factors, such as the container, the URL address associated with the container, previous conversational inputs and contexts, intents, and responses associated therewith, device data, user account data, and metadata. In one example, the NLP service 205 processes the first conversational input and associates the first conversational input with a ticketing context. In some embodiments, the NLP service 205 updates a ranking of potential contexts such that the first context is a top-ranked entry.

Following step 1009, the process 1000 may include determining one or more intents of the first conversational input. The operation of the determining the one or more intents may be similar to step 912 of the process 900. In one example, based on the first conversational input and the context thereof, the NLP service 205 determines an intent of the first conversational input as “tickets.tickets-generaladmission-buy.”

At step 1012, the process 1000 includes generating a response (see, e.g., response 216 shown in FIG. 2 and described herein) to the first conversational input. In the present description of the process 1000, the response to the first conversational input may be referenced as the first response. Step 1012 may be similar to step 915 of the process 900. The response service 207 can generate the first response (e.g., or multiple, respective first responses to each of a plurality of first conversational inputs) based on one or more of the context of the first conversational input, the intent of the first conversational input, and additional factors. For example, the response service 207 generates a first response including “Great! There are still tickets available to the “Stones.” and a selectable link for completing a transaction for a ticket to the performance at the corresponding venue. The rules service 209 can format the first response as described herein.

Following step 1012, the communication service 204 can transmit the first response to the computing device 203 from which the first conversational input was received.

At step 1015, the process 1000 includes receiving one or more second conversational inputs. Step 1015 may be similar to the steps 903, 921 of the process 900. The communication service 204 can receive the second conversational input via the same or a different channel as the first conversational input. The second conversational input includes natural language, such as “where will I park?”

At step 1018, the process 1000 includes processing the second conversational input and identifying a contextual change. The contextual change can include a disassociation of the second conversational input from the first context and an association of the second conversational input with a second context (see, e.g., step 1021). The NLP service 205 can process the second conversational input, for example, by comparing the second conversational input to the first conversational input and/or one or more knowledge bases associated with the first context. In response to determining that the second conversational input is not associated with the first context (e.g., based on a level of dissimilarity, a reduced level of similarity as compared to the first conversational input, combinations thereof, etc.), the NLP service 205 can determine that the second conversational input is not associated with the first context. The NLP service 205 can determine that the second conversational input is associated with a second context. For example, the NLP service 205 determines that the second conversational input is associated with a parking context.

As shown in FIG. 6 and described herein, the NLP service 205 can evaluate the second conversational input with respect to a ranking of potential contexts (e.g., potentially initiating with the first context). For example, the NLP service 205 retrieves a ranking of potential contexts and determines whether the first conversational input is associated with a top-ranked entry (e.g., the first context) or a lower-ranked entry.

At step 1021, the process 1000 includes initiating a change to the second context. The NLP service 206 can initiate the change to the second context by determining an updated intent (e.g., a second intent, corresponding to the second conversational input) based on the second context, the second conversational input, additional factors, or combinations thereof. The response service 207 can update the ranking of potential contexts such that the second context is a top-ranked entry (e.g., the first context potentially becoming a second-ranked entry).

The NLP service 205 can process the second conversational input and the second context and determine an intent of the second conversational input, referred to as the second intent. The second intent includes, for example, “parking information:parking_location-learn.”

In some embodiments, the NLP service 205 predicts a third context of a future conversational input and updates the context ranking such that the predicted third context is a top- or higher-ranked entry. For example, based on one or more of the first context, the first intent, the first response, the second conversational input, the second context, the second intent, and additional factors, the NLP service 205 updates the context ranking such that a food and beverages context becomes a top- or high-ranked entry thereof.

At step 1024, the process 1000 includes generating a response to the second conversational input. In the present description of the process 1000, the response to the second conversational input may be referenced as the second response. Step 1024 may be similar to step 1012 or step 915 of the process 900. The response service 207 can generate the second response (e.g., or multiple, respective second responses to each of a plurality of second conversational inputs) based on one or more of the second context, the second intent, and additional factors. For example, the response service 207 generates a second response including “Yes! You can reserve valet parking at Marina Towers (300 N State St.) before heading to your event. For a self-park option, check out the Greenway Garage (58 W Kinzie St.)” and an image comprising a map of parking locations adjacent the corresponding venue. The rules service 209 can format the first response as described herein. In some embodiments, prior to generating the second response, the NLP service 205 may process the first conversational input based on the second context. For example, the NLP service 205 processes the first conversational input based on the parking context and determines an updated second intent (e.g., or a separate third intent) of “parking information:parking_reservation-learn” or “parking_information:parking_reservation-buy.” The response service 207 can generate or modify the second response based on the updated second intent (e.g., or the second intent or the third intent). After step 1024, the process 1000 can proceed to step 1015 to process additional conversational inputs.

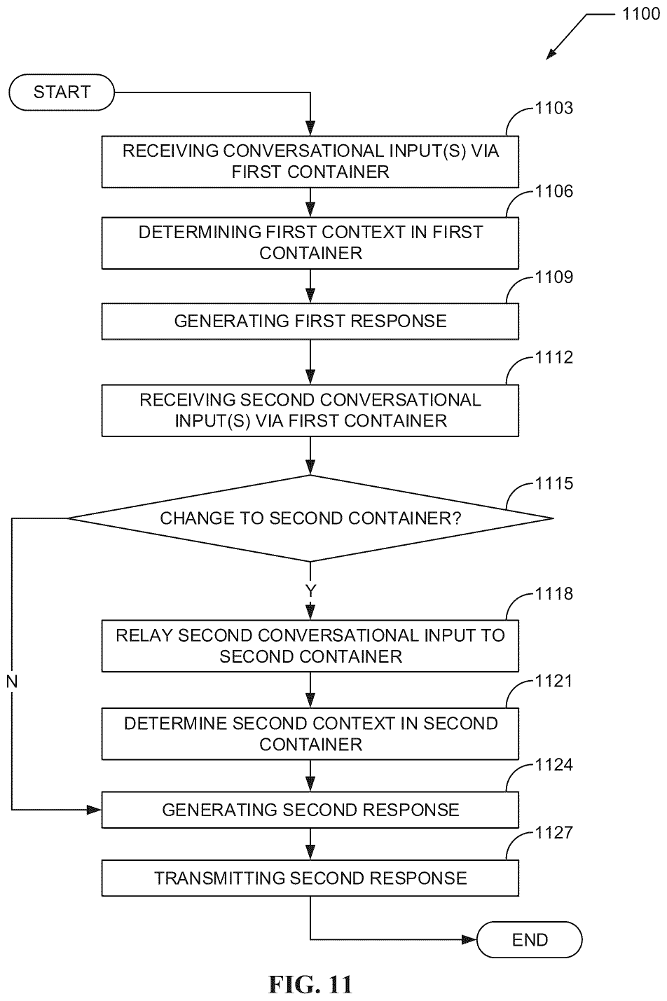

FIG. 11 shows an exemplary response generation process 1100 that may be performed by an embodiment of the present contextual response systems, such as the contextual response system 201 shown in FIG. 2 and described herein. In various embodiments, the process 1100 show in FIG. 11 and described herein demonstrates the ability of the contextual response system to identify transitions in input container and transition from responding to conversational inputs by a first container (e.g., a first set of resources) to responding to conversational inputs by a second container (e.g., a second set of resources).

At step 1103, the process 1100 includes receiving a first conversational input from a computing device 203 by a first container (see, e.g., container 219 shown in FIG. 2 and described herein). For example, communication service 204 receives the first conversational input from a computing device 203 at a first URL address. The communication service 204 determines that the first URL address is associated with a first container, thereby causing the NLP service 205, response service 207, and rules service 209 to process the first conversational input (e.g., and context(s), intent(s), and response(s) associated therewith) via resources associated with the first container. Step 1103 may be similar to step 903 of the process 900 shown in FIG. 9 and described herein. In one example, the first conversational input includes natural language “I want to buy a baseball jersey.” The first container may be, for example, a container associated with the Major League Baseball (MLB) organization. The communication service 204 may retrieve a user profile associated with the computing device 203. For example, the communication service 204 processes the first conversational input to extract metadata thereof including a computing device identifier. The communication service 204 can retrieve a user account 217 from the data store 211 based on the computing device identifier.

At step 1106, the process 1100 includes determining, a context of the first conversational input in the first container. In the present description of the process 1100, the context of the first conversational input may be referenced as the first context. Step 1106 can be similar to step 909 of the process 900. For example, the NLP service 205 processes the first conversational input in the first container and associates the first conversational input with a merchandise context.

Following step 1106, the process 1100 can include determining an intent of the first conversational input based on one or more of the first conversational input, the first context, the first container, and additional factors (see, e.g., step 912 of the process 900 shown in FIG. 9 and described herein). For example, the NLP service 205 determines an intent of the first conversational input as “merchandise:merchandise_jersey-buy.”

At step 1109, the process 1100 includes generating a response to the first conversational input. In the present description of the process 1100, the response to the first conversational input may be referenced as the first response. Step 1109 can be similar to step 915 of the process 900. The response service 207 can generate the first response based on one or more of the first context in the first container, the first intent, and additional factors. For example, the response service 207 generates a response including natural language “Great! Who is your team?”

Following step 1109, the rules service 209 can format the first response and the communication service 204 can transmit the first response to the computing device 203. In some embodiments, the communication service 204 causes the computing device 203 to render, in a display of the user session, a visual indicator of the first container. For example, the communication service 204 causes the computing device 203 to render “MLB” and/or a logo thereof on a display of the user session.

At step 1112, the process 1100 includes receiving a second conversational input. The communication service 204 can receive the second conversational input from the computing device 203 and via the URL address associated with the first container. The second conversational input includes natural language, such as “Yankees.”

At step 1115, the process 1100 includes determining whether to change to a second container. The change to the second container can refer to processing the user session by resources of a second container instead of resources associated with the first container. The NLP service 205 can determine whether to change to a second container based on one or more of a context of the second conversational input, an intent of the second conversational input, a profile associated with the user account, the first response, and additional factors.

The NLP service 205 can process the second conversational input and the URL address to determine a context of the second conversational input. The context of the second conversational input may be the first context or a second context different from the first context. In one example, the NLP service 205 determines the second conversational input is associated with the merchandise context. The NLP service can process the second conversational input and the context of the second conversational input to determine the intent of the second conversational input, referred to herein as a second intent. For example, the NLP service 205 determines that the second conversational input is associated with a second intent “merchandise:merchandise_Yankees_jersey-buy.” Based on the second intent (e.g., alone or in combination with other factors, such as the first response, a profile of the user account, etc.), the NLP service 205 transitions the user session from the first container to a second container. For example, based on the second intent, the NLP service 205 transfers the user session from the container associated with the MLB organization to a second container associated with the New York Yankees franchise.

The NLP service 205 can process a profile of the user account 217 and determine whether to change to from the first container to a second container based thereon. The profile can include, but is not limited to, user preferences, current and historical user locations, purchase histories of the user, and historical conversations associated with the user profile 217. In one example, the NLP service 205 determines that the profile includes a user preference for the New York Yankees baseball team. In another example, the NLP service 205 determines that the profile includes a historical location of the user within a predetermined proximity (e.g., 10 miles, 20 miles, 200 miles, or any suitable metric) of a geolocation associated with the New York Yankees baseball team (e.g., Yankee Stadium, New York City, New York state, New England, or any suitable geolocation). In another example, the NLP service 205 determines that the profile includes a historical purchase for a ticket to a New York Yankees baseball game. In another example, the NLP service 205 determines that the profile includes one or more historical conversations in which one or more conversational inputs thereof were received and/or processed via a container associated with the New York Yankees franchise. Based on processing the profile of the user account 217, the NLP service 205 can determine to transfer the user session from the container associated with the MLB organization to a second container associated with the New York Yankees franchise.

The NLP service 205 can determine to maintain the user session within the current container. For example, the second conversational input includes natural language “all-star game” and the current container of the user session is a container associated with the Major League Baseball franchise. The NLP service 205 determines that the second conversational input is associated with the merchandise context. The NLP service 205 determines that an intent of the second conversational input is “merchandise:merchandise_allstar_jersey-buy.” Based on the intent, the NLP service 205 determines to maintain the user session within the current container.

In response to the response service 207 determining to change the user session to a second container, the process 1100 can proceed to step 1118. In response to determining not to change the user session to a second container, the process 1100 can proceed to step 1124.

At step 1118, the process 1100 includes relaying the second conversational input from the first container to the second container, thereby relaying the user session from the first container to the second container). In some embodiments, the first container is associated with a first application (e.g., a computing device application, a network address, an online platform, etc.) and the second container is associated with a second application. In some embodiments, a first instance of the communication service 204 is associated with the first container and a second instance of the communication service 204 is associated with the second container. The first instance of the communication service 204 may relay the second conversational input to the second instance of the communication service 204 (e.g., the contextual response system 201 may receive, by the second container, the second conversational input).

The communication service 204 can cause the computing device 203 to update a user interface to indicate the change from the first container to the second container. In one example, the conversation manager 303 of the communication service 204 can relay the second conversational input, and the user session associated therewith, from a first container associated with the MLB organization to a second container associated with the New York Yankees franchise. In this example, the communication service 204 causes the computing device 203 to update a user interface to replace a “MLB” conversation label with a “Yankees” conversation label. In relaying the second conversational input from the first container to the second container, the communication service 204 may also relay the first conversational input and data associated therewith (e.g., context of the first conversational input, intent of the first conversational input, first response to the first conversational input, etc.). Within the user interface presented to the user, the communication service 204 can cause the computing device 203 to duplicate or retain the conversational history prior to receipt of the second conversational input such that visual provenance of the current user session is preserved for and provided to the user. While the user session may be transitioned from a first application to a second application, the communication service 204 may preserve, to the user, an appearance of the user interface such that the user may be unaware of the application change (e.g., apart from a change in a visual indicator for indicating the second container).

At step 1121, the process 1100 includes determining a context of the second conversational input within the second container. The context of the second conversational input may be the same context as the first conversational input or a different context. The NLP service 205 can determine the context of the second conversational input based on one or more of the second conversational input, the first conversational input, the context of the first conversational input, the intent of the first conversational input, the response to the first conversational input, and additional factors. In one example, the second conversational input includes natural language “Yankees” and an intent of the first conversational input includes “merchandise:merchandise_jersey-buy.” Based on the second conversational input and the intent of the first conversational input, the NLP service 205 may determine that the second conversational input is associated with a merchandise context of the second container (e.g., or another context, such as a jersey design context). In another example, one of a plurality of second conversational inputs includes “when can I get my jersey signed.” The NLP service 205 may determine that the plurality of second conversational inputs is associated with a special events context of the second container.

The NLP service 205 can determine an intent of the second conversational input. The NLP service 205 can determine the intent similar to steps 912 and/or 924 of the process 900 shown in FIG. 9 and described herein. For example, the second conversational input includes “Yankees” and is associated with a merchandise context. Based on the second conversational input and the merchandise context, the NLP service 205 determines an intent of the second conversational input as “merchandise:merchandise_Yankees_jersey-learn.”

At step 1124, the process 1100 includes generating a response to the second conversational input (e.g., the response referred to herein as a second response). Step 1124 may be similar to steps 915, 927 of the process 900 shown in FIG. 9 and described herein. The response service 207 can generate the second response by processing, in the second container, one or more of the second conversational input, the context of the second conversational input, the first response, the intent of the first conversational input, and additional factors. For example, the second conversational input includes “Yankees” and is associated with an intent “merchandise:merchandise_Yankees_jersey-learn.” Based on the second conversational input and the intent, the response service 207 can generate a second response including “Whose jersey would you like to wear?”

At step 1127, the process 1100 includes transmitting the second response. Step 1127 may be similar to steps 915, 918, and/or 927 shown in FIG. 9 and described herein. The rules service 209 can format the second response prior to transmission. The communication service 204 can transmit the second response to the computing device 203. After step 1127, the process 1100 can proceed to step 1103 or 1112 to process additional conversational inputs either in the second container or in a third or other container.

FIG. 12 shows an exemplary response generation process 1200 that may be performed by an embodiment of the present contextual response systems, such as the contextual response system 201 shown in FIG. 2 and described herein.

At step 1203, the process 1200 includes receiving a conversational input. Step 1203 may be similar to step 903 of the process 900 shown in FIG. 9 and described herein. The communication service 204 receives a conversational input from the computing device 203 via a channel 218 (see, e.g., FIG. 2 and accompanying description herein). The conversational input includes natural language, such as, for example, “how long is the wait for the dolphin show?”

At step 1206, the process 1200 includes determining a context of the conversational input. Step 1206 may be similar to steps 906, 909 of the process 900. The NLP service 205 can scan through a plurality of tiers of knowledge bases (see, e.g., knowledge base 212 shown in FIGS. 2 and 7 and described herein) to determine the context based on the first conversational input. For example, the NLP service 205 scans through each of a plurality of knowledge bases to determine if one of the plurality of knowledge bases includes matching natural language terms. The NLP service 205 can evaluate the context of the conversational input based on a ranking of potential contexts. In one example, the conversational input includes “how long is the wait for the dolphin show?” The NLP service 205 can determine that the conversational input is associated with an events context.

At step 1209, the process 1200 includes determining an intent of the conversational input. Step 1209 may be similar to step 912 of the process 900. The NLP service 205 can through a plurality of tiers of knowledge bases (e.g., associated with the context of step 1206) to determine the intent based on the context of step 1206 and the conversational input. The NLP service 205 can determine the intent based on the conversational input and the context determined at 1206. The NLP service 205 can scan through a plurality of tiers of knowledge bases associated with the context to determine the intent. For example, the conversational input includes “how long is the wait for the dolphin show?” and the NLP service 205 determines that the conversational input is associated with an intent “events:events_dolphins-learn.” In some embodiments, in response to failing to identify the intent based on scanning through knowledge bases associated with the context, the NLP service scans through knowledge bases associated with one or more additional contexts (e.g., a context of a previous conversational input, a context ranked immediately beneath the determined context in a context ranking, or another suitable context).

At step 1212, the process 1200 includes generating a response to the conversational input. The response service 207 can generate the response via one or more response tree algorithms and based on one or more of the context of the conversational input, the intent of the conversational input, and other factors (e.g., previous conversational inputs, contexts, intents, and/or responses, metadata, user account data, etc.). For example, the conversational input is associated with an events context and an intent “events:events_dolphins-learn.” The response service 207 can scan through one or more branches of a decision tree based on the context and the intent and generate a response including natural language “You can see the dolphins at 12 pm, 2 pm, and 4 pm, the estimated wait for the next dolphin show is [x]!” In the preceding example, [x] may be a dynamic content variable for a length of time (e.g., a wait time for the next iteration of the corresponding event).

At step 1215, the process 1200 includes determining a dynamic content variable associated with the response. The response service 207 can determine the dynamic content variable via one or more dynamic content variable algorithms. The algorithms can include one or more of, but is not limited to, retrieving a value of the dynamic content variable from the data store 211 (e.g., or one or more inputs to determining the value of the dynamic content variable), computing the value of the dynamic content variable, and requesting the value of the dynamic content variable (e.g., or one or more inputs to determining the value) from one or more external services 226. In one example, the response includes “You can see the dolphins at 12 pm, 2 pm, and 4 pm, the estimated wait for the next dolphin show is [x].” The response service 207 can access a current time, determine a next performance of the corresponding event, and compare the current time to the scheduling of the corresponding event to calculate a value of [x]. The value of [x] can be a length of time between the current time and the next performance of the corresponding event.

At step 1218, the process 1200 includes formatting the response. The response service 207 can modify the response to include the determined value of the dynamic content variable. For example, the response includes “You can see the dolphins at 12 pm, 2 pm, and 4 pm, the estimated wait for the next dolphin show is [x].” At step 1215, the response service 207 determines the value of [x] to be 43 minutes. The response service 207 can modify the response to include the value of [x] (e.g., “You can see the dolphins at 12 pm, 2 pm, and 4 pm, the estimated wait for the next dolphin show is in 43 minutes.”).

The rules service 209 can format the response for transmission via the same channel by which the conversational input was received. For example, if the conversational input was received via SMS text, the rules service 209 can format the response as an SMS text message. In another example, if the conversational input was received via a messaging service of a particular social media platform, the rules service can format the response as a message to for transmission via the messaging service.

At step 1221, the process 1200 includes transmitting the response. Step 1221 can be similar to step 917 of the process 900. The communication service 204 can transmit the response to computing device via the channel by which the conversational input was received. After step 1221, the process 1200 can proceed to step 1203 to process additional conversational inputs.

FIG. 13 shows an exemplary knowledge base generation process 1300 that may be performed by an embodiment of the present contextual response systems, such as the contextual response system 201 shown in FIG. 2 and described herein. By the process 1300, the contextual response system 201 may generate one or more knowledge bases for use in responding to conversational inputs.

At step 1303, the process 1300 includes receiving criteria for generating one or more knowledge bases for a particular client, or plurality thereof. The communication service 204 can receive indications of one or more topics, activities, services, locations, or audiences with which the particular client is associated. For example, the particular client is a baseball franchise and the communication service 204 receives an indication that the baseball franchise is associated with a topic “New York Yankees,” activities including “ticketing,” “merchandise sales,” “food and beverage sales,” and “parking,” and a location “Yankee Stadium, Bronx, New York City, New York.” The communication service 204 can receive the criteria from one or more computing devices 203, one or more external services 226, or combinations thereof. In some embodiments, the communication service 204 receives a first criterion and processes the first criterion via one or more algorithms, models, or other techniques to identify one or more second criteria.

At step 1306, the process 1300 includes obtaining one or more knowledge volumes based on the criteria. The NLP service 205 can process the criteria and retrieve one or more knowledge volumes from knowledge bases 212 stored in the data store 211. The NLP service 205 can use similarity metrics, topic modeling, and/or other suitable techniques to identify knowledge volumes with which the criteria may be associated. The communication service 204 can receive knowledge volumes from the particular client and provide the knowledge volumes to the NLP service 205. The NLP service 205 can request and receive knowledge volumes from one or more external services 226, including external services 226 associated with the particular client (e.g., a website of the particular client, promotional materials of the particular client etc.). In one example, the NLP service 205 obtains promotional materials associated with the particular client. The NLP service 205 can process the promotional materials to generate corpus including a plurality of keywords and phrases extracted from the promotional materials. The NLP service 205 can generate a knowledge volume based on the corpus (e.g., or update an existing knowledge volume based thereon).

At step 1309, the process 1300 includes generating a plurality of knowledge tiers based on the one or more knowledge volumes. The NLP service 205 can generate the plurality of knowledge tiers by identifying a plurality of segments in the one or more knowledge volumes. The plurality of segments can include, but is not limited to, a global segment, a vertical knowledge segment, a sub-vertical knowledge segment, and a local segment. The NLP service 205 can assign varying levels of information scope to subsets of the knowledge volume(s) and can identify the plurality of segments based on the assigned information scope. The global segment can correspond to a first subset of the knowledge volume(s) assigned to a highest level of information scope (e.g., least specific or most general, lowest granularity, etc.). The vertical knowledge segment can correspond to a second subset of the knowledge volume(s) assigned to a second-highest level of information scope. The sub-vertical knowledge segment can correspond to a third subset of the knowledge volume(s) assigned to a third-highest level of information scope. The local knowledge segment can correspond to a fourth subset of the knowledge volume(s) associated with a lowest level of information scope (e.g., most specific or least general, highest granularity, etc.).

The plurality of knowledge tiers can include, but is not limited to, a global knowledge tier, a vertical knowledge tier, a sub-vertical knowledge tier, and a local knowledge tier (see also knowledge base 212 shown in FIG. 2 and described herein, and FIG. 7 and accompanying description herein). The NLP service 205 can generate the global knowledge tier based on one or more global knowledge segments, the vertical knowledge tier based on one or more vertical knowledge segments, the sub-vertical knowledge tier based on one or more sub-vertical knowledge segments, and the local knowledge tier based on one or more local knowledge segments. The NLP service 205 can assign the global knowledge tier to a first level of information scope (e.g., a highest level of information scope), the vertical knowledge tier to a second level of information scope (e.g., a second-highest level of information scope), the sub-vertical knowledge tier to a third level of information scope (e.g., a third-highest level of information scope), and the local knowledge tier to a fourth level of information scope (e.g., a lowest level of information scope).

At step 1312, the process 1300 includes generating one or more knowledge bases based on the plurality of knowledge tiers. The knowledge base(s) can include the plurality of knowledge tiers and the assigned levels of information scope (see also FIG. 7 and accompanying description herein).

At step 1315, the process 1300 includes determining one or more metrics of the knowledge base(s) of step 1312. The one or more metrics include, but are not limited to, a context metric, an intent metric, and a level of granularity. Further non-limiting examples of the metrics include company identifier, volume identifier, channel identifier, natural language processing (NLP) class identifier, base intent names, volume priority, context importance, intent importance, class count, and class match count.

The metric can be a score, a label, a categorization, or other suitable classification of the knowledge base. In one example, the NLP service 205 performs topic modeling on the knowledge base to associate the knowledge base with one of a plurality of topics, the associated topic constituting a context of the knowledge base (e.g., the context metric). In another example, the NLP service 205 compares the knowledge base to a plurality of historical intents and generates an intent metric of the knowledge base based on the comparison. In another example, the NLP service 205 compares a first knowledge base to a plurality of second knowledge bases and generates a granularity ranking of the first knowledge base and the plurality of second knowledge bases based thereon (e.g., most granular to least granular, most specific to least specific, highest level of information scope to lowest level of information scope, etc.). Continuing this example, the NLP service assigns a level of granularity to the knowledge base, or one or more subsets thereof, based on the granularity ranking.

At step 1318, the process 1300 includes training one more models using the knowledge base(s) of step 1312 and the one or more metrics of step 1315. The NLP service 205 can use the knowledge base and labeled and/or unlabeled datasets of conversational inputs to train one or more models 220. The NLP service 205 can train the model 220 to process, as input, a conversational input and predict, based on the knowledge base, a context of the conversational input and/or an intent of the conversational input. The NLP service 205 can train the model 220 to predict whether a conversational input is associated with the knowledge base (e.g., the association indicating that the context of the conversational input corresponds to the context metric of the knowledge base). The NLP service 205 can train the model 220 to predict whether a conversational input is associated with a subset of knowledge base (e.g., the association indicating that the context of the conversational input corresponds to an intent metric and/or level of granularity associated with the subset of the knowledge base). The conversational inputs of the labeled datasets can include known context labels and/or known intent labels. The conversational inputs of the unlabeled datasets can exclude known context labels and/or known intent labels. The NLP service 205 can iteratively train, assess, and modify the model 220 to improve context and intent detection (e.g., including adjusting model weights and other parameters).

Following generation of the knowledge base and metric(s), the NLP service 205 can store the knowledge base and metric(s) at the data store 211. The NLP service 205 can associate the knowledge base with a container corresponding to the particular client. The communication service 204 can transmit the knowledge base to the computing device 203 associated with the particular client. The communication service 204 may receive a modified knowledge base from the particular client (e.g., adding additional knowledge volumes or adjusting one or more properties of the knowledge volume). The communication service 204 can replace the knowledge base in the data store 211 with the updated knowledge base.

The NLP service 205 can receive second criteria associated with a second particular client. The NLP service 205 can generate a second knowledge base based on the second criteria (e.g., via the process 1300). The NLP service 205 can generate a second knowledge base by modifying the first knowledge base based on the second criteria. The NLP service 205 can remove or add one or more knowledge volumes to or from one or knowledge tiers based on the second criteria. The NLP service 205 can determine one or more metrics of the second knowledge base (see, e.g., step 1315). The NLP service 205 can train a second model based on the second knowledge base and the metric(s) associated therewith.

At step 1321, the process 1300 includes receiving a request including a conversational input. The communication service 204 can receive the request from a computing device 203 via a channel (see, e.g., channel 218 shown in FIG. 2 and described herein).

Following step 1321, the contextual response system 201 may perform an embodiment of the response generation process 900, as shown in FIG. 9 and described herein, to process the conversational input of the request and generate and transmit a response to the computing device 203. The contextual response system 201 can perform the response generation process 900, a response generation process 1000 as shown in FIG. 10 and described herein, a response generation process 1100 as shown in FIG. 11 and described herein, a response generation process 1200 as shown in FIG. 12 and described herein, or combinations thereof. In various embodiments, following transmission of the response to the computing device 203, the communication service 204 obtains performance data by monitoring and recording one or more of user interactions at the computing device 203, activities of the contextual response system 201 (e.g., such as subsequent response generation processes), and activities occurring at one or more external services 226, such as a user-facing system associated with the particular client.

At step 1324, the process 1300 includes analyzing performance data associated with use of the knowledge bases(s) in responding to conversational inputs. The NLP service 205 and/or response service 207 can analyze a historical user session (e.g., a historical conversation of conversational inputs and responses to the same as provided by the contextual response system). Based on the historical user session, the NLP service 205 can determine whether the responses satisfied the conversational input. The NLP service 205 can determine whether the user session ended following transmission of a response. The NLP service 205 can determine whether a conversational input was repeated (e.g., indicating a failure of the response to satisfy the prior instance of the conversational input). The NLP service 205 can determine whether a conversational input includes natural language indicating dissatisfaction or frustration. For example, the NLP service 205 can perform sentiment analysis on the historical user session to predict a degree of user dissatisfaction associated therewith. The NLP service 205 can determine whether one or more responses from a base response track were required (e.g., indicating the response service 207 was unable to generate a more specific response to the conversational input). The NLP service 205 can determine (e.g., or receive from an external service 226) a realization rate or click-through rate for indicating whether the user session led to a user navigating to a physical or digital location, participating in an activity, attending events, or purchasing goods or services. The NLP service 205 can receive, from one or more computing devices 203 of the particular client, historical performance data associated with use of the knowledge base to determine the contexts and intents of conversational inputs associated with the particular client. The NLP service 205 can generate one or more error metrics based on the historical performance data, such as for example, a mislabeled context error rate, a mislabeled intent error rate, or other suitable metrics. The NLP service 205 can identify one or more particular conversational inputs that are incorrectly associated with a context or intent via the trained model 220.

At step 1327, the process 1300 includes modifying the knowledge bases(s) to improve response generation processes. The NLP service 205 can adjust one or more metrics of the knowledge base to reduce one or more error metrics. For example, the NLP service 205 changes a context label of the knowledge base, adds or removes one or more intent labels of the knowledge base, or increases or decreases a level of granularity assigned to the knowledge base. The NLP service 205 can generate one or more labeled or unlabeled training datasets based on the historical user sessions and can retrain the model 220 to generate more accurate context and intent associations using the training dataset(s). The NLP service 205 can identify one or more informational deficiencies in one or more knowledge tiers of the knowledge base. The NLP service 205 can retrieve one or more additional knowledge volumes based on the informational deficiency. The NLP service 205 can update the knowledge base to include the additional knowledge volume(s). The NLP service 205 can request and receive information from one or more external services 226 and update the knowledge base based thereon. The NLP service 205 can process the historical conversational inputs to extract keywords and phrases therefrom. The NLP service 205 can update the knowledge volume to include the extracted keywords and phrases.

### Additional Exemplary System Features and Functions

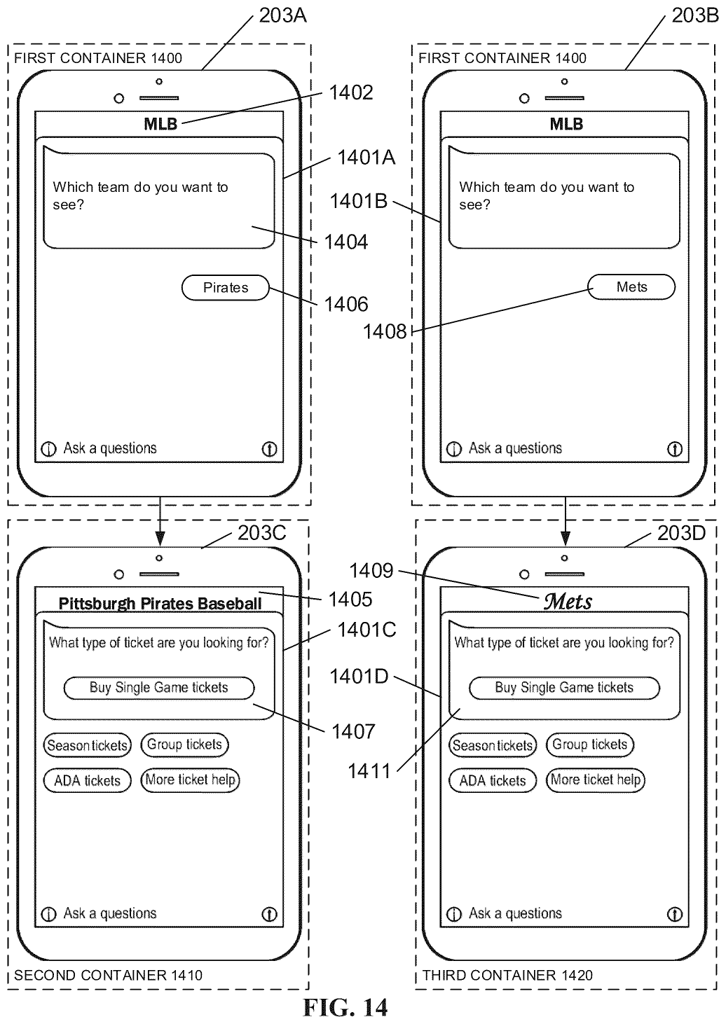

FIG. 14 shows an exemplary user interfaces 1401A, C, and user interfaces 1403B, D that can be rendered on respective computing devices 203A, C and computing devices 203B, D. The user interfaces 1401A, C and 1403B, D shown in FIG. 14 and described herein may demonstrate the ability of the contextual response system to transition from a first container to a second container based on processing conversational inputs (e.g., see also container 219 shown in FIG. 2 and described herein). The elements shown in FIG. 14 and described herein provide an exemplary scenario of receiving conversational input by a first container and transitioning to different containers based on processing the conversational input.

The contextual response system (not shown, see, e.g., contextual response system 201 shown in FIG. 2 and described herein) can initiate a conversation in a first container 1400. In some embodiments, the conversation may be referred to as a “user session.” The user interfaces 1401A, 1401B can correspond to the first container 1400. The first container 1400 can be associated with a first entity, such as, for example, the Major League Baseball (MLB) organization. The contextual response system can cause the computing devices 203A, 203B to render, on the respective user interfaces 1401A, 1401B, a visual indication of the first container 1400. For example, the user interfaces 1401A, 1401B include a visual indicator 1402 comprising an MLB logo.

The contextual response system can transmit a first response 1404 in response to receiving a request from the computing devices 203A, 203B. The request may include a natural language input (not shown) and/or comprise the computing devices 203A, 203B accessing an application for communicating with the contextual response system (see, e.g., application 225 shown in FIG. 2 and described herein). The contextual response system can generate the first response 1404 based on the request. For example, the contextual response system associates the request with a ticketing context based on the natural language input and/or a recognition that the request was received via the first container. The contextual response system can generate the first response 1404 by processing the request based on the ticketing context. As shown in FIG. 14, the exemplary first response 1404 may include a question posed to a user, “Which team would you like to see?”

The computing devices 203A, 203B can receive and transmit, to the contextual response system, a respective input 1406, 1408 responding to the first response 1404. The input 1406 includes, for example, “Pirates.” The NLP service of the contextual response system can process the input 1406 and determine that the input 1406 is associated with a ticketing context and an intent of obtaining tickets for the Pittsburgh Pirates baseball team. Based on the ticketing context and the updated intent, the contextual response system can transition the conversation from the first container 1400 to a second container 1410 that is associated with the Pittsburgh Pirates baseball team. The contextual response system can cause the computing device 203A, 203C to transition from the user interface 1401A to a user interface 1401C. The contextual response system can cause the computing devices 203C to render, on the user interfaces 1401C, a visual indication of the second container 1410. For example, the user interface 1401C includes a visual indicator 1405 comprising the Pittsburgh Pirates name. Based on the ticketing context and updated intent, the contextual response system can generate and transmit to the computing device 203 a second response 1407. The second response 1407 can include selectable links for purchasing tickets for the Pittsburgh Pirates baseball team. While not shown in FIG. 14, in response to receiving subsequent input(s) from the computing device 203C, the contextual response system can process a ticket transaction within the conversation and second container 1410. In some embodiments, the contextual response system may relay the conversation to a live agent (e.g., automatically or based on processing subsequent conversational input(s).

The input 1408 includes, for example, “Mets.” The NLP service can process the input 1408 and determine that the input 1408 is associated with a ticketing context and an intent of obtaining tickets for the New York Mets baseball team. Based on the ticketing context and the updated intent, the contextual response system can transition the conversation from the first container 1400 to a third container 1420 that is associated with the New York Mets baseball team. The contextual response system can cause the computing devices 203C to render, on the user interfaces 1401C, a visual indication of the third container 1420. For example, the user interface 1401C includes a visual indicator 1409 comprising the New York Mets name. Based on the ticketing context and updated intent, the contextual response system can generate and transmit to the computing device 203 a second response 1411. The second response 1411 can include selectable links for purchasing tickets for the New York Mets baseball team.

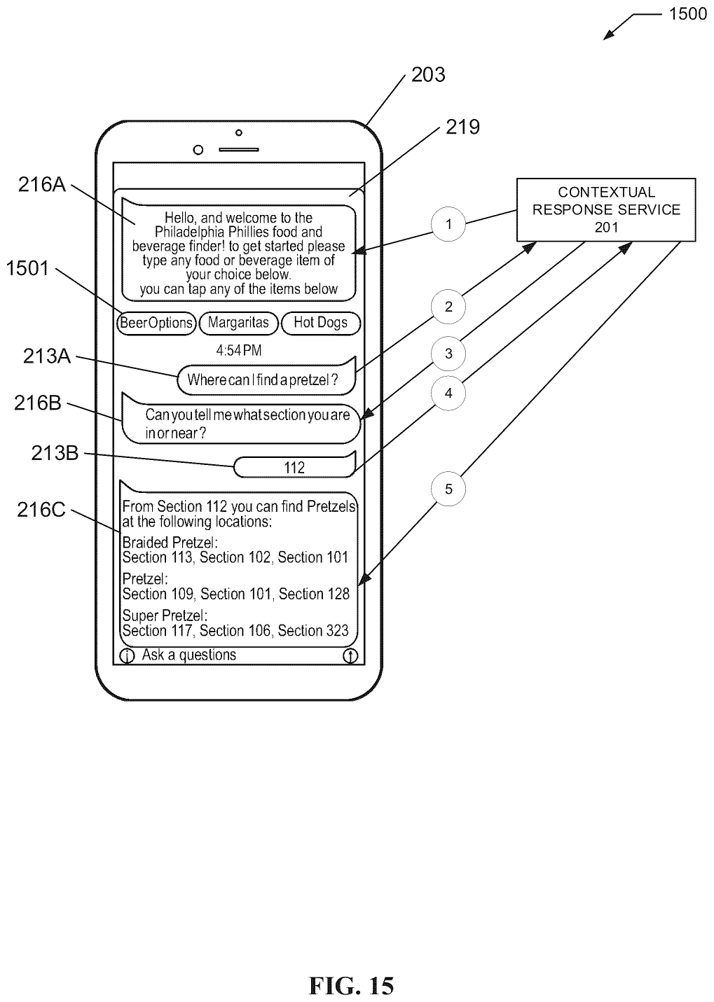

FIG. 15 shows an exemplary response generation workflow 1500 that can be performed by an embodiment of the contextual response system 201 (see also FIG. 2 and accompanying description herein). In the workflow 1500, the contextual response system 201 may be deployed as a virtual assistant to guests at a venue (e.g., a stadium, arena, etc.) and may be accessed via a computing device 203. For example, the contextual response system 201 can assist guests with finding and purchasing food and beverages available at the venue. The contextual response system 201 can provide data associated with assisting the guests to an operator of the venue, thereby providing potential insight into what new or existing items should be stocked or restocked to increase sales. The contextual response system 201 can improve food and beverage sales practices by providing automated expertise and strategic responses optimized to improve sales experiences. For example, the contextual response system 201 can support brand orientation by promoting particular items to guests. As another example, the contextual response system 201 can support trend identification by analyzing user sessions and identifying popular conversational inputs and items associated therewith. As another example, the contextual response system 201 can support food safety by identifying and informing guests of food allergens and allergen-compliant items. As another example, the contextual response system 201 can promote specialty or health items by providing recommendations for drinks, drink specials, bar specials, or nutritionally beneficial items. The proceeding paragraphs provide an exemplary scenario of the workflow 1500 as performed by the contextual response system 201.

The contextual response system 201 can receive, from the computing device 203, a request to initiate a user session. The contextual response system 201 can receive the request via a channel (not shown), such as a website, application, SMS text, messaging application, or voice chat. Based on the request and the channel, the contextual response system 201 can initiate the user session in a container 219 associated with the venue. In one example, a website includes a selectable link to access a food and beverage finder. In response to the computing device 203 receiving a selection of the link, the contextual response system 201 receives the request and initiates the user session.

The contextual response system 201 can transmit a first response 216A in response to initiating the user session. The contextual response system 201 can determine that the request is associated with a food and beverages context and in intent of accessing food and beverage information. The contextual response system 201 can process the context and the intent to generate the first response 216A based on one or more potential responses of a main response track, a fallback response track, or a base response track. In some embodiments, the first response 216A is a default response track transmitted by user in response to initiation of any user session associated with the food and beverages context. The first response 216A includes natural language, such as “Hello, and welcome to the Philadelphia Phillies food and beverage finder! To get started please type any food or beverage item of your choice below. You can tap any of the items below.” The first response 216A can include one or more selectable options 1501 that, upon selection, cause the computing device 203 to transmit a preset conversational input. For example, in response to receiving selection of a “Margaritas” option, the computing device 203 automatically transmits a conversational input to the contextual response system 201 (e.g., the conversational input including natural language “Margaritas”).

The computing device 203 can receive input from a user and generate a first conversational input 213A. The first conversational input 213A includes natural language, such as “Where can I find my pretzel?” The contextual response system 201 can receive the first conversational input 213A. The contextual response system 201 can perform a response generation process to generate a second response 216B for responding to the first conversational input 213A (e.g., such as the processes 900, 1000, 1100, or 1200 shown in respective FIGS. 9, 10, 11, and 12, and described herein). The NLP service of the contextual response system 201 can associate the first conversational input 213A with the food and beverages context. Based on the food and beverages context and the natural language, the NLP service can determine an intent of the first conversational input 213A as “foodbeverages.food_pretzel_location-learn.” The response service of the contextual response system can generate the second response 216B based on the food and beverages context and the intent. The second response 216B includes, for example, “Can you tell me what section you are in or near?” The contextual response system 201 can transmit the second response 216B to the computing device 203 for display to the user.

The computing device 203 can receive second input from a user and generate a second conversational input 213B. The second conversational input 213B includes natural language, such as “112.” The contextual response system 201 can perform a response generation process to generate a third response 216C for responding to the second conversational input 213B. The NLP service associate the second conversational input 213B with the food and beverages context. Based on the food and beverages context and the natural language, the NLP service can determine an intent of the second conversational input 213B as “foodbeverages.food_pretzel_location_sec112-learn.” The response service of the contextual response system can generate the third response 216B based on the food and beverages context and the intent. The third response 216B includes, for example, natural language indicating the location of one or more vendors nearest the section 112 that offer pretzels. The contextual response system 201 can transmit the third response 216C to the computing device 203 for display to the user.

While not shown in FIG. 15, the contextual response system 201 can initiate in-chat purchasing of the pretzel, and/or other items, thereby advantageously reducing wait times and queue lengths. For example, the contextual response system 201 can serve an inline frame (iframe) to the computing device 203 for secure collection of transaction processing data into an external service 226 (e.g., a transaction processing service or a point of sale system of the venue). The contextual response system 201 can transmit a confirmation of the purchase to a second external service 226 associated with food and beverage preparation and/or inventory management at the corresponding vendor of the venue.

FIG. 16A shows an exemplary decision tree 1600A that may be accessed and applied by the contextual response system (e.g., response service 207 shown in FIG. 2 and described herein) to generate a response to a conversational input. The decision tree 1600A may correspond to a portion of a decision tree shown collectively by decision trees 1600A, 1600B shown in FIGS. 16A, 16B respectively.

FIG. 16B shows an exemplary decision tree 1600B that may be accessed and applied by the contextual response system (e.g., response service 207 shown in FIG. 2 and described herein) to generate a response to a conversational input.

The response service 207 can generate one or more determinations based on a conversational input (not shown), an intent 1601 of the conversational input, a context 1602 of the conversational input, and other factors (e.g., prior conversational inputs, device data, user profile(s), etc.). The response service 207 can scan and proceed through one or more branches of the decision trees 1600A, 1600B based on the determination(s).

In one example, a conversational input includes “show me the game highlights.” The NLP service 205 of the contextual response system (not shown, see NLP service 205 shown in FIG. 2 and described herein) processes the conversational input and determines a context 1602 of the conversational input as “Event Media.” The NLP service 205 further processes the conversational input and the context thereof to determine an intent 1601, “event_media:game highlights-watch.” The response service 207 processes the intent 1601 to generate one or more determinations for proceeding through the decision tree 1600A. The response service 207 determines that the intent 1601 does not specify a team or a game date. Based on the intent 1601 and determinations, the response service 207 determines that a response 1603 is a most appropriate response for responding to the conversational input. The response 1603 includes a query requesting that sender of the conversational input identify a team and a game date they wish to access.

In some embodiments, not shown in FIGS. 16A, 16B, instead of selecting the response 1603, the response service 207 retrieves a user profile 217 (e.g., shown in FIG. 2 and described herein) with which the conversational input is associated. The response service 207 processes the user profile 217 to identify a team preference stored therein. The response service 207 processes the team preference to identify a date of the most recent game of the team (e.g., which may include receiving an indication of the most recent game from an external service 226, shown in FIG. 2 and described herein). The response service 207 processes the team and the identified date and identifies a response to the conversational input that includes a selectable link for viewing highlights of the most recent game of the team.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A system, comprising:
a memory; and
at least one computing device in communication with the memory, wherein the at least one computing device is configured to:
receive a first conversational input of a plurality of sequential conversational inputs via at least one user input device, wherein the first conversational input is associated with a particular uniform resource locator (URL) address;
process the first conversational input via at least one natural language processing (NLP) algorithm to:
determine a context based on the particular URL address and the first conversational input; and
determine at least one intent based on the context and the first conversational input;
generate a response to the first conversational input based on the context and the at least one intent;
subsequent to receiving the first conversational input, receive a second conversational input of the plurality of sequential conversational inputs;
process the second conversational input via the NLP algorithm to generate at least one updated intent based on the first conversational input, the second conversational input, and the particular URL address; and
generate a second response to the second conversational input based on the at least one updated intent and the context.

2. The system of claim 1, wherein the context is a first context and the at least one computing is further configured to:
identify a contextual change in a subset of the plurality of sequential conversational inputs; and
initiate a change from the first context to a second context based on the contextual change.

3. The system of claim 2, wherein the at least one computing is further configured to iteratively process a plurality of second sequential conversational inputs, via natural language processing (NLP) algorithm and based on the second context, to generate a plurality of second responses individually corresponding to a respective one of the plurality of second sequential conversational inputs.

4. The system of claim 3, wherein the at least one computing is further configured to iteratively process the plurality of sequential conversational inputs based on the second context prior to generating the plurality of second responses.

5. The system of claim 1, wherein:
the at least one computing is configured to receive the first conversational input via the at least one computing device by a first container;
the context is a first context of the first container;
the at least one computing device is further configured to:
prior to generating the at least one updated intent, determine to change to a second container based on at least one of: the second conversational input, a profile associated with a particular user account, and the first context of the first container; and
relay the second conversational input to a second container.

6. The system of claim 5, wherein the system comprises:
a first application that, when executed by the at least one computing device, causes the first application to:
receive the first conversational input the at least one user input device;
process the first conversational input via the at least one natural language processing (NLP) algorithm to:
determine the first context of the first container based on the particular URL address and the first conversational input; and
determine the at least one intent based on the first context of the first container and the first conversational input; and
generate the response to the first conversational input based on the context and the at least one intent;
receive, by the first container, the second conversational input;
prior to generating the at least one updated intent, determine whether to change to the second container based on at least one of: the second conversational input, the profile associated with the particular user account, and the first context of the first container; and
relay the second conversational input to the second container; and
a second application that, when executed by the at least one computing device, causes the second application to:
receive, by the second container, the second conversational input relayed from the first container;
determine a second context of the second container based on the second conversational input;
process the second conversational input via the NLP algorithm to generate at least one updated intent based on the first conversational input, the second conversational input, and the particular URL address; and
process at least one second conversational input, based on the at least one updated intent and the second context in the second container, to generate at least one second response.

7. The system of claim 6, wherein the first application is executed by a first computing device of the at least one computing device and the second application is executed by a second computing device of the at least one computing device.

8. A method, comprising:
receiving a first conversational input of a plurality of sequential conversational inputs via at least one user input device, wherein the first conversational input is associated with a particular uniform resource locator (URL) address;
processing the first conversational input via at least one natural language processing (NLP) algorithm to:
determine a context based on the particular URL address and the first conversational input; and
determine at least one intent based on the context and the first conversational input;
generating a response to the first conversational input based on the context and the at least one intent;
subsequent to receiving the first conversational input, receiving a second conversational input of the plurality of sequential conversational inputs;
processing the second conversational input via the at least one NLP algorithm to generate at least one updated intent based on the first conversational input, the second conversational input, and the URL address; and
generating a second response to the second conversational input based on the at least one updated intent and the context.

9. The method of claim 8, wherein processing the first conversational input via the at least one NLP algorithm comprises scanning through a plurality of tiers of knowledge bases to determine the context and the at least one intent.

10. The method of claim 9, wherein processing the second conversational input via the at least one NLP algorithm comprises scanning through the plurality of tiers of knowledge bases to determine the at least one updated intent.

11. The method of claim 10, wherein the plurality of tiers of knowledge bases are assigned to a hierarchy based on an as-signed information scope.

12. The method of claim 8, wherein generating the response to the first conversational input comprises processing a response tree algorithm based on the context and the at least one intent.

13. The method of claim 12, wherein generating the second response comprises processing the response tree algorithm based on the context and the at least one updated intent.

14. The method of claim 12, wherein generating the response to the first conversational input comprises:
determining a dynamic content variable associated with the response; and
formatting the response based on a channel type corresponding to a current user session and the dynamic content variable.

15. The method of claim 14, wherein the step of processing the first conversational input via the at least one natural language processing (NLP) algorithm to determine the at least one intent is further based on a plurality of past conversational inputs corresponding to the current user session.

16. The method of claim 8, wherein the response is a top-ranked entry of a main response track and the method further comprises:
determining that the top-ranked entry of the main response track is unavailable;
determining that a top-ranked entry of a fallback response track satisfies the at least one intent; and
identifying the top-ranked entry of the fallback response track as the response.

17. A non-transitory, computer-readable medium embodying a program that, when executed by at least one computing device, causes the at least one computing device to:
receive a first conversational input of a plurality of sequential conversational inputs via at least one user input device, wherein the first conversational input is associated with a particular uniform resource locator (URL) address;
process the first conversational input via at least one natural language processing (NLP) algorithm to:
determine a context based on the particular URL address and the first conversational input; and
determine at least one intent based on the context and the first conversational input;
generate a response to the first conversational input based on the context and the at least one intent;
subsequent to receiving the first conversational input, receive a second conversational input of the plurality of sequential conversational inputs;
process the second conversational input via the NLP algorithm to generate at least one updated intent based on the first conversational input, the second conversational input, and the URL address; and
generate a second response to the second conversational input based on the at least one updated intent and the context.

18. The non-transitory, computer-readable medium of claim 17, wherein the program, when executed by the at least one computing device, further causes the at least one computing device to process the first conversational input via the at least one NLP algorithm by scanning through a plurality of tiers of knowledge bases to determine the context and the at least one intent.

19. The non-transitory, computer-readable medium of claim 18, wherein the program, when executed by the at least one computing device, further causes the at least one computing device to:
receive first criteria associated with a client;
obtain a plurality of knowledge volumes based on the first criteria, wherein each of the plurality of knowledge volumes comprises a respective plurality of contexts and a respective plurality of intents; and
generate a plurality of knowledge tiers based on the plurality of knowledge volumes.

20. The non-transitory, computer-readable medium of claim 19, wherein:
each of the plurality of knowledge tiers is assigned a different information scope; and
the plurality of knowledge tiers comprises, respectively, a global knowledge tier, a vertical knowledge tier, a sub-vertical knowledge tier, and a local knowledge tier; and
the program, when executed by the at least one computing device, further causes the at least one computing device to generate at least one client knowledge base comprising the plurality of knowledge tiers.
